(19) United States
(12) Patent Application Publication
(10) Pub. No.: US 2026/0235746 A1
(43) Pub. Date: Aug. 13, 2026

(54) METHODS AND APPARATUS USING INTEGRATED SENSING AND COMMUNICATIONS IN WIRELESS SYSTEMS

(71) Applicant: Charter Communications Operating, LLC, St. Louis, MO (US)

(72) Inventors: Rauf Hafeez, Cary, NC (US); Saúl A. Torrico, Bethesda, MD (US)

(21) Appl. No.: 19/049,263

(22) Filed: Feb. 10, 2025

(51) Int. Cl. G01S 13/42; H04W 16/14

(52) U.S. Cl. CPC G01S 13/42; H04W 16/14

(57) ABSTRACT

The present invention relates to methods and apparatus for using Integrated Sensing and Communications in wireless systems for identifying clutter, determining clutter losses, determining transmission power levels, planning base station site locations, and/or managing spectrum allocation and/or usage. An exemplary method includes the steps of: transmitting, by a first wireless communications entity radio frequency sensing pulses; receiving, by a second wireless communications entity, reflected radio frequency sensing pulses which are the transmitted sensing pulses which have been reflected by clutter; determining information about the clutter in the vicinity of the first wireless communications entity based on information about the reflected sensing pulses; determining a clutter loss for one or more radio frequency propagation paths extending from the first wireless communications entity to a third wireless communications entity based on the determined information about the clutter.

### FIELD OF INVENTION

The present invention relates to methods and apparatus for using Integrated Sensing and Communications in wireless systems (e.g., shared spectrum wireless systems) for identifying clutter such as trees and buildings, determining clutter losses, determining transmission power levels, planning base station site locations, and/or managing spectrum allocation and/or usage. The present invention further relates to methods and apparatus which utilize propagation clutter loss between a transmitter and a receiver determined based on clutter identified using Integrated Sensing and Communications (ISAC) to manage spectrum allocation.

### BACKGROUND OF THE INVENTION

Integrated Sensing and Communication (ISAC) is a 3GPP technology candidate which integrates sensing and spatial location of passive (not connected) objects into the mobile communications network, expanding the mobile communications network's functionality beyond just communication.

Some wireless networks, or particular regions of wireless spectrum, have introduced tiered access in which some entities have higher access priority than others. Various wireless systems share spectrum among tiers of users. Radio frequency propagation path loss models have been used for spectrum sharing among tiers of users in bands such as for example, the 3.5 GHz spectrum frequency band used for Citizens Broadband Radio Service (CBRS) and 6 GHz spectrum frequency band which in some instances is used for Wi-Fi. In CBRS systems the tiers of users include incumbent users, licensed users, and unlicensed users.

Path losses allow a spectrum access controller to determine if two users (in the same tier or different tiers) can use the same frequency in a geographic location given their transmission characteristics and the terrain profile between them. Over short distances (less than 5 kilometers), WINNER and Extended Hata (eHata) propagation path loss models are used to predict Radio Frequency (RF) path losses in a statistical manner in generic topologies, such as for example urban, suburban, and rural topologies. Over long distances (e.g., distances greater than 5 kilometers), the Irregular Terrain Model (ITM) also referred to as the Longley-Rice model and Terrain Integrated Rough Earth Model (TIREM) models are used to predict Radio Frequency path losses in a statistical manner using terrain heights. One important component of RF propagation is signal attenuation due to buildings and vegetation along the path known as clutter loss which may be determined using models such as the International Telecommunications Union (ITU) Recommendation ITU-R P.2108 entitled prediction of clutter loss. Clutter models are not very accurate due to the diverse nature of clutter, i.e., the density and height of buildings in different geographic areas—suburban, urban, dense urban. This generally leads to conservative estimations of the propagation loss resulting in inefficient spectrum sharing. Furthermore, without accurate clutter loss information the determination of transmission power level for devices as well as spectrum allocations are done conservatively so as to avoid interference especially with incumbent users in the CBRS systems. Moreover, with respect to wireless network planning without accurate clutter information, it is difficult to plan for site locations for base stations regardless of the type or types of spectrum utilized by the wireless network (e.g., licensed spectrum, unlicensed spectrum, shared spectrum and/or unshared spectrum) as the estimates of coverage areas based on predicted power transmission levels and signal strength which are inaccurate can lead to gaps in coverage and/or instances in which there is too much overlapping coverage which can result in low signal quality.

From the foregoing, it should be understood that there is a need for new and/or improved methods and apparatus for identifying clutter, determining information about clutter, determining clutter losses along propagation paths and/or near transmitters and receivers, determining propagation loss between a transmitter and a receiver based on clutter data, determining power transmission levels based on clutter data, and/or identifying base station site locations. From the foregoing, it should be understood that there is a need for new and/or improved methods of determining Radio Frequency propagation loss between a transmitter and receiver when the transmitter and/or receiver is in the vicinity and/or is surrounded by clutter. From the foregoing, it should be understood that there is a need for new and/or improved methods and apparatus for efficiently and effectively determining and managing the allocation and usage of spectrum (e.g., spectrum shared among tiers of users) in wireless systems based on the location of transmitters and receivers and terrain and clutter. There is a need for a solution to how to effectively and efficiently solve the technical problem of determining clutter loss from clutter affecting radio frequency transmission. This is particularly a problem when the transmitter and/or the receiver is embedded and/or is in vicinity of and/or is surrounded by clutter. There is a further need for new and/or improved methods and/or apparatus for accounting for clutter heights and locations in propagation models used for determining spectrum sharing among users in wireless systems, e.g., CBRS systems. There is a further need for new and/or improved methods and apparatus for allocating spectrum usage among wireless devices (e.g., base stations, wireless access points, etc.) to increase spectral efficiency in shared spectrum wireless systems such as for example CBRS systems.

### SUMMARY OF THE INVENTION

Various embodiments of the present invention provide new and/or improved methods and apparatus for identifying clutter and determining information about the clutter that can be used for determining clutter losses and determining the radio frequency propagation loss between a transmitter and a receiver assuming that the transmitter and/or receiver is located in the vicinity of and/or below clutter and/or is embedded in or surrounded by the clutter. Clutter includes objects, such as for example, vegetation, buildings, towers, or other man-made structures, which are located on top of the terrain of a geographic area. Various embodiments of the present invention further provide new and/or improved methods and apparatus for using the determined information about clutter to determine radio frequency propagation loss in managing the assignment/allocation and/or usage of shared spectrum among users of a wireless network. For example, by determining a predicted degree, amount, or level of RF interference at a point where a receiver is located from radio frequency transmission of a point at which a transmitter is located. Various embodiments provide new and/or improved methods and apparatus for more accurately determining propagation loss between two endpoints and predicting RF interference using determined clutter information. Various embodiments provide new and/or improved methods and apparatus for allocating spectrum usage among wireless devices (e.g., base stations, wireless access points, etc.) to increase spectral efficiency in shared spectrum wireless systems such as for example CBRS systems. Various embodiments of the present invention provided new and/or improved methods and apparatus for determining transmission power levels for wireless entities such as base station using information which more accurately identifies clutter, clutter locations, clutter losses, clutter heights, clutter size and clutter density. Various embodiments of the present invention provide new and/or improved methods of identifying base station site locations based on clutter information. Various embodiments of the present invention solve one or more of the problems discussed above.

Various embodiments of the present invention provide new and/or improved methods and apparatus for using Integrated Sensing and Communications in wireless systems (e.g., shared spectrum wireless systems) for identifying clutter in the vicinity of and/or surrounding and/or in an area surrounding a transmitter, determining clutter losses for radio frequency transmission paths, determining transmission power levels for radio frequency transmitters, planning base station site locations, and/or managing spectrum allocation and/or usage. Various embodiments of the present invention provide new and/or improved methods and apparatus which utilize Integrated Sensing and Communications (ISAC) to identify clutter and determine clutter losses between a transmitter and a receiver to manage spectrum (e.g., shared spectrum) such as by making decisions on spectrum allocations and usages based on RF interference predictions based on the determined clutter losses.

In various method embodiments sensing pulses transmitted from wireless network entities are used for identifying clutter (e.g., one or more items of clutter) in the vicinity and/or surrounding the wireless network entities and information about the identified clutter. The wireless network entities and/or other elements of the wireless system such a computer system or Spectrum Access System then utilize the determined clutter information to manage spectrum allocation and/or power transmission assignments for wireless network entities of the wireless system. The clutter information is determined using Integrated Sensing and Communication technology incorporated into the wireless network entities such as for example base stations of a wireless communications network to identify information (e.g., location, height, size, density, etc.) about the clutter in the vicinity and/or surrounding the wireless network entities. The information about the clutter surrounding the wireless network entities is used to determine radio frequency propagation losses due to the clutter and predict interference levels caused by radio frequency transmissions from the wireless network entities. Using the predicted interference, spectrum is managed including making decisions on spectrum allocations and usage in response to spectrum access requests or notifications of spectrum usage such as for example by incumbent users (e.g., Navy ship with radar moving into an area sending a notification about its usage). In various embodiments, the method is implemented in shared spectrum wireless networks (e.g., CBRS networks). In some embodiments, the computing system which performs the steps of allocating spectrum to wireless network entities is a Spectrum Access System which manages the usage of the shared spectrum. In various embodiments, the determined clutter information and/or clutter losses and/or predicted spectral interference determinations based on the determined clutter losses are used to determine transmission power levels for various network entities. In some embodiments, the determined clutter information and/or clutter losses and/or predicted RF interference determinations based on the determined clutter losses are used in planning for determining wireless network entity site locations (e.g., base station site locations).

An exemplary method includes the steps of: transmitting, from a first transmitter (e.g., of a first wireless entity), radio frequency sensing pulses; receiving, by a first receiver (e.g., of the first wireless entity or of a second wireless entity), reflected radio frequency sensing pulses, said reflected radio frequency sensing pulses being the transmitted radio frequency sensing pulses which have been reflected by one or more items of clutter in the vicinity or area of the first transmitter (e.g., clutter surrounding, in view of, or in a line of sight transmission path of the first transmitter); determining information about the one or more items of clutter based on information about the received reflected radio frequency sensing pulses; determining a clutter loss for one or more radio frequency propagation paths extending from the first transmitter to a second receiver (e.g., of a third wireless entity) based on the determined information about the one or more items of clutter, said one or more radio frequency propagation paths including a first radio frequency propagation path. In various embodiments, the first transmitter, first receiver, and second receiver are part of wireless communications entities such as for example, wireless network equipment devices, wireless base stations, wireless access points, customer premises equipment devices, and wireless user equipment devices (e.g., smartphones, mobile devices/stations, tablets, and/or laptops).

Another exemplary method includes the steps of: transmitting, by a first wireless base station (e.g., a first CBSD), radio frequency sensing pulses; receiving, by a second wireless base station (e.g., a second CBSD), reflected radio frequency sensing pulses, said reflected radio frequency sensing pulses being the transmitted radio frequency sensing pulses which have been reflected by one or more items of clutter in the vicinity of the first wireless base station; determining information about the one or more items of clutter in the vicinity of the first wireless base station based on information about the received reflected radio frequency sensing pulses; determining a clutter loss for one or more radio frequency propagation paths extending from the first wireless base station to a third wireless base station based on the determined information about the one or more items of clutter, said one or more radio frequency propagation paths including a first radio frequency propagation path.

In some embodiments, the radio frequency sensing pulses are transmitted along with communications data as part of a communications signal (e.g., OFDM symbols of a wireless data communication). In some embodiments, the radio frequency sensing pulses form a plurality of pulse-Doppler-based radar pulse trains which have been integrated into an OFDM resource grid being used for wireless communications.

In some embodiments, the information about the received reflected radio frequency sensing pulses includes: (i) an amount of time from when the radio frequency sensing pulses were transmitted from the first wireless base station to when the reflected radio frequency sensing pulses were received by the second wireless base station (e.g., the delay from when an RF sensing pulse is transmitted from a transmitter to when it is received by the receiver) and (ii) information on a spatial direction of the received reflected radio frequency sensing pulses.

In some embodiments, the step of determining information about the one or more items of clutter based on information about the received reflected radio frequency sensing pulses includes: identifying a clutter type of a first item of clutter based on information about the transmitted radio frequency sensing pulses and the received reflected radio frequency sensing pulses, said first item of clutter being one of the one or more items of clutter.

In some embodiments, the said determining information about the one or more items of clutter based on information about the received reflected radio frequency sensing pulses further includes: determining a first clutter distance for a first item of clutter, said first item of clutter being one of the one or more items of clutter, said first clutter distance being the distance between a first transmitter of the first wireless base station and the first item of clutter.

In some embodiments where monostatic sensing is employed, the first wireless base station and the second wireless base station are the same wireless station; and the step of determining information about the one or more items of clutter based on information about the received reflected radio frequency sensing pulses further includes: determine a scattering cross section (o) for the first item of clutter based on: (i) a transmitted power (Pₜ) of the radio frequency sensing pulses, (ii) a received power (Pᵣ) of the reflected radio frequency sensing pulses; (iii) a wavelength (λ) of the transmitted radio frequency sensing pulses, (iv) the first clutter distance; and (v) a gain of an antenna used to transmit the radio frequency sensing pulses and receive the reflected radio frequency sensing pulses.

In various embodiments, the method further includes the step of identifying a clutter type for the first item of clutter based on the determined scattering cross section for the first item of clutter.

In various embodiments, the method further includes the steps of making a spectrum usage decision based on a first radio frequency propagation path loss for the first radio frequency propagation path extending from the first wireless base station to the third wireless base station. In some such embodiments, the first radio frequency propagation path loss is based on said determined clutter loss for the first radio frequency propagation path extending from the first wireless base station to the third wireless base station.

In some embodiments, the method further includes the step of making a spectrum usage decision based on the determined clutter loss for the one or more radio frequency propagation paths extending from the first wireless base station to the third wireless base station, said determined clutter loss including at least one clutter loss for a path extending from the first wireless base station to one of the one or more items of clutter determined as a scattering loss determined as a function of a scattering cross section of the one or more items of clutter.

In some embodiments, the clutter loss includes a first clutter loss (L_{tx-sc}) for a first radio frequency propagation path extending from a point of transmission of a first transmitter of the first wireless base station to a first item of clutter and a second clutter loss (L_{sc-rx}) for a second radio frequency propagation path extending from the first item of clutter to the point of reception at a receiver of the third wireless base station, said first item of clutter being one of the items of clutter in the vicinity of the first wireless base station.

In some embodiments, the step of determining information about the one or more items of clutter in the vicinity of the first wireless base station based on information about the received reflected radio frequency sensing pulses includes: determining whether the first item of clutter blocks a line-of-sight transmission path between the first wireless base station and the third wireless base station. In some embodiments, the method further includes determining the first clutter loss as a single diffraction loss in response to determining that the first item of clutter blocks the line-of-sight transmission path between the first wireless base station and the third wireless base station.

In some embodiments, the method further includes the step of determining the first clutter loss as a scattering loss in response to determining that the first item of clutter does not block the line-of-sight path between the first wireless base station and the third wireless base station. In some embodiments, the step of determining information about the one or more items of clutter includes determining a type of clutter for the first item of clutter from a set of clutter types, said set of clutter types including a building clutter type and a tree clutter type; and wherein the scattering loss is determined as a function of a scattering cross section of the first item of clutter.

In some embodiments, the method further includes the steps of: prior to determining the scattering loss for the first item of clutter determining the scattering loss for different types of clutter; and storing the scattering losses in memory. In some such embodiments, the step of determining the scattering loss for the first item of clutter includes looking up the scattering loss based on the determined type of clutter of the first item of clutter and information on the scattering cross section for the first item of clutter.

In some embodiments, the second clutter loss (L_{sc-rx}) is determined using terrain and clutter heights profile information for a propagation path extending from the first item of clutter to an antenna of a receiver of the third wireless base station.

In some embodiments, the step of making a spectrum usage decision based on the first radio frequency propagation path loss for the first radio frequency propagation path includes: determining a predicted amount of RF interference for a range of spectrum frequencies that will occur at the third wireless base station from radio frequency transmissions emanating from the first wireless base station based on the first radio frequency propagation path loss; and determining whether or not the first wireless base station is authorized to communicate using the range of spectrum frequencies based on the predicted amount of RF interference.

In some embodiments, the step of making a spectrum usage decision based on the first radio frequency propagation path loss for the first radio frequency propagation path includes: determining that the first wireless base station is authorized to utilize spectrum to communicate with another wireless network entity in response to determining that a predicted amount of RF interference that will occur at the third wireless base station from radio frequency transmissions emanating from the first wireless base station is below a first threshold level of interference.

The present invention is also applicable to and includes apparatus and systems such as for example, apparatus and systems that implement the steps and/or functions of the method embodiments. For example, a system in accordance with one embodiment of the present invention includes: a first wireless base station (e.g., a first CBSD) including a first processor configured to operate the first wireless base station to transmit radio frequency sensing pulses; and a second wireless base station (e.g., a second CBSD) including a second processor configured to operate the second wireless base station to: receive reflected radio frequency sensing pulses, said reflected radio frequency sensing pulses being the transmitted radio frequency sensing pulses which have been reflected by one or more items of clutter in the vicinity of the first wireless base station; determine information about the one or more items of clutter in the vicinity of the first wireless base station based on information about the received reflected radio frequency sensing pulses; and determine a clutter loss for one or more radio frequency propagation paths extending from the first wireless base station to a third wireless base station based on the determined information about the one or more items of clutter, said one or more radio frequency propagation paths including a first radio frequency propagation path.

In various embodiments, the invention is applied to clutter which is in view of the first wireless base station transmitter or in a line of sight of the first wireless base station transmitter, or in area surrounding the first wireless base station and, in such embodiments, such clutter is included in the one or more items of clutter in the vicinity of the first wireless base station.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE DRAWINGS

FIG. 1 illustrates an exemplary system in accordance with an embodiment of the present invention.

FIG. 2 is an illustration of an exemplary pulse-Doppler-based radar system pulse train which has been integrated into an OFDM resource grid being used for wireless communications.

FIG. 3 illustrates monostatic sensing.

FIG. 4 illustrates bistatic sensing.

FIG. 5 illustrates multi-static sensing in which there is one transmitting wireless node which transmits pulse train signals and two wireless nodes receiving the reflected pulse train signals.

FIG. 6 illustrates an exemplary computing system in accordance with an embodiment of the present invention.

FIG. 7 illustrates a wireless network entity device in accordance with an embodiment of the present invention.

FIG. 8 illustrates an exemplary assembly of components for a wireless network entity device in accordance with an embodiment of the present invention.

FIG. 9 illustrates an exemplary assembly of components for a computing system in accordance with an embodiment of the present invention.

FIG. 10 illustrates an example showing the angles used in determining a bistatic scattering cross section.

FIG. 11 illustrates an example of a scattering loss table for clutter which is a building in accordance with an exemplary embodiment of the present invention.

FIG. 12 illustrates clutter loss determination in an exemplary embodiment of the present invention.

FIG. 13 comprises FIG. 13A, FIG. 13B, FIG. 13C, FIG. 13D, FIG. 13E, FIG. 13F and FIG. 13G.

FIG. 13A is the first part of a flowchart of an exemplary method in accordance with an embodiment of the present invention.

FIG. 13B is the second part of a flowchart of an exemplary method in accordance with an embodiment of the present invention.

FIG. 13C is the third part of a flowchart of an exemplary method in accordance with an embodiment of the present invention.

FIG. 13D is the fourth part of a flowchart of an exemplary method in accordance with an embodiment of the present invention.

FIG. 13E is the fifth part of a flowchart of an exemplary method in accordance with an embodiment of the present invention.

FIG. 13F is the sixth part of a flowchart of an exemplary method in accordance with an embodiment of the present invention.

FIG. 13G is the seventh part of a flowchart of an exemplary method in accordance with an embodiment of the present invention.

### DETAILED DESCRIPTION

The examples set forth below represent the information to enable individuals to practice various embodiments of the present invention. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims. As used herein of ordinals in conjunction with an element is solely for distinguishing what might otherwise be similar or identical labels, such as “first wireless network entity” and “second wireless network entity” and does not imply an initial occurrence, a quantity, a priority, a type, an importance, or other attribute, unless otherwise stated herein. As used herein, the terminology “one or more of the following” and “one or more or all of the following” includes any combination of items, elements, or steps which follow the quoted language.

As previously discussed, some wireless networks, or particular regions of wireless spectrum, have introduced tiered access frameworks in which some entities have higher access priority than others. For example, the Citizens Broadband Radio Service (CBRS) refers to a shared region of wireless spectrum that allows different entities to utilize the same frequency bands dynamically. The Federal Communications Commission (FCC), which manages aspects of the CBRS, has introduced multiple tiers of access for the CBRS (e.g., incumbent entities, Priority Access License (PAL) holding entities, General Authorized Access (GAA) entities). Management of access to such wireless networks is often handled by a managing entity, such as a Spectrum Access System (SAS). To follow the previous example, in CBRS incumbent entities include federal entities including the U.S. Navy which have radar systems which use the CBRS 3.5 GHz band for radar. The Priority Access tier consists of Priority Access Licenses (PALs) users that are licensed use of a portion of the CBRS spectrum within a geographic area. The General Authorized Access (GAA) tier is licensed-by-rule to permit open, flexible access to the band for the widest possible group of potential users. General Authorized Access users are permitted to use any portion of the 3550-3700 MHz band not assigned to a higher tier user and may also operate opportunistically on unused Priority Access channels. Incumbent entities/users have the highest priority, PAL entities/users have the second highest priority and GAA entities have the lowest priority). In CBRS, the SAS determines the available frequencies at a given geographic location and assign them to wireless base stations referred to as CBSDs; it determines the maximum permissible transmission power level for CBSDs at a given location and communicates that information to the CBSDs; it registers and authenticates the identification information and location of CBSDs; it enforces exclusion and protection zones, including any future changes to such Zones, to ensure compatibility between Citizens Broadband Radio Service users and incumbent federal operations; it protects Priority Access Licensees (PAL) from impermissible interference from other Citizens Broadband Radio Service users; ensures secure and reliable transmission of information between the SAS, ESC, and CBSDs. Through the management of the access to CBSD spectrum and CBSDs power transmission levels in a geographical area the SAS manages the radio interference in the geographical area.

When managing spectrum access in CBRS, the SAS typically incorporate information from an Environmental Sensing Capability (ESC), a sensor network that detects transmissions from Department of Defense radar systems and transmits that information to the SAS. The SAS will then coordinate operations between and among users in the three tiers of authorization in the 3.5 GHz band: Incumbent Access, Priority Access, and General Authorized Access.

In CBRS, the SAS may receive a CBRS access request from an incumbent entity and/or information from an Environmental Sensing Capability system that reports the detection of a transmission from the Department of Defense radar systems, and in response, identify and revoke access grants and/or reduce power transmission levels from the non-incumbent entities likely to cause interference.

Some tiered access networks are capable of assigning multiple network entities to the same part of frequency band (i.e. co-channel or adjacent channel) based on a predicted degree of interference. The predicted degree of interference can be determined by a SAS based on terrain information, which generally includes accurate measurements of terrain height within specific geographic areas. For example, if a SAS receives spectrum access requests for the same frequency band from two network entities located in the same area, the SAS may accept or reject the requests based on a predicted degree, amount or level of interference for each of the entities. This degree, amount or level of interference can be predicted based on path loss. Path loss, in turn, can be predicted at least partially based on the height of terrain located between the network entities. In this manner, the SAS can utilize terrain height information to determine whether to grant spectrum access to a requesting entity and the maximum transmission power level the requesting entity is allowed to utilize so as to minimize interference with other network entities.

More specifically, a SAS can determine a predicted degree of interference for a device requesting or requiring spectrum access based on the height of terrain existing between two entities (e.g., a Navy ship radar and a network base station). If there is relatively high terrain with sufficient blocking to avoid interference between the requesting and receiving entities (e.g., obstructing a line of sight between the entities), the predicted degree of interference is likely to be low. In addition to spectrum access and/or usage decisions, terrain information (e.g., information describing local terrain heights) can be utilized to make a number of organizational and architectural network planning decisions (e.g., such as where to locate base stations to minimize interference between base stations while maximizing wireless network coverage area).

However, conventional terrain information usually fails to account for “clutter” that is located atop the terrain. Clutter can reduce wireless interference via “blocking,” which refers to physically obstructing wireless signals before one can interfere with the other. “Clutter” includes any object (e.g., vegetation, billboard, infrastructure, etc.), building, man-made entity, etc. located atop the terrain of a geographic area. In some instances, the differences between terrain height and the combination of terrain and existing clutter height can be substantial. Terrain height or evaluation being the vertical distance from mean sea level to a point or object on the Earth's surface. For example, while the terrain of New York City in some locations is only 2-3 meters above sea level, clutter located atop the terrain of New York City can be over 400 meters in height (e.g., the One World Trade Center, the Empire State Building, etc.).

To summarize, predicted interference can be determined based on terrain information (e.g., terrain elevation or height information) which does not include clutter heights, and clutter can cause substantial blockage of the transmission of wireless signals. As such, decisions made using predicted interference determined based on terrain information are necessarily inaccurate. To mitigate these inaccuracies, some decision making entities (e.g., network service providers and/or their spectrum usage decision making devices/systems) conservatively assume low or no clutter exists in particular geographic regions due to the actual degree of clutter being unknown.

To follow the previous example regarding a CBRS system, assume that two network entities (e.g., two wireless base stations which may, and in some embodiments do, belong to the same or different network wireless operators) are located in a New York City suburb with relatively high clutter (e.g., tall buildings), and that both entities submit spectrum access requests to a SAS. With accurate clutter information, the SAS may predict a degree of interference sufficiently low as to grant both requests. However, without accurate clutter information, the SAS may predict a degree/level/amount of interference based on clutter that is low or non-existent to prevent the two network entities from interfering with each other, so it would not grant both requests. In this manner, a lack of accurate obstruction information (e.g., clutter and terrain information) can impede the SAS (and other network functions) from fully utilizing available frequency spectrum, thus substantially reducing network capacity.

Accordingly, implementations of the present disclosure propose optimizing spectrum assignment and/or maximum power transmission limits based on using Integrated Sensing and Communication (ISAC) technology included in wireless network entity devices of wireless systems (e.g., CBRS systems) to identify clutter and information about clutter in the vicinity of wireless network entity device transmitters and receivers. The identification of the clutter (its location, size, density, etc.) is then used to determine radio frequency propagation information (e.g., radio frequency propagation losses) due to the clutter. The propagation information (e.g., clutter loss) of a radio frequency propagation signal transmitted from a first transmitter of a first wireless device (e.g., a base station) of a first wireless communications system in the direction of a second wireless device (e.g., another base station) or system is used to estimate or predict the interference caused by the first wireless device of the first wireless communications system to the second wireless device or system by the first wireless device of the first wireless communications system. The estimated and/or predicted interference may be, and in some embodiments is, used to manage the allocation of spectrum (e.g., shared spectrum) among wireless devices.

For example, in some embodiments, a computing system such as an SAS generates a propagation profile that includes a predicted degree of interference for a second wireless network entity (e.g., a wireless base station or endpoint device) which will be caused by transmissions from a first wireless network entity (e.g., a first base station). If the predicted degree of interference is less than a threshold degree of interference, the computing system can make a spectrum access decision to grant a spectrum access request from the first wireless network entity. In such a fashion, the computing system can more accurately evaluate predicted interference for a wireless network entity, thus enabling the computing system to grant spectrum access requests that it may otherwise reject.

Various embodiments of the present invention provide a number of technical effects and benefits. As one example technical effect and benefit, implementations described herein substantially increase network utilization efficiency and spectrum efficiency. Specifically, conventional systems that mediate access to networks, such as SASs, do so based on interference predictions. Interference predictions are conventionally determined based on information describing terrain heights but do not include accurate information about clutter surrounding or in the area of transmitters and receivers. Without accurate clutter information, interference predictions can be substantially inaccurate, and as such, conventional systems must make conservative spectrum access decisions to account for these inaccuracies. The ability to increase and/or maximize spectral efficiency of shared spectrum is extremely important and objective of not only network operators but also the Federal Communications Commission which licenses and controls the usage of spectrum (e.g., in U.S. locations).

This is often accomplished by assuming a low or no clutter height scenario for a particular geographic region. Based on this “worst-case” scenario, the SAS will often deny a spectrum access request that, with access to accurate clutter information, it would otherwise grant. However, implementations described herein enable generation of propagation profiles which taken into account radio frequency propagation losses for scattering caused by clutter in the vicinity of transmitters and/or receivers thus enabling substantially more accurate propagation profiles and corresponding interference predictions. In turn, the capacity to more accurately predicting interference enables SASs to increase spectral efficiency by for example, making less conservative spectrum access decisions, thus substantially increasing network capacity.

The more accurate propagation profiles also allow SASs to more accurately determine power transmission levels (e.g., maximum power transmission levels) to be used by wireless network equipment entities (e.g., wireless base stations) for assigned and/or allocated spectrum in order to minimize interference between wireless network equipment entities (e.g., wireless base stations, user equipment devices, endpoint devices, wireless receiver and/or transmitter devices, wireless sensors, radar system devices, etc.) to be below predetermined threshold interference levels.

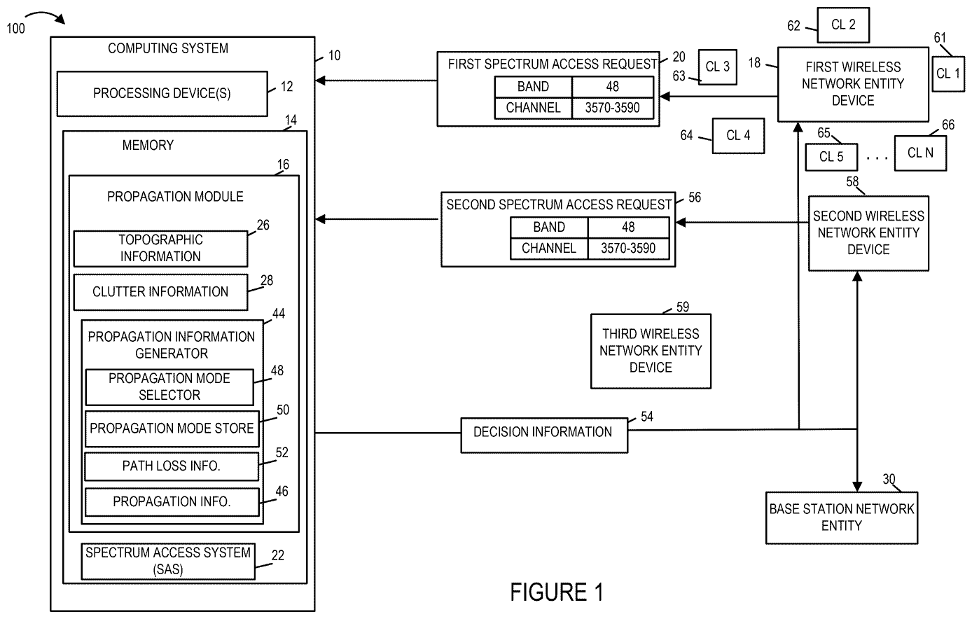

FIG. 1 is a block diagram of an environment suitable and/or exemplary system 100 for implementing optimization of frequency spectrum assignment, grant and/or usage according to some implementations of the present disclosure. The environment and/or exemplary system 100 includes a computing system 10, a plurality of wireless network entity devices (i.e., first wireless network entity device 18, second wireless network entity device 58, third wireless network entity device 59, and base station network entity device 30), and items of clutter (CL 1 61, CL 2 62, CL 3 63, CL 4 64, CL 5 65, . . . , CL N 66) which are in the vicinity of and surround the first wireless network entity. The present invention is applicable to situations in which: (i) clutter is in the area of the first wireless base station or its transmitter transmission point such as for example an area around or surrounding the first wireless base station or its transmitter/antennas, (ii) clutter is in view of, or in a line of sight of, or which can be seen by the first wireless base station transmitter/antenna, (iii) clutter is surrounding the first wireless base station or its transmitter/antenna, and (iv) the transmitter/antenna of the first wireless base station is embedded in and/or below one or more items of clutters.

The computing system 10 includes one or more processing device 12 and memory 14. The memory 14 includes a propagation module 16 and a spectrum access system module/component 22. The propagation module 16 includes topographic information 26, clutter information 28 (e.g., scattering cross section information including scattering cross sections for different types of clutter, monostatic scattering cross sections for different types of clutter, bistatic scattering cross sections for different types of clutter, monostatic and/or bistatic scattering cross section loss information for different types of clutter), and a propagation information generator 44. The propagation information generator 44 including propagation mode selector 48, a propagation mode store 50, path loss information 52, and propagation information 46. Items of clutter (CL 1 61, CL 2 62, CL 3 63, CL 4 64, CL 5 65, . . . , CL N 66) are in the vicinity of and surround the first wireless network entity. The elements of system 100 will be discussed in further detail below.

The present invention utilizes the Integrated Sensing and Communication (ISAC) capability of a wireless communications system to identify clutter (e.g., buildings, trees, vegetation, etc.) in its vicinity. The identification of clutter (its location, size, and density) is used to determine Radio Frequency propagation losses due to clutter (i.e., clutter loss). Clutter loss in the direction of another system or wireless device is used to estimate interference caused by the wireless communications system to the other system or wireless device.

For example, clutter loss in the direction from a transmitter of a first wireless communications system employing ISAC technology (e.g., from a CBSD of a first CBRS system operated by a first wireless operator) to a second wireless system (such as for example an incumbent Navy radar system) is used to estimate interference caused by the first wireless communications system to the second wireless system (e.g., the incumbent Navy radar system). Similarly, clutter loss in the direction from a transmitter of a first wireless communications system employing ISAC technology (e.g., from a CBSD of a first CBRS system operated by a first wireless operator) to a second wireless communications system (such as for example a different wireless communications system such as a licensed communications system being operated by a second wireless operator) is used to estimate interference caused by the first wireless communications system to the second wireless communications system.

The interference estimates are used to improve spectrum sharing between the first communications wireless system and the second wireless system which are using the same spectrum or adjacent spectrum for example by managing the allocation of shared spectrum to wireless devices and its usage so as to minimize interference as well as managing the transmission power levels of different devices to minimize RF interference.

Interference estimation(s) can be done by the first wireless communications system itself or a spectrum access system (SAS) or other spectrum resource management devices or systems that control spectrum access for multiple wireless communications systems utilizing the shared spectrum.

Furthermore, in addition to the use of interference estimates to manage the allocation of shared spectrum among different users and wireless communications systems based on the identification of clutter and determination of clutter loss, the identification of clutter may, and in some embodiments of the present invention is also used for network planning, e.g., determining the placement of wireless nodes (e.g., base stations, repeaters, etc.) in a wireless communications network to improve network coverage and/or capacity.

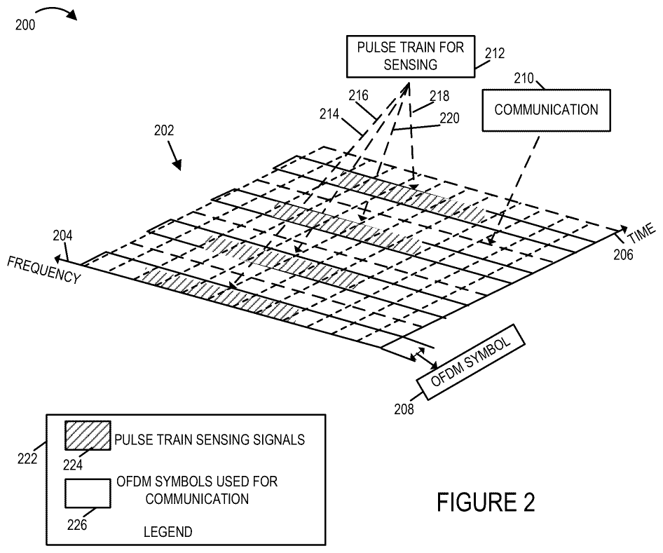

In various embodiments, a pulse-Doppler based radar system is integrated into an OFDM wireless communications system (e.g., into wireless devices such as base stations (e.g., CBSDs) of a wireless communications system (e.g., CBRS wireless communications system). FIG. 2 is an illustration of an exemplary pulse-Doppler-based radar system pulse train which has been integrated into an OFDM resource grid being used for wireless communications similar to FIG. 2 shown in the article entitled, “Integrated Sensing and Communication” dated, Jun. 18, 2024, by Robert Baldemair which is available on the Internet at: https://www.ericsson.com/en/blog/2024/6/integrated-sensing-and-communication, which is hereby incorporated by reference in its entirety.

The OFDM resource grid with integrated pulse trains for sensing 202 is shown as a grid with the X axis representing frequency 204 and the Y axis representing time 206. Each block contains and OFDM symbol (e.g., for communication) or a pulse for sensing. OFDM symbol 208 is an exemplary OFDM symbol of the OFDM resource grid 202. As the legend 222 indicates blocks with slanted lines [symbol] 224 in the OFDM resource grid 202 represent pulse train sensing signals while empty blocks [symbol] 226 which do not have slanted lines in the OFDM resource grid 202 represent OFDM symbols used for communication (e.g., communication of data or control signals to a device). The resource grid 202 includes a plurality of exemplary pulse trains for sensing 212 (first pulse training for sensing 214, second pulse train for sensing 216, third pulse train for sensing 218 and fourth pulse train for sensing 220 which have been integrated in the OFDM resource grid 202 being used for communication. Resource 210 illustrates an exemplary resource block of the OFDM resource grid 202 having an OFDM symbol being used for communications. As noted in the “Integrated Sensing and Communication” dated, Jun. 18, 2024, by Robert Baldemair matched filtering of each received pulse is performed to obtain a correlation peak, which indicates the range to the target or object.

An exemplary embodiment of the invention works as follows. A transmitter of a wireless device (e.g., a base station) transmits a pulse train along with its standard communications signal (e.g., as shown in FIG. 2). The pulse train is detected by a receiver of the transmitting wireless device and/or another wireless device after being reflected by the clutter. The delay of the received signals of the pulse train is used along with the spatial direction to identify information about the clutter including for example the clutter's location, size and density. The spatial direction (e.g., the direction of the clutter relative to the receiver position) may be, and in some embodiments is, determined through the use of a multi-antenna processing at the receiver. For example, the spatial direction may, and in some embodiments, uses a receiver (e.g., base station) which utilizes beamforming and angle of arrival estimation to determine the spatial direction of the clutter relative the receiver position. Information obtained about the clutter is then used to determine propagation clutter loss. The propagation clutter loss is in turn used to determine interference at other wireless devices and to manage spectrum allocation based on the determined interference.

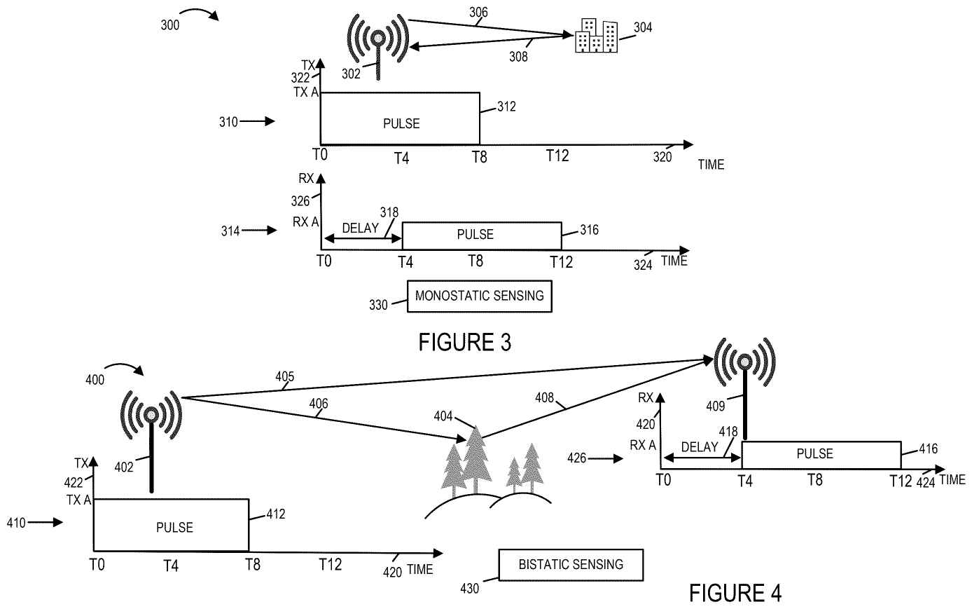

FIG. 3 diagram 300 illustrates monostatic sensing. In monostatic sensing the same wireless node (e.g., a wireless device such as a base station) 302 acts as the transmitter and receiver. The wireless node 302 transmits a pulse train sensing signal 306 which is reflected by clutter 304. The exemplary clutter 304 is shown in diagram 300 of FIG. 3 as buildings. The reflected pulse train sensing signal 308 is received by the wireless node 302. The wireless node determines the delay between the transmission of the pulse train sensing signal 306 to when the wireless node received the reflected pulse train sensing signal 308. Based on the determined delay and the spatial direction to the clutter 304 which is determined by the wireless node by means of beaming forming, the wireless node 302 identifies the clutter location, size and density.

The signal diagram 310 of FIG. 300 shows the transmission of an exemplary pulse 312 from the transmitter of the wireless node 302. The X axis 320 shows time with specific times T0, T2, T4, T8, and T12 being shown along the X axis. The Y axis 322 shows amplitude with TX A being the amplitude of the transmitted pulse 312. The beginning of the transmission of the pulse 312 starting at time T0. The pulse 312 having a pulse width of time T8−T0.

The signal diagram 314 of FIG. 3 shows the reception of the reflected pulse 316 by the receiver of the wireless node 302. The reflected pulse 316 being the pulse 312 reflected off the clutter 304. The X axis 324 shows time with specific times T0, T2, T4, T8 and T12 being shown along the X axis. These are the same times as shown in diagram 310. The Y axis 326 shows amplitude with RX A being the amplitude of the received reflected pulse 316. The TX A amplitude being greater than the RX A amplitude as the amplitude of the reflected pulse 316 is not as great as the transmitted pulse 312. Delay 318 shows the delay from the transmission of the pulse 312 which commenced from the wireless node 302 at time T0 to when the reflected pulse 316 was received by the wireless node 302 at time T4. The delay is determined by the formula T4−T0 where T4 is time at which the initial edge of the received reflected pulse 316 was received and T0 is the time the leading edge of the transmitting pulse 312 commenced being transmitted. Monostatic sensing may, and in some embodiments does, require fast downlink to uplink switching or full duplex reception depending on the distance between the wireless node and the clutter and/or the delay. The distance between the wireless node and the clutter sometimes being referred to as the clutter distance. For a wireless node that is a base station the downlink mode of operation refers to when the base station is transmitting messages to from the base station to the wireless devices it is providing services (e.g., smartphones) and the uplink mode of operation refers to the wireless base station receiving transmissions from wireless devices it is providing services.

FIG. 4 diagram 400 illustrates bistatic sensing. In bistatic sensing transmission and reception of the pulse sensing train are performed by different wireless nodes wherein a first wireless node (e.g., a first wireless device such as a first base station) 402 transmits the pulse train and a second wireless node (e.g., a second wireless device such as a second base station) 408 receives the pulse train (e.g., after reflection or refraction from clutter). The first wireless node 402 transmits a pulse train sensing signal 406 which is reflected by clutter 404. The exemplary clutter 404 is shown in diagram 400 of FIG. 4 as a tree. The reflected pulse train sensing signal 408 is received by the second wireless node 409. The pulse train sensing signal also travels along path 405 directly to the receiver without being reflected by clutter. The locations of the first wireless node 402 (e.g., antenna of 402) and the second wireless node 409 (e.g., antenna 409) are known as well as the distance between the first wireless node and the second wireless node. Based on the locations of the first and second wireless nodes and/or distance between the first and second wireless nodes, and the times (i) when the sensing pulses were transmitted, (ii) when the reflected sensing pulses were received at the second wireless node, and (iii) when the non-reflected pulses along path 406 were received at the second wireless node, the distance from the first wireless node transmitter antenna to the clutter can be determined as well as the distance from the clutter to the receiver antenna at the second wireless node. The delay between the transmission of the pulse train sensing signals by the first wireless and the receipt of the reflected and non-reflected is determined either by the first wireless node using information from the second wireless node, the second wireless node using information from the first wireless node or by a third node/device (e.g., an Spectrum Access System) using information from the first wireless node (e.g., commencement of transmission of the pulse signals) and information from the second wireless node (e.g., time of receipt of the non-reflected and reflected pulse signals). Based on the determined delays and the spatial direction to the clutter 404 which is determined by means of beaming forming, the identity, clutter location, size and density of the clutter 404 is determined.

The signal diagram 410 of FIG. 400 shows the transmission of an exemplary pulse 412 from the transmitter of the first wireless node 402. The X axis 420 shows time with specific times T0, T2, T4, T8, and T12 being shown along the X axis. The Y axis 422 shows amplitude with TX A being the amplitude of the transmitted pulse 412. The beginning of the transmission of the pulse 412 starting at time T0. The pulse 412 having a pulse width of time T8−T0.

The signal diagram 414 of FIG. 4 shows the reception of the reflected pulse 416 by the receiver of the second wireless node 409. The reflected pulse 416 being the pulse 412 reflected off the clutter 404. The X axis 424 shows time with specific times T0, T2, T4, T8 and T12 being shown along the X axis. These are the same times as shown in diagram 410. The Y axis 426 shows amplitude with RX A being the amplitude of the received reflected pulse 416. The TX A amplitude being greater than the RX A amplitude as the amplitude of the reflected pulse 416 is not as great as the transmitted pulse 412. Delay 418 shows the delay from the transmission of the pulse 412 which commenced from the first wireless node 402 at time T0 to when the reflected pulse 416 was received by the wireless node 409 at time T4. The delay is determined by the formula T4−T0 where T4 is time at which the initial edge of the received reflected pulse 416 was received and T0 is the time the leading edge of the transmitting pulse 412 commenced being transmitted. The information to determine the delay as well as the distance to the clutter is communicated from the first wireless node and the second wireless node to whichever node of the system is making the clutter determinations (e.g., the first wireless node, the second wireless node or a third node such as a Spectrum Access System).

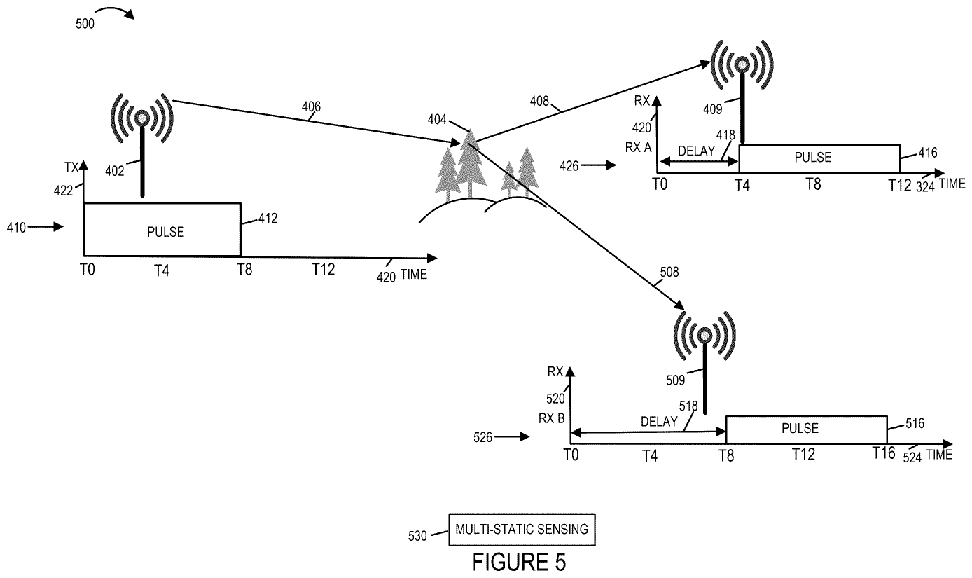

In some embodiments, multi-static sensing systems are utilized in which the reception of the reflected pulse train is performed by multiple wireless nodes at different locations providing additional information on the location, size and density of the clutter from which the pulse train was reflected. FIG. 5 diagram 500 illustrates multi-static sensing in which there is one transmitting wireless node which transmits the pulse train and two wireless nodes receiving the reflected pulse train signals. Elements or steps with the same reference numbers used in different figures are the same or similar and those elements or steps will not be described in detail again.

In the multi-static sensing system 500, the first wireless node 402 transmits the pulse train sensing signal 406 as previously described. The pulse train sensing signal 406 is reflected off clutter 404 in two different directions as reflected pulse train sensing signal 408 and reflected pulse train sensing signal 508. Reflected pulse train sensing signal 408 is received by the second wireless node 409 as previously described. The reflected pulse train 508 is received by a third wireless node 509.

The delay between the transmission of the pulse train sensing signal 406 by the first wireless node 402 to when the third wireless node 509 receives the reflected pulse train sensing signal 508 is determined either by a node in the system (e.g., a Spectrum Access System) using information from the first wireless node (e.g., commencement of transmission of the pulse signal 406) and information from the third wireless node (e.g., time of receipt of the reflected pulse signal 508). Based on the determined delay and the spatial direction to the clutter 404 which is determined by means of beaming forming identify of the clutter location, size and density 404 is determined.

The signal diagram 510 of FIG. 500 shows the transmission of an exemplary pulse 412 from the transmitter of the first wireless node 402. The X axis 420 shows time with specific times T0, T2, T4, T8, and T12 being shown along the X axis. The Y axis 422 shows amplitude with TX A being the amplitude of the transmitted pulse 412. The beginning of the transmission of the pulse 412 starting at time T0. The pulse 412 having a pulse width of time T8−T0.

The signal diagram 414 of FIG. 5 shows the reception of the reflected pulse 416 by the receiver of the second wireless node 408 as previously described in connection with FIG. 4.

The signal diagram 514 of FIG. 5 shows the reception of the reflected pulse 516 by the receiver of the third wireless node 409. The reflected pulse 516 being the pulse 412 reflected off the clutter 404. The X axis 524 shows time with specific times T0, T2, T4, T8, T12, and T16 being shown along the X axis. The Y axis 526 shows amplitude with RX B being the amplitude of the received reflected pulse 516. The TX A amplitude being greater than the RX B amplitude as the amplitude of the reflected pulse 516 is not as great as the transmitted pulse 412. Delay 518 shows the delay from the transmission of the pulse 412 which commenced from the first wireless node 402 at time T0 to when the reflected pulse 516 was received by the wireless node 509 at time T8. The delay is determined by the formula T8−T0 where T8 is time at which the initial edge of the received reflected pulse 516 was received and T0 is the time the leading edge of the transmitting pulse 412 commenced being transmitted. The information to determine the delay as well as the distance to the clutter is communicated from the first wireless node and the third wireless node to whichever node of the system is making the clutter determinations (e.g., the first wireless node, the second wireless node, the third wireless node or a fourth node such as for example a Spectrum Access System).

Bistatic and multi-static sensing require tight synchronization between the wireless nodes as the delay is determined based on information from the transmitting wireless node regarding when the pulse train transmission was transmitted and information from the receiving wireless node or nodes as to the time when the pulse train was received. In some embodiments, local oscillators which are calibrated on a regular basis are used for synchronization. In some embodiments a synchronization signal is sent between the wireless nodes for example via wired or optical cables connecting the wireless nodes. In some embodiments, synchronization is obtained using GPS signals received at the wireless nodes.

Clutter loss in each direction of transmission from the wireless communications system (e.g., the wireless nodes such as base stations of the wireless communications system) is determined by modeling signal propagation loss through the identified clutter. The clutter loss is added to the standard RF propagation loss (e.g., a RF propagation loss determined using any terrain based (only) propagation model such as the Irregular Terrain Model) to estimate interference and/or coverage of the wireless communications system (e.g., during use of the wireless communications system or during the planning of the wireless communications system (e.g., identifying site locations for base stations of the wireless communications system based on the determined signal interference and in turn the coverage and/or capacity of the wireless communications system)).

### Clutter Type and Distance Identification

To identify the clutter type of clutter surrounding a transmitter a scattering cross section σ(θₛ, φₛ; θᵢ, φᵢ) database for different types of clutter (such as for example: buildings and trees) is developed. The scattering cross section σ is also referred to as radar cross section. The received power (Pᵣ) is measured from the sensor receiver (i.e., the receiver antenna of the wireless node that receives the pulse train signal transmitted from the transmitter antenna of the transmitting wireless node.

For Bistatic radar the received power (Pᵣ) is given by the equation:

$${P}_{r} = \frac{{P}_{t} {λ}^{2} σ}{{( 4 π )}^{3} {R}_{1}^{2} {R}_{2}^{2}} {ℊ}_{t} {ℊ}_{r}$$

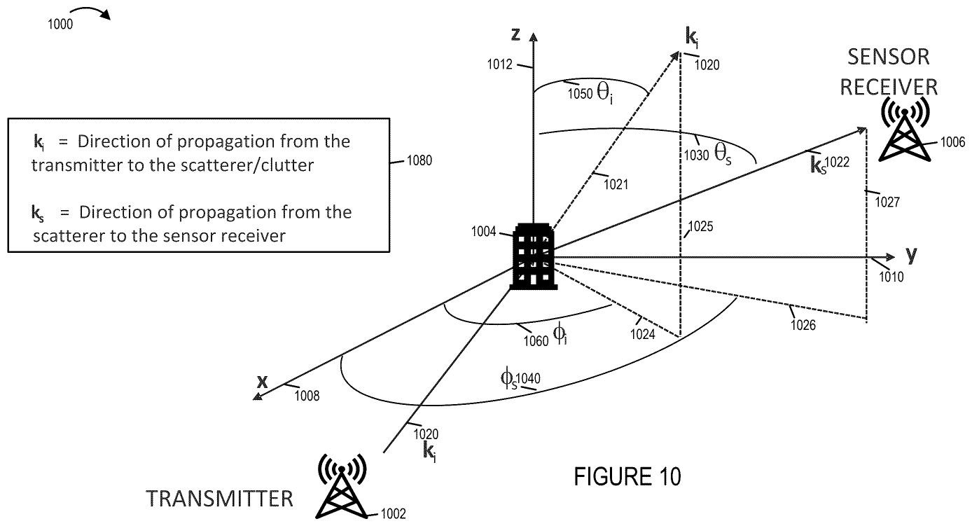

solving for the bistatic scattering cross section σ yields:

$$σ = \frac{{( 4 π )}^{3} {R}_{1}^{2} {R}_{2}^{2} {P}_{r}}{{P}_{t} {λ}^{2} {ℊ}_{t} {ℊ}_{r}}$$

where Pₜ is the transmit power (in watts);
where Pr is the received power (in watts);
where λ is the wavelength (in meters) of the sensing pulse signal;
where σ(θₛ, φₛ; θᵢ, φᵢ) is the bistatic scattering cross section in square meters where the index i=incident angles and s=scattering angles, where θᵢ and φᵢ are the polar and azimuthal incident angles towards the scatterer (which is the clutter) and θₛ and φₛ are the polar and azimuthal angles scattering angles away from the scatterer (which is the clutter), respectively as shown in FIG. 10;
where R1 is the distance in meters from the transmitter to the scatterer which is the clutter and can be determined using Time-Difference-of-Arrival (TDOA) where R2 is the distance in meters from the scatterer which is the clutter to the sensor receiver and can be determined using Time-Difference-of-Arrival (TDOA); and
where gₜ and gᵣ are the gain of the transmitter antenna and sensor-receiving antenna respectively.

For Monostatic radar the received power (Pᵣ) is given by the equation:

$${P}_{r} = \frac{{P}_{t} {λ}^{2} σ}{{( 4 π )}^{3} {R}^{4}} {ℊ}^{2}$$

solving for the monostatic scattering cross section σ yields:

$$σ = \frac{{( 4 π )}^{3} {R}^{4} {P}_{r}}{{P}_{t} {λ}^{2} {ℊ}^{2}}$$

where Pₜ is the transmit power (in watts);
where Pr is the received power (in watts);
where λ is the wavelength (in meters) of the sensing pulse signal;
where σ(θₛ, φₛ; θᵢ, φᵢ) (in dB square meters (dBsm)) is the scattering cross section where the index i=incident angles and s=scattering angles (for monostatic scattering i=s), where θᵢ and φᵢ are the polar and azimuthal incident angles towards the scatterer (which is the clutter) and θₛ and φₛ are the polar and azimuthal scattering angles away from the scatterer (which is the clutter);
where R is the distance (in meters) from the transmitter/receiver to the scatterer which is the clutter and can be determined using time of transmission from the transmitter/receiver of the sensing pulses and the time of arrival or receipt at the transmitter/receiver of the sensing pulses reflected by the clutter; and
where g is the antenna gain of the transmitter/receiver.

The receiver power Pᵣ is obtained at the sensor receiving node. In the monostatic case the distance R that the transmitter/receiver is from the clutter is determined using the time-delay of arrival between when the sensing pulses were transmitted by the transmitter/receiver to when the sensing pulses which were reflected by the clutter were received or arrived at the transmitter/receiver sometimes referred toas time-delay of arrival between transmitter-clutter-receiver.

The scattering cross section σ (θₛ, φₛ; θᵢ, φᵢ) is determined/calculated using the above equations for the bistatic and monostatic cases. Based on the determined scattering cross section, the type of clutter is then determined using a scattering cross section database which contains scattering cross section information (e.g., monostatic and bistatic scattering cross sections) for different types of clutter (e.g., buildings, trees, etc.). The determined scattering cross section is compared to the information on the scattering cross section (e.g., different scattering cross sections) for the different types of clutter stored in the scattering cross section database to identify the clutter's type (e.g., based on identifying the best match or fit to the clutter's signature (e.g., determined scattering cross section) from among the different scattering cross sections for the different types of clutter stored in the scattering cross section database).

Diagram 1000 of FIG. 10 illustrates an example showing the angles θₛ 1030, φₛ 1040, θᵢ 1050, φᵢ 1060 used in the above equations where σ(θₛ, φₛ; θᵢ, φᵢ) is the bistatic scattering cross section where the index i=incident angles and s=scattering angles, where θᵢ and φᵢ are the polar and azimuthal incident angles towards the scatterer (which is the clutter) and θₛ and φₛ are the polar and azimuthal angles scattering angles away from the scatterer (which is the clutter), respectively. In diagram 1000 the transmitter 1002 sends a communications signal including a pulse train towards the scatterer 1004. The direction of propagation of the pulse train from the transmitter 1002 to the scatterer 1004 is shown as Kᵢ 1020. The pulse train signal is scattered by the scatterer 1004 which is the clutter shown as a building. The scattered pulse train signal is received by the sensor receiver 1006. The direction of propagation of the pulse train from the scatterer 1004 to the sensor receiver 1006 is Kₛ 1022. X 1008, Y 1010, and Z 1012 form a Cartesian coordinate system on which the angles θₛ 1030, φₛ 1040, θᵢ 1050, φᵢ 1060 are illustrated. As stated in the legend 1080, Kᵢ 1020 is the direction of propagation from the transmitter to the scatterer and Kₛ 1022 is the direction of propagation from the scatterer to the sensor receiver. Dashed lines 1021, 1024, 1025 are used to show the angle of incidence θᵢ. Dashed lines 1022, 1026, and 1027 are used to show the scattering angle θₛ.

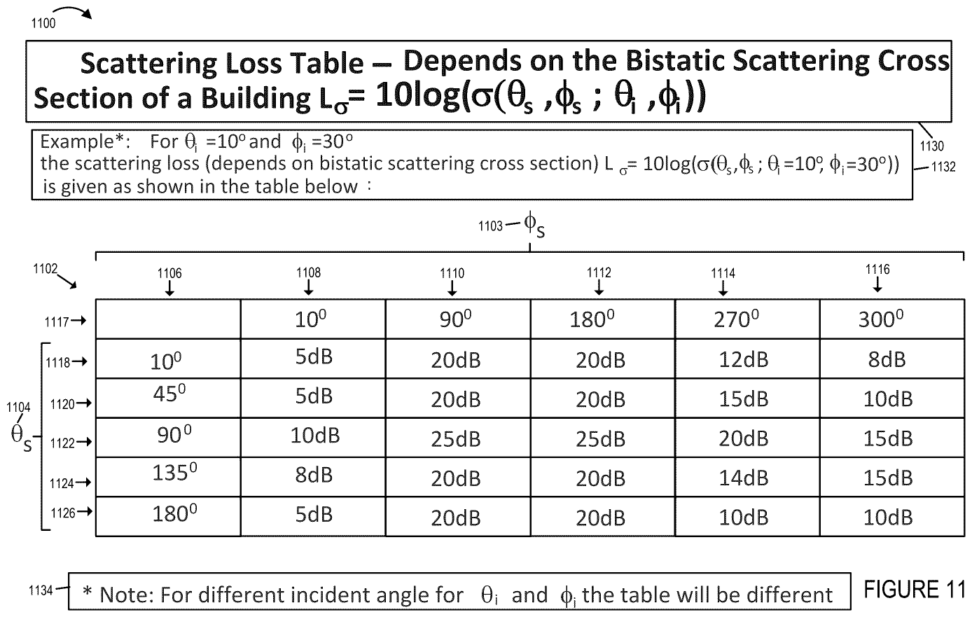

Diagram 1100 of FIG. 11 illustrates an example of a scattering loss table for clutter which is a building. As the title 1130 of FIG. 11 indicates the scattering loss depends on the Bistatic Scattering Cross Section of the building which is given by the equation:

$${L}_{σ} = 10 log ( σ ( {Θ}_{s} , {ϕ}_{s} ; {Θ}_{i} , {ϕ}_{i} )$$

Exemplary scattering loss table 1102 is for clutter which is a building and as indicated in the legend 1132 the scattering losses indicated in the scattering loss table 1102 are signals with incident angles of θᵢ=10 degrees and φᵢ=30 degrees. Also as indicated in note 1134, for different incident angles for θᵢ and φᵢ the table will different (e.g., there will be different losses for the scattering angles included in the table).

Scattering loss table 1102 includes columns 1106, 1108, 1110, 1112, 1114, 1116 and rows 1117, 1118, 1120, 1122, 1124, 1126. The entries in row 1117 are the values of scattering angles φₛ 1103 which are for the entries in the same row.

The entries in column 1106 are the values of scattering angle θₛ 1104 which are for entries in the same column. Entries in column 1108 scattering losses for φₛ=10 degrees. Entries in column 1110 are scattering losses for φₛ=90 degrees. Entries in column 1112 are scattering losses for φₛ=180 degrees. Entries in column 1114 are scattering losses for φₛ=270 degrees. Entries in column 1116 are scattering losses for φₛ=300 degrees.

Entries in row 1118 scattering losses for θₛ=10 degrees. Entries in row 1120 are scattering losses for θₛ=90 degrees. Entries in row 1120 are scattering losses for θₛ=45 degrees. Entries in row 1122 are scattering losses for θₛ=90 degrees. Entries in row 1124 are scattering losses for θₛ=135 degrees. Entries in row 1126 are scattering losses for θₛ=180 degrees.

Examples of how to read the table is now provided. With a signal having incident angles θᵢ=10 degrees and φᵢ=30 degrees and scattering angles φₛ=90 degrees and θₛ=135 degrees the scattering loss is 20 dB (entry column 1110, row 1124). With a signal having incident angles θᵢ=10 degrees and φᵢ=30 degrees and scattering angles φₛ=270 degrees and θₛ=10 degrees the scattering loss is 12 dB (entry column 1114, row 1118).

### Clutter Loss Determination

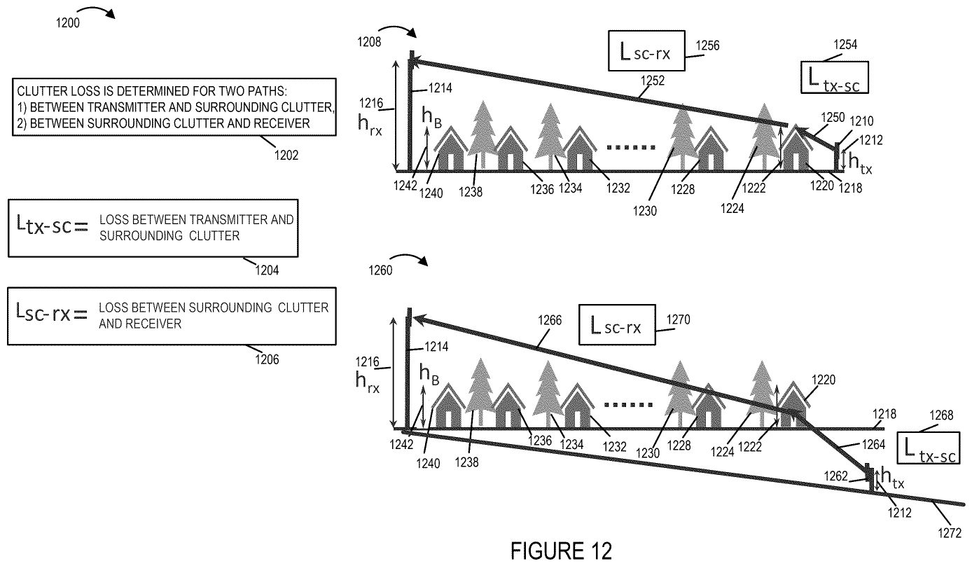

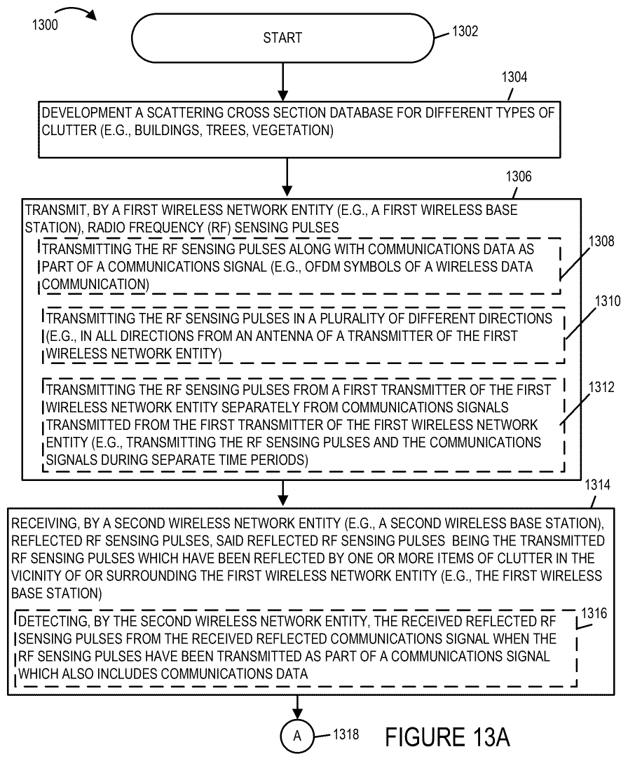

Clutter loss determination, for example for spectrum sharing between a CBRS commercial wireless system transmitter and a CBRS incumbent system receiver (e.g., Navy system receiver) will now be discussed in connection with FIG. 12.

As indicated in diagram 1200 legend 1202 of FIG. 12, clutter loss is determined for two paths: (i) the first path being between the transmitter and the surrounding clutter, and (ii) the second path being between the surrounding clutter and the receiver.

Loss between the transmitter and surrounding clutter is referred to as L_{tx-sc} as indicated in legend 1204 of diagram 1200 of FIG. 12. Monostatic sensing or bistatic sensing is used to determine the types of clutter surrounding the transmitter and their respective clutter distances using the equations described above.

For each item of clutter identified surrounding the transmitter the loss between the transmitter and the surrounding clutter L_{tx-sc} is determined/calculated. There are two possible situations to find L_{tx-sc}: (i) single diffraction loss situation, and (ii) scattering loss situation.

Single Diffraction Loss (L_{sd}) (dB) occurs when the identified clutter is in front of the transmitter (Tx) and is blocking the line-of-sight view towards the receiver (Rx) as shown in system diagram 1208 of FIG. 12. Diagram 1208 illustrates a transmitting node or transmitter 1210 which has an antenna/antenna array height hₜₓ 1212 from which it transmits wireless signal 1250 to receiver node or receiver 1214. The receiver node or receiver 1214 has an antenna/antenna array having a height hᵣₓ 1216 for receiving wireless signals. On the path between the transmitting node 1210 and the receiving node 1214 are exemplary items of clutter 1220, 1124, 1228, 1230, . . . , 1232, 1234, 1236, 1238, and 1240. The exemplary items of clutter are buildings and trees. Clutter items 1220, 1228, 1232, 1236, and 1240 represent clutter which are buildings. Clutter items 1224, 1230, 1234, and 1238 represent clutter which are trees. Clutter 1220 has a height 1222. Clutter 1240 has a height hp 1242. The heights hₜₓ 1212, hᵣₓ 1216, 1222, and hp 1242 are with respect to the terrain 1218. In diagram 1208, the transmitting node 1210 transmits wireless signal 1250 to the receiving node 1214. The wireless signal 1250 is diffracted by the building clutter 1220 which has a height 1222 which is greater than the height 1212 of the antenna/antenna array of the transmitter node/transmitter 1210. The building clutter 1220 is in the front of the transmitter node/transmitter 1210 and is blocking the line-of-sight view towards the receiver node/receiver 1214 antenna/antenna array. The scatterer which is the building clutter 1220 causes a single diffraction of the wireless signal 1250. The diffracted signal 1252 is received by the antenna/antenna array of the receiver node/receiver 1214. The clutter loss L_{tx-sc} 1254 between the transmitter node/transmitter 1210 and the scatterer which is surrounding clutter 1220 is a single diffraction loss. One exemplary way of obtaining the single diffraction loss is using the “height gain loss” of the Okumura-Hata model. The Okumura-Hata model is described in the following two publications which are incorporated herein by reference in their entirety: (i) Y. Okumura, E. Ohmori, T. Kawano and K. Fukuda, “Field strength and its variability in VHF and UHF land-mobile radio service”, Review of the ECL NTT Public Corporation, vol. 16, no. 9-10, pp. 825-873, September-October 1968 reference, and (ii) Hata, M. (August 1980) “Empirical Formula for Propagation Loss in Land Mobile Radio Services”, IEEE Transactions on Vehicular Technology, VT-29 (3): 317-25 reference.

Scattering Loss (L_{σ}) (dB) occurs when the wireless signal leaving the transmitter (Tx) is scattered by/from the surrounding clutter before it reaches the receiver (Rx). In other words, scattering loss occurs when the identified clutter is not in the plane containing the transmitter (Tx) and receiver (Rx) as shown in diagram 1260 of FIG. 12. The transmitter (Tx) is line-of-sight towards the identified clutter. The scattering loss for the clutter is determined based on its determined clutter type. The scattering loss L_{σ} is obtained/determined using the following equation:

$${L}_{σ} = 10 log ( σ ( {Θ}_{s} , {ϕ}_{s} ; {Θ}_{i} , {ϕ}_{i} )$$

The scattering loss for the clutter in various embodiments is determined based on the clutter's determined clutter type and information contained in scattering cross section database for the determined clutter type. Elements with the same reference numbers used in diagrams 1208 and 1260 are the same or similar and those elements will not be described in detail again. In diagram 1260, the transmitting node/transmitter 1262 has an antenna/antenna array height 1212 with respect to terrain 1272. The transmitting node/transmitter 1262 transmits wireless signal 1264 to the receiver node/receiver 1214. The building clutter 1220 scatters the wireless signal 1264. The scattered signal 1266 is received by the antenna/antenna array of the receiving node/receiver 1214. The building clutter 1220 is not in the plane containing the transmitting node/transmitter 1260 and the receiver node/receiver 1214. The transmitter node/transmitter is in the line-of-sight of the building clutter 1220. In the situation of diagram 1260, the clutter loss L_{tx-sc} 1268 between the transmitter node/transmitter 1262 and the surrounding clutter 1220 is the scattering loss Lσ=10 log(σ(θs, φs; θi, φi).

Loss between the surrounding clutter and the receiver is referred to as L_{sc-rx} as indicated in legend 1206 of diagram 1200 of FIG. 12. The loss between the surrounding clutter 1220 and the receiver node/receiver 1214 shown as L_{sc-rx} 1256 in diagram 1208 and L_{sc-rx} 1270 in diagram 1260 may be, and in some embodiments is, determined by using the terrain and clutter heights profile between any one of the surrounding clutter items and the receiver (Rx). The terrain heights may be, and in some embodiments is determined from geographical databases and/or survey information including terrain heights such as in the geographical area of the United States from the United States Geological Survey (USGS) database. Clutter heights above terrain may be, and in some embodiments are, obtained from LiDar and/or National Land Cover Dataset (NLCD). The loss between the clutter 1220 and the receiver node/receiver 1214 shown as L_{sc-rx} 1256 in diagram 1208 and L_{sc-rx} 1270 in diagram 1260 may be, and in some embodiments is, determined using an Irregular Terrain Model (ITM) which is terrain based only. The Longley-Rice ITM propagation model is disclosed in the ESSA TECHNICAL REPORT ERL 79-ITS 67 Prediction of Tropospheric Radio Transmission Loss Over Irregular Terrain A Computer Method—1968 authored by A. G. Longley and P. L. Rice published in July 1968 with comments and errata published in April 1970. The ESSA TECHNICAL REPORT ERL 79-ITS 67 Prediction of Tropospheric Radio Transmission Loss Over Irregular Terrain A Computer Method—1968 authored by A. G. Longley and P. L. Rice published in July 1968 with comments and errata published in April 1970 is incorporated herein by reference in its entirety. Updated versions of the Irregular Terrain Model have also been created based on the Longley-Rice ITM propagation model and these updated models are also referred to as Irregular Terrain Model or Longley-Rice model. Information about the Irregular Terrain Model is available from The National Telecommunications and Information Administration (NTIA) of the United States Department of Commerce. The National Telecommunications and Information Administration (NTIA) of the United States Department of Commerce has published the following documents on the Internet website http://its.ntia.gov/software/itm (i) the whitepaper, “The ITS Irregular Terrain Model, version 1.2.2 Algorithm” by George Hufford published by the National Telecommunications and Information Administration Institute for Telecommunication Sciences, (ii) “Dr. George Hufford's 1985 Memo describing the changes to ITM version 1.2.1 (dated April 1979) in ITM version 1.2.2 (dated September 1984); and (iii) “The ‘definitive’ representation of the ITS Irregular Terrain Model” which contains both FORTRAN source code and documentation as updated on 5 Aug. 2002. These three documents are incorporated herein by reference in their entirety.

Irregular Terrain Model version 7, also known as the ‘Longley Rice’ model was developed by the US NTIA and is used by the FCC. In some embodiments, terrain information and/or clutter information (e.g., elevation and height information) is obtained from information from the United States Geological Survey on land use and land cover (e.g., USGS LULC database and/or USGS National Land Cover database) and/or from the Sentinel-2 10 meter land use/land cover time series of the world produced by Impact Observatory and Esri. Another exemplary way of computing/determining the loss between surrounding clutter and the receiver L_{sc-rx} is by using the Okumura-Hata model. A further exemplary way of computing/determining the loss between surrounding clutter and the receiver L_{sc-rx} is by using the methods disclosed in pending U.S. patent application Ser. No. 18/415,214 filed Jan. 17, 2024, entitled “Optimizing Frequency Spectrum Assignment Based On High-Fidelity Obstruction Heights” which is hereby incorporated by reference in its entirety.

Clutter gain (negative of clutter loss value) may be, and in some embodiments is, determined for each identified surrounding item of clutter (n) as the sum of the clutter gains for two RF transmission paths (RF transmission path from the transmitter to the item of clutter/scatterer (n) and RF transmission path from the item of clutter/scatterer (n) to the receiver, n being a positive integer identifying the item of clutter.

$${G}_{n} = {G}_{tx - scn} + {G}_{scn - rx} = - {L}_{tx - scn} - {L}_{scn - rx}$$

$${L}_{n} = - {G}_{n}$$

Lₙ is the clutter loss for the RF propagation path extending from the transmitter to the item of clutter/scatterer n and from the item of clutter/scatterer n to the receiver given by the equation Lₙ=L_{tx-scn}+L_{scn-rx}. Gₙ is the clutter gain for the RF propagation path extending from the transmitter to the item of clutter/scatterer n and from the item of clutter/scatterer n to the receiver given by the equation Gₙ=G_{tx-scn}+G_{scn-rx}. The clutter gain from the transmitter to the item of clutter/scatter n is G_{tx-scn}. The clutter gain from the item of clutter/scatter n to the receiver is G_{scn-rx}, Where G_{tx-scn}=−L_{tx-scn}, G_{scn-rx}=−L_{scn-rx}, and Gₙ=−Lₙ.

To compute or determine a total predicted amount of RF interference that will be caused at the receiver from RF transmissions emanating from the transmitter two different approaches can be used.

The first approach includes the following steps: (i) determine for each of the n RF propagation paths extending from the transmitter to the receiver an amount of predicted RF interference based on the Lₙ or Gₙ determined for the RF propagation path (this results in n RF interference amounts—one RF interference amount for each of the n RF propagation paths extending from the transmitter to an item of clutter/scatterer and from the item of clutter to the receiver), and (ii) identity from the determined n predicted RF interference amounts the predicted RF interference amount that is the maximum as the total predicted amount of RF interference.

The second approach includes adding at the receiver the interference coming from each of the n-RF propagation paths to determine the total predicted amount of interference that will occur or be caused at the receiver from RF transmissions emanating from the transmitter. The RF interference coming from each of the n-RF propagation paths being determined based on the Lₙ or Gₙ for the particular path.

For example, with respect to the first approach, when there are 3 items of clutter n=3, an amount of RF interference is determined for each of three different RF propagation paths extending from the antenna of the transmitter (i.e., transmission point) to the antenna of the receiver (reception point). The RF interference amount 1 is the amount of interference determined for the RF propagation path extending from the antenna of the transmitter to the first item of clutter and from the first item of clutter to the antenna of the receiver (reception point). The RF interference amount 1 is determined based on L₁ or G₁. The RF interference amount 2 is the amount of interference determined for the RF propagation path extending from the antenna of the transmitter to the second item of clutter and from the second item of clutter to the antenna of the receiver (reception point). The RF interference amount 2 is determined based on L₂ or G₂. The RF interference amount 3 is the amount of interference determined for the RF propagation path extending from the antenna of the transmitter to the third item of clutter and from the third item of clutter to the antenna of the receiver (reception point). The RF interference amount 3 is determined based on L₃ or G₃. The total interference is then determined as maximum (RF interference amount 1, RF interference amount 2, RF interference amount 3). For example, if RF interference amount 1>RF interference amount 2 and RF interference amount 1>RF interference amount 3 then RF interference amount 1 is the maximum RF interference from the set of three RF interference amounts and is determined and/or selected to be the total predicted RF interference amount that will occur or be caused at the receiver from RF transmissions emanating from the transmitter. If however, RF interference amount 2>RF interference amount 1 and RF interference amount 2>RF interference amount 3 then RF interference amount 2 is the maximum RF interference amount from the set of three RF interference amounts and is determined and/or selected to be the total predicted RF interference amount that will occur or be caused at the receiver from RF transmissions emanating from the transmitter. If however, RF interference amount 3>RF interference amount 1 and RF interference amount 3>RF interference amount 2 then RF interference amount 3 is the maximum RF interference amount from the set of three RF interference amounts and is determined and/or selected to be the total predicted RF interference amount that will occur or be caused at the receiver from RF transmissions emanating from the transmitter.

This predicted amount of RF interference that will occur or be caused at a receiver (e.g., of a wireless network entity such as a base station) by RF transmissions from a transmitter (e.g., from another wireless network entity such as another base station) is in various embodiments used for example by an SAS to manage spectrum allocation and usage (e.g., making spectrum allocation and usage decisions for entities requesting spectrum allocation and/or using allocated spectrum).

As discussed above, FIG. 1 is a block diagram of an environment suitable and/or exemplary system 100 for implementing optimization of frequency spectrum assignment, grant and/or usage according to some implementations of the present disclosure. In some implementations, a computing system 10 includes processor device(s) 12 and memory 14. In some implementations, the computing system 10 may be a computing system that includes multiple computing devices.

Alternatively, in some implementations, the computing system 10 may be one or more computing devices within a computing environment that includes multiple distributed devices and/or systems. Similarly, the processor device(s) 12 may include any computing or electronic device capable of executing software instructions to implement the functionality described herein.

The following description refers to network entities. As described herein, a network entity refers to any type or manner of entity that requests access to or has access to a network (e.g., a tiered-access network) or a region of frequency spectrum within a network (e.g., a tiered-access region of frequency spectrum, etc.). For example, a network entity may refer to network service providers (e.g., internet service providers, wireless telephony service providers, geolocation service providers, etc.), governmental organizations (e.g., police, military, first responders, etc.), medical personnel, private organizations, businesses, users (e.g., subscribers to network service providers), etc. The term network entity may also be interchangeably used herein to refer to device(s) used by the above-mentioned entities, such as user devices (e.g., smartphones, laptops, tablets, etc.), network devices (e.g., wireless base stations, access points, network nodes, endpoint devices, routers, modems, Cable Modem Termination Systems (CMTSs), radar systems, customer premises equipment devices, etc.), network functions (e.g., SASs), etc. The term wireless network entity device includes any of the aforementioned network entities which include a wireless interface.

The environment and/or exemplary system 100 shown in FIG. 1 illustrates a plurality of network entities including a first wireless network entity device 18 (e.g., a user equipment device, base station, access point, etc.), a second wireless network entity device 58 (e.g., a user equipment device, base station, access point, etc.), a third wireless network entity device 59 (e.g., a user equipment device, base station, access point, radar system, etc.) and a base station network entity 30. Items of clutter CL-1 61, CL-2 62, CL-3 63, CL-4 64, CL-5 65, . . . , CL-N 66 are in the vicinity of and surrounding area of first wireless network entity device 18. The items of clutter are objects such as for example buildings, trees, and vegetation.

Specifically, to demonstrate various implementations and/or embodiments of the present invention more clearly, the computing system 10 is depicted as a computing system. However, the computing system 10 can be, or otherwise include, a variety of computing device(s) and/or network-specific device(s). Specifically, in some implementations, the computing system 10 can be, or otherwise include, a network node. The network node can perform various functions, and can include or otherwise implement various network functions. For example, the network node may implement a Spectrum Access System (SAS). Alternatively, the network node may implement services for communicating with the SAS.

Alternatively, in some implementations, the computing system 10 can be a computing device or system that is communicatively coupled to a network node (e.g., via existing wired or wireless network infrastructure). For example, the computing system 10 can be a distributed network of computing device(s) and/or system(s) that collectively implement various wireless networking services of an Internet Service Provider (ISP).

The memory 14 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 14 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The memory 14 can include a propagation module 16. The propagation module 16 can generate radio frequency propagation path loss information for radio frequency propagation paths between wireless transmitting entities/devices and wireless devices which receive the transmitted signals using location information for the wireless transmitting devices and the wireless devices which receive the transmitted signals and terrain and clutter information along the radio frequency propagation paths between the transmitting and receiving devices. The propagation module 16 in various embodiments can also generate propagation information, such as for example radio frequency propagation path loss information, which is indicative of a predicted degree, amount and/or level of interference for the wireless devices which receive the transmitted signal but are not the intended destination of the transmitted wireless signal. The propagation module 16 in various embodiments can also generate propagation information indicative of a predicted degree, amount and/or level of interference for a device that requests access to a network and/or usage of a region of frequency spectrum within a network. The propagation module 16 can generate predicted total propagation losses from a first endpoint (e.g., a transmission point of a transmitter) to a second endpoint (e.g., transmission reception point of a receiver). The propagation module 16 can also generate propagation information indication of a predicted degree, amount and/or level of interference for other wireless network entity devices. For example, the first wireless network entity device 18 can provide a spectrum access request 20. The spectrum access request 20 can indicate a band and channel for which access and/or usage is requested by the first wireless network entity device 18. The first wireless network entity device may be, and in some embodiments is, an endpoint device network entity, which as described herein, refers to an endpoint device utilized by a network entity, such as a user computing device, a modem, a router, a CMTS, a network node, base station, etc.

In some implementations, the computing system 10 can determine whether to grant the spectrum access request 20 based on a predicted degree of interference caused by granting the spectrum access request 20. More specifically, the computing system 10 can, in some implementations, include a Spectrum Access System (SAS) 22. The SAS 22 can make spectrum access decisions for a wireless network implemented by a network service provider. The SAS 22 can make the spectrum access decisions based on a predicted degree of interference determined using the propagation module 16. For example, the network service provider may utilize a tiered access network such as used in Citizen Broadband Radio Service (CBRS) network, and the SAS 22 can mediate access to the network and/or shared spectrum utilized by subscribers to obtain services from their network service provider. For example, the SAS 22 can determine whether or not to authorize use of requested spectrum by a requesting device (e.g., first wireless network entity device 18) based on the requesting device's tier of service and the amount and/or level of interference the usage is predicted to cause with other wireless network entity devices and/or the interference other wireless network entity devices transmission will have on the transmissions of the first wireless network entity device 18 using the requested spectrum if the requested spectrum usage was authorized by the SAS 22 for usage by the first wireless network entity device 18.

For example, if the first wireless network entity device 18 is a base station which is requesting usage of the spectrum to communicate with user equipment devices within its coverage area (e.g., assume the first wireless network entity device 18 wishes to communicate with the third wireless network entity device 59 which is located in its coverage area for this example), the amount of interference which will result at the base station network entity 30 can be determined and authorization of the usage of the requested spectrum can be authorized or denied based on the determined amount of interference which will result at the base station network entity 30. For example, if the determined amount of interference at base station network entity 30 is below a threshold interference level or value then the usage of the requested spectrum may be authorized by the SAS 22. If the amount of interference is not below the threshold interference level or value then the request for usage of the spectrum is denied. In some embodiments, the SAS 22 may also determine the maximum transmit power level when authorizing usage of the requested spectrum as the amount of interference will be a function of a plurality of elements including for example, the transmission power, the radio frequency propagation path loss between the transmitting and receiving devices, frequency of the transmitted signal and the frequency of the spectrum authorized for utilization by the base station network entity 30. In another example, the spectrum access request 20 may be a request for continued usage of the spectrum which has already been granted and is being used by the first wireless network entity device (e.g., a spectrum grant re-authorization request or heartbeat request). The request may be denied based on receipt of a sensor notification of detection of a higher tiered user's signal (e.g., navy radar signal) with which the requested re-authorization of continued usage of spectrum would interfere as determined for example based on the propagation path loss between the first wireless network entity device 18 and the location of the higher tiered user's device (e.g., location of navy ship radar system transmitting the radar signal detected by the sensor).

While in the exemplary computing system 10, the SAS is shown as an element of the system, in some implementations, the SAS 22 can be separate from the computing system 10, and the computing system 10 can determine a propagation profile and/or predicted degree of interference and can transmit the information to the SAS 22. The SAS 22 then uses this information to determine whether or not to accept or reject the request for spectrum access/usage.

Because the propagation module 16, and/or the SAS 22, is a component of the computing system 10, functionality implemented by the propagation module 16 and/or SAS 22 may be attributed to the computing system 10 generally. Moreover, in examples where the propagation module 16 and/or SAS 22 comprises software instructions that program the processor device(s) 12 to carry out functionality discussed herein, functionality implemented by the propagation module 16 and/or SAS 22 may be attributed herein to the processor device(s) 12.

To determine the predicted degree of interference, the propagation module 16 can include an obstruction information handler 24. The obstruction information handler 24 can obtain, store, modify, or otherwise handle multiple types and sources of obstruction information. In some implementations, the obstruction information handler 24 can process information to extract or otherwise obtain the obstruction information. For example, the obstruction information handler 24 may process high-fidelity LIDAR information to determine clutter height information.

In particular, the obstruction information handler 24 can include topographic information 26 and clutter information 28 for a particular geographic area. As described herein, a “geographic area” refers to any type or manner of physical area, and may be demarcated to any degree of specificity, such as a street, city block, town, city, county, state, country, zip code, telecommunications sector, etc. The topographic information 26 can describe a terrain height at multiple points within the geographic area. In some implementations, the topographic information 26 can describe the terrain height at every point within the geographic area. In some embodiments topographic information is obtained from geographical databases and/or survey information such as United States Geological Survey (USGS) and National Land Cover Dataset (NLCD).

Clutter information 28 for items of clutter surrounding and/or in the vicinity of a wireless network entity device is in various embodiments obtained through the use of ISAC technology incorporated into the wireless network entity device as explained in detail herein. For example for items of clutter in the vicinity of or surrounding a wireless network entity, the direction of the items of clutter from the transmitter of the wireless network entity, the distance of the items of clutter from the transmitter of the wireless network entity, the height of the items of clutter with respect to the terrain on which each item of clutter is located, the height of the items of clutter with respect to the height of the transmitter of the wireless network entity device, the width of the items of clutter, the shape of the items of clutter, the density of the items of clutter, the clutter type of each of the items of clutter and other features of the items of clutter may be, and in some embodiments are, determined through the implementation of monostatic, bistatic and/or multistatic sensing as described herein.

The clutter information 28 can also include, or otherwise indicate, clutter height values for clutter located atop the terrain within the particular geographic area. “Clutter” includes any object (e.g., vegetation, billboard, infrastructure, etc.), building, man-made entity, etc. located atop the terrain of a geographic area. In some instances, the differences between terrain height and the combination of terrain and existing clutter height can be substantial. For example, while the terrain of New York City in some locations is only 2-3 meters above sea level, clutter located atop the terrain of New York City can be over 400 meters in height (e.g., the One World Trade Center, the Empire State Building, etc.).

In some implementations, the clutter information 28 can be, or can be derived from, high-resolution imagery information. Specifically, in some implementations, the clutter information 28 can be, or can be derived from, LIDAR information. For example, LIDAR imagery (e.g., imagery from autonomous vehicle data sets, etc.) can be obtained for a particular point, and ray tracing can be utilized to determine clutter heights from that particular point. The clutter information 28 may include the LIDAR imagery, the clutter heights derived from the LIDAR imagery, or both. For another example, the clutter information 28 may include high-resolution images depicting clutter from the perspective of a particular point (e.g., street-view imagery, etc.), satellite imagery, infrared imagery, point clouds, etc.

In some embodiments, terrain information and/or clutter information (e.g., elevation and height information) is obtained from information from the United States Geological Survey on land use and land cover (e.g., USGS LULC database and/or USSG National Land Cover database) and/or from the Sentinel-2 10 meter land use/land cover time series of the world produced by Impact Observatory and Esri.

In some embodiments, the topographic information 26 and/or the clutter information 28 can be obtained by the propagation module 16 in response to receipt of the spectrum access request 20. For example, specifically, upon receipt of the spectrum access request 20, the propagation module 16 can determine a location of the first wireless network entity 18 and another wireless network entity device (e.g., base station network entity 30) to determine potential interference from wireless transmissions from the first wireless network entity 18 at the base station network entity 30 if usage of the requested spectrum in spectrum access request 20 was authorized and/or potential interference from wireless transmissions of the base station network entity 30 at the first wireless network entity device 18 such as for example when the base station network entity 30 is serving a different network entity such as a user equipment device within its coverage area (e.g., third wireless network entity). In some embodiments, the first wireless network entity device 18 is a mobile endpoint device such as a user equipment device (e.g., a smartphone) which already has a connection to the SAS 22 (e.g., a direct wireless connection to the computing system 10 on an already authorized spectrum channel, on a special control channel, or via a base station providing wireless services to the first wireless network entity device 18 on a different spectrum channel). The spectrum access request in such a case may be for an additional channel so that the user equipment device can have more bandwidth for communications and/or can also act as wireless node, hot spot or wireless relay for one or more wireless network entity devices (e.g. other user equipment devices, wireless base stations, access points, etc. using the additional requested spectrum in the spectrum access request 20). This can be done for example to provide additional network coverage, backhaul for other wireless devices such as other base station network entities, etc.). In such a case the additional spectrum requested can also be for side link communications between the first wireless network entity device 18 and another wireless user equipment device or wireless network equipment device (e.g., the second wireless network equipment entity device 58). The spectrum access request in such cases may include location information for the first wireless network equipment device (e.g., GPS coordinates generated by the first wireless network entity device 18). In some embodiments, the location of the first wireless network entity 18 may not be known exactly and can, for example, be hypothesized to be in the coverage area of its serving base station entity when the SAS request 20 is received via a serving base entity. Once, the location of the first wireless network entity device 18 and the base station network entity 30 in this example are identified. The propagation module 16 can then determine the geographic area in which both the first wireless network entity device 18 and the base station network entity 30 are located. For example, the spectrum access request 20 may indicate the location of the first wireless network entity device 18 and the base station network entity 30, or the locations could be indicated in a registration request received earlier, or identified in a known database (e.g., when the first wireless network entity device 18 and base station network entity 30 are at fixed locations such as when both are base stations). Alternatively, the propagation module 16 may identify the particular geographic area in some other manner (e.g., pinging the first wireless network entity device 18 for location information, etc.).

The propagation module 16 can generate/determine clutter information, identify different types of clutter, determine scattering cross sections for clutter, determine scattering losses for clutter, determine single edge diffraction losses for clutter, determine propagation path losses. It can utilize the Okumura-Hata model e.g., height gain model to determine clutter loses. The propagation module contains information for applying various models to calculate propagation losses including the ITU-R P.2108 recommendation model(s) and Irregular Terrain Model.

The radio frequency propagation path loss can then be used to predict a degree, an amount and/or a level of interference at or for the first wireless network entity device 18 (e.g., when the base station network entity 30, is communicating with user equipment devices it is serving using authorized spectrum) and/or a degree, an amount and/or a level of interference at or for the base station network entity 30 if the first wireless network entity device 18 where to utilize the requested spectrum in spectrum access request 18. For example, when the first wireless network entity device 18 is a base station requesting spectrum for use in communicating with user equipment devices using the requested spectrum in spectrum request 20, the propagation path loss along with transmission power level can be utilized to determine the strength of a signal being received at the base station network entity 30 and the amount of interference the base station network entity 30 will experience. In this way, the radio frequency propagation loss information can also be used to determine whether there is a maximum transmission power level for the first wireless network entity device 18 for the requested spectrum in spectrum access request 20 which will result in an amount of interference below an interference threshold value level at the base station network entity 30 and what that maximum transmission power level is.

The propagation module 16 can include a propagation information generator 44. The propagation information generator 44 can generate propagation information 46. The propagation information 46 can include, or otherwise indicate, a radio frequency propagation path loss between the first wireless network entity 18 and the base station network entity 30, predicted degree and/or amount and/or level of interference for and/or at the base station network entity 30 from transmission from the first wireless network entity device 18 utilizing the requested spectrum, predicted degree and/or amount and/or level of interference at the first wireless network device 18 from base station network entity 30 using information on the spectrum the base station network entity 30 is authorized to use for transmission and maximum transmission power level. The propagation information may, and in some embodiments does, include propagation profile information from which a predicted degree, amount, and/or level of interference can be derived for the base station network entity 30 and/or the first wireless network entity device 18.

To do so, the propagation information generator 44 can include a propagation mode selector 48. The propagation mode selector 48 can select one or more of a number of candidate propagation modes stored in propagation mode store 50. As described herein, a “propagation mode” refers to a mode in which a predicted degree, amount and/or level of interference can be determined, or a mode used to generate information from which a predicted degree, amount and/or level of interference can be derived (e.g., a path loss estimation, etc.). Examples of propagation modes include Okumura-Hata Propagation Model loss, propagation loss models of the ITU-1546, Free Space Loss (FSL), Line of Sight (LOS), Diffraction loss, Tropo-scatter loss, etc.

The propagation mode selector 48 can select one or more propagation modes from the propagation mode store 50. For example, the propagation mode selector 48 may select one propagation mode to determine a path loss prediction, or may select multiple propagation modes to determine multiple path loss predictions. The propagation mode selector 48 can select the propagation mode(s) based on determined clutter information and/or terrain information. It should be noted that, in some instances, the selected propagation mode can have a substantial effect on the path loss prediction and/or the interference prediction. Further, the propagation mode(s) are selected based on one or more of the following transmission and/or reception points, points selected along a propagation path and clutter information 28 and terrain information. As such, the synthesis of the topographic information 26 and the clutter information 28 can have substantial downstream effects on the predicted degree, amount, and/or level of interference. Different propagation modes can further be selected for different portions of the path between a first endpoint (e.g., a transmission point) and a second endpoint (e.g., a reception endpoint).

In some embodiments, the selected propagation mode can be utilized to generate the propagation information 46. Alternatively, in some implementations, the selected propagation mode can be used to generate path loss information 52. The path loss information 52 can include a path loss prediction for communications from one wireless network entity device to another wireless network entity device (e.g., from the first wireless network entity device 18 to base station network entity 30). The path loss information 52 can be utilized by the propagation information generator 44 to generate the propagation information 46. For example, path loss values indicated by the path loss information 52 may be used to determine projected received interference levels for the first wireless network entity device 18, the second wireless network entity device 58, the third wireless network entity device 59 and/or the base station network entity 30. In some embodiments, a total propagation loss for radio frequency transmissions from a first endpoint to a second endpoint are determined and a plurality of frequencies within a spectrum range are then utilized to determine the range of RF interference that may occur for a plurality of different power transmission levels.

In some implementations, the computing system 10 can include the SAS 22, and the SAS 22 can generate decision information 54. The decision information 54 can indicate whether the spectrum access request 20 has been granted by the SAS 22. To follow the depicted example in FIG. 1, assume that the SAS 22 receives the spectrum access request 20 and a second spectrum access request 56 from a second wireless network entity device 58. The second spectrum access request 56 can request access and/or authorization to a frequency band that at least partially overlaps with the frequency band indicated by the spectrum access request 20.

To determine whether such overlap is acceptable, the SAS can request the propagation information 46 for the first wireless network entity device 18 and/or the second wireless network entity device 58 from the propagation module 16. The propagation information 46 can include the radio frequency propagation path loss between the first wireless network entity device 18 and the second wireless network entity device 58 and/or a predicted amount of interference at the first wireless network entity device 18 and/or the second wireless network entity device 58. The radio frequency propagation path loss between the first wireless network entity device 18 and the second wireless network entity device 58 for example can be and typically is used to determine whether an amount or level of predicted interference at the first wireless network entity device from the second wireless network entity device 18 and at the second wireless network entity device 58 from the first wireless network entity device 18 is less than a threshold amount or level of interference, the decision information 54 can indicate that the spectrum access request 20 has been granted. Alternatively, if the propagation information 46 indicates a degree of predicted interference greater than or equal to a threshold amount or level of interference at the first wireless network entity device 18 or at the second wireless network entity device 58, the decision information 54 can indicate that the spectrum access request 20, and/or the second spectrum access request 56, has been denied.

The examples discussed above have focused on the determination of interference between two wireless network entities (e.g., first wireless network entity device 18 and the base station network entity 30, the first wireless network entity device 18 and the second wireless network entity device 58). In determining the interference which will be caused by a wireless network entity device requesting spectrum access/usage such as the first wireless network entity 18 in system 100 should the spectrum requested be authorized for use, predicted interference amounts and/or levels may be generated for one or more of the other wireless network entity devices (e.g., other wireless network entity devices (e.g., base station network entity 30, second wireless network entity device 58, and third wireless network entity device 59) which may be affected by the transmission of the wireless network entity device requesting the spectrum access/usage (e.g., first wireless network entity device 18). The interference amount or level experienced at each of these other wireless network entity devices may then be evaluated to determine whether the amount of interference at each of these other devices is below a threshold level or amount before authorizing the usage of the requested spectrum by the requesting wireless network entity device (e.g., first wireless network entity device 18). In some embodiments, the interference at the requesting wireless network entity device (e.g., the first wireless network entity device 18) from one or more other wireless network entity devices (e.g., base station network entity 30, second wireless network entity device 58, third wireless network equipment entity device 59) is determined and the requested spectrum is only authorized for usage if the amount or level of interference at the requesting wireless network entity device from the one or more other wireless network entity devices is below a threshold amount or level of interference. In various embodiments, the interference which may be caused by and which may be experienced by the requesting wireless network entity device should the requested spectrum be authorized for use by the requesting wireless network entity device is determined and only when both the interference experience at the requesting wireless network entity device and the interference caused by the requesting wireless network entity device are both below predetermined interference levels and/or amounts is the spectrum request granted. In some embodiments, the wireless network equipment devices for which RF interference is to be determined is based on the spectrum range, frequency, band, and/or channel being requested and the spectrum range, frequency, band, and/or channel currently in usage by other wireless network entity devices (e.g., within a specified distance). For example, other wireless network entity devices using and/or authorized for use for the same, adjacent or overlapping spectrum range, bands, and/or channels as the requested spectrum range, bands and/or channel(s) may be selected.

In various embodiments, when generating a predicted degree, amount or level of interference at a first wireless network entity device which may be caused by the transmissions of a second wireless network entity device, a radio frequency propagation path loss is generated for a radio frequency propagation path between the two entities. The radio frequency propagation path loss is a function of the clutter propagation loss from the transmission point (i.e., antenna) of the transmitter to the receiving point (i.e., antenna of the receiver) which includes two paths the first path being between the transmitter and the surrounding clutter and the second path being from the surrounding clutter to the receiver. Loss between transmitter and the surrounding clutter is obtained in various embodiments of the invention using monostatic sensing and/or bistatic sensing. For example, monostatic sensing and/or bistatic sensing is used to determine types of clutter (e.g., buildings, trees, vegetation, etc.) surrounding the transmitter and their respective distances. For each item of clutter identified surrounding the transmitter the propagation path loss between the transmitter and the item of clutter is determined. There are two possible situations to find the loss between the transmitter and an item of surrounding clutter.

The first is single diffraction loss (dB) which occurs when the identified item of clutter is in front of the transmitter and is blocking the line of sight view towards the receiver. FIG. 12 diagram 1208 shows an example where clutter is in the line of sight between the transmitter and receiver. In an exemplary embodiment, the single diffraction loss is determined and/or obtained using the “height gain loss” of the Okumura-Hata model.

The second situation is a scattering loss which occurs when the signal leaving the transmitter is scattered from the surrounding item of clutter before it reaches the receiver of the second wireless network entity. In other words, it occurs when the identified item of clutter is not in the plane containing the transmitter and the receiver. The transmitter is in the identified line of sight towards the identified clutter. FIG. 12 diagram 160 shows an example where clutter is not in the line of sight between the transmitter and receiver. The clutter is in the line of sight to the transmitter and causes the signal transmitted by the transmitter to be scattered toward the receiver. The scattering loss in this situation is determined as Lσ=10 log(σ(θs, φs; θi, φi)) which is a loss for a scattering cross section of the item of clutter and depends on the direction of propagation of the signal from the transmitter to the item of clutter and the direction of propagation from the item of clutter to the receiver. σ(θs, φs; θi, φi)) is a bistatic cross section where the index i=incident angles and s=scattering angles; θi, φi are the polar and azimuthal incident angles of the signal transmitted towards the item of clutter respectively; and θs, φs are the polar and azimuthal scattering angles of the signals away from the item of clutter respectively as explained in further detail in connection with FIGS. 10 and 11.

The propagation path loss between the surrounding clutter and the receiver is determined by using the terrain and clutter heights profile between any one of the surrounding clutter items and the receiver. As described above the terrain heights may be, and in some embodiments are, obtained from the United States Geological Survey and the clutter heights above terrain may be, and in some embodiments are, obtained from LiDAR or National Land Clutter Data. In some embodiments, the propagation path loss between the scattering clutter and the receiver is determined using the Okumura-Hata model, an extended Okumura-Hata model or a model described in the International Telecommunications Union Recommendation ITU-R P.1546-6 (August 2019) entitled, “Method for point-to-area predictions for terrestrial services in the frequency range 30 MHz to 4 000 MHz” which also provides the Okumura-Hata model equations. The International Telecommunications Union Recommendation ITU-R P.1546-6 (August 2019) entitled, “Method for point-to-area predictions for terrestrial services in the frequency range 30 MHz to 4 000 MHz” is incorporated herein by reference in its entirety.

The radio frequency propagation path loss also referred to herein as propagation path loss is also a function of the radio frequency spectrum to be utilized. The radio frequency propagation path loss once determined is then used, along with the maximum transmission power level of the second wireless network entity device to determine the predicted degree, amount or level of interference at the first wireless network entity device from transmissions of the second wireless network entity. When the principle of radio frequency reciprocity is applied, the radio frequency propagation path loss between the two entities is the same regardless of which is the transmitter and which is the receiver. That is the propagation path loss for a path from a first wireless network entity device to a second wireless network entity device is the same as the propagation loss for the same path from the second wireless network entity device to the first wireless network entity device.

The propagation module 16 of the computer 10 may, and in some embodiments does, determine the propagation path loss from a transmitter to items of clutter surrounding the transmitter of a wireless network entity device (e.g., the first wireless network device) and from the items of clutter to the receiver of other wireless network entity devices (e.g., the second wireless network entity device) of system 100 based on information received from the wireless network entity device about the items of clutter surrounding it and/or information from the other wireless network entity device in the system 100. In some embodiments, the propagation path loss from the items of clutter surrounding a wireless network entity device (e.g., a first wireless network entity device) to other wireless network entity devices (e.g., a second wireless network entity device) or areas of coverage of the other wireless network entity devices (e.g., area of coverage of the second wireless network entity device) is determined by the propagation module 16 of system 10.

Various embodiments of the present invention provide new and/or improved methods and apparatus for determining the radio frequency propagation loss between a transmitter and a receiver assuming that the transmitter and/or receiver is located below the clutter and/or is embedded in the clutter. Clutter includes objects, such as for example, vegetation, buildings, towers, or other man-made structures, which are located on top of the terrain of a geographic area. Various embodiments of the present invention further provide new and/or improved methods and apparatus for using this determined radio frequency propagation loss in managing the assignment/allocation and/or usage of shared spectrum among users of a wireless network. For example, by determining a predicted degree, amount, or level of RF interference at a point where a receiver is located from radio frequency transmission of a point at which a transmitter is located.

Once a radio frequency propagation loss including the clutter propagations losses for the path is determined between a transmitter transmission point and the receiver reception point, this propagation information can be used to predict a degree, amount or level of RF interference at the receiver from transmission of the transmitter. The predicted degree, amount, or level of RF interference can then be used to make a decision on whether the transmitter (e.g., a transmitter of a first wireless base station) which is requesting usage of spectrum (e.g., shared spectrum) is to be authorized to use the requested spectrum. For example, as previously explained if the predicted degree, amount or level of RF interference is less than a RF interference threshold value then the requested spectrum usage is authorized and when the predicted degree, amount or level of RF interference is not below the RF interference threshold value the usage of spectrum is not authorized.

A propagation or total propagation path loss in addition to being used to make spectrum usage decision can also be used to determine maximum transmission levels for the transmitting device so as to restrict the predicted amount of RF interference at the receiving point to be below a threshold amount.

In addition, the clutter information, clutter path loss information, and propagation path loss information can be used in determining base station locations so as to increase and/or maximize wireless coverage while decreasing and/or minimizing interference between base stations.

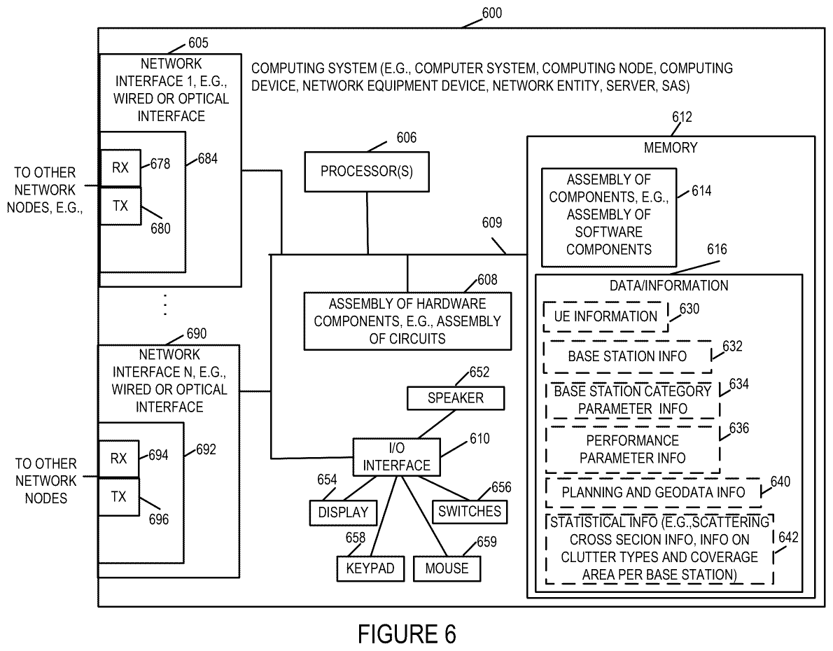

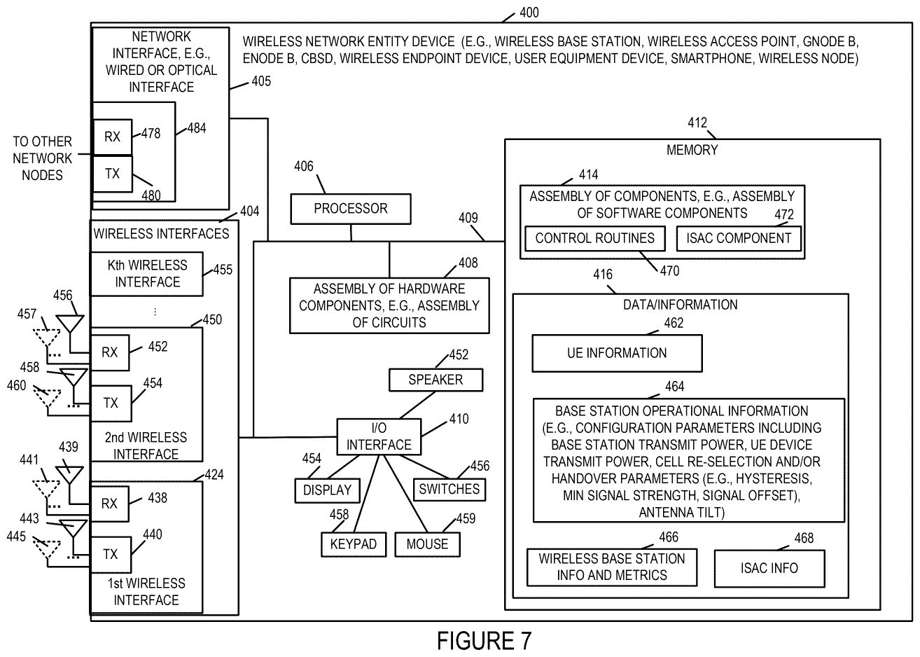

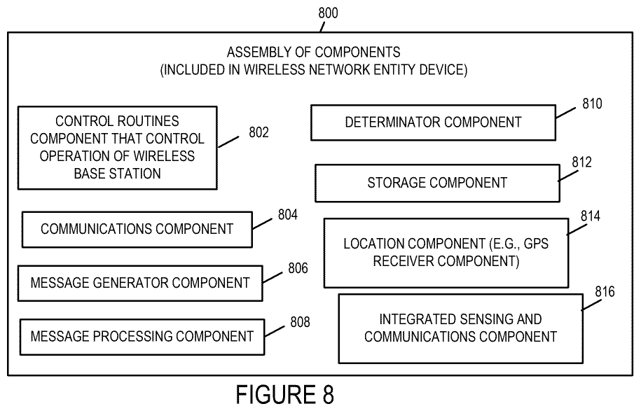

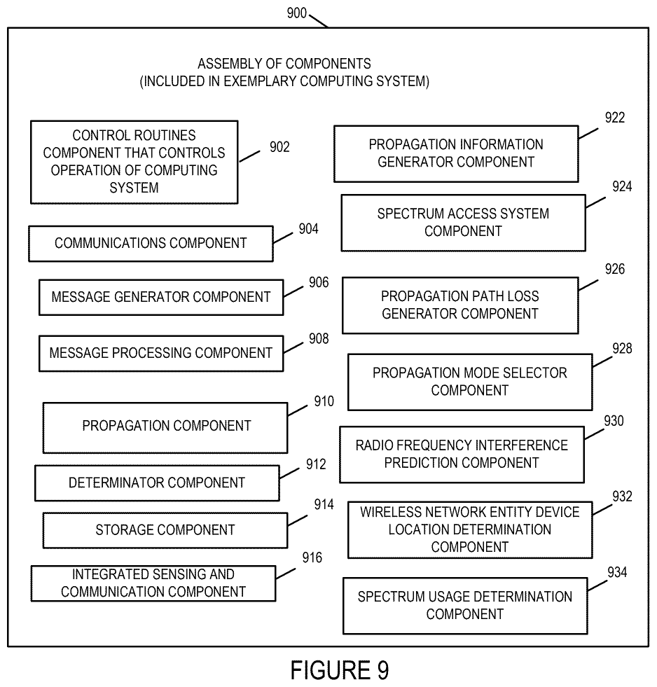

FIG. 6 which is discussed in further detail below illustrates an exemplary computing system in accordance with an embodiment of the present invention. FIG. 7 which is discussed in further detail below illustrates a wireless network entity device in accordance with an embodiment of the present invention. FIG. 8 which is discussed in detail below illustrates an exemplary assembly of components for a wireless network entity device in accordance with an embodiment of the present invention. FIG. 9 which is discussed in detail below illustrates an exemplary assembly of components for a computing system in accordance with an embodiment of the present invention.

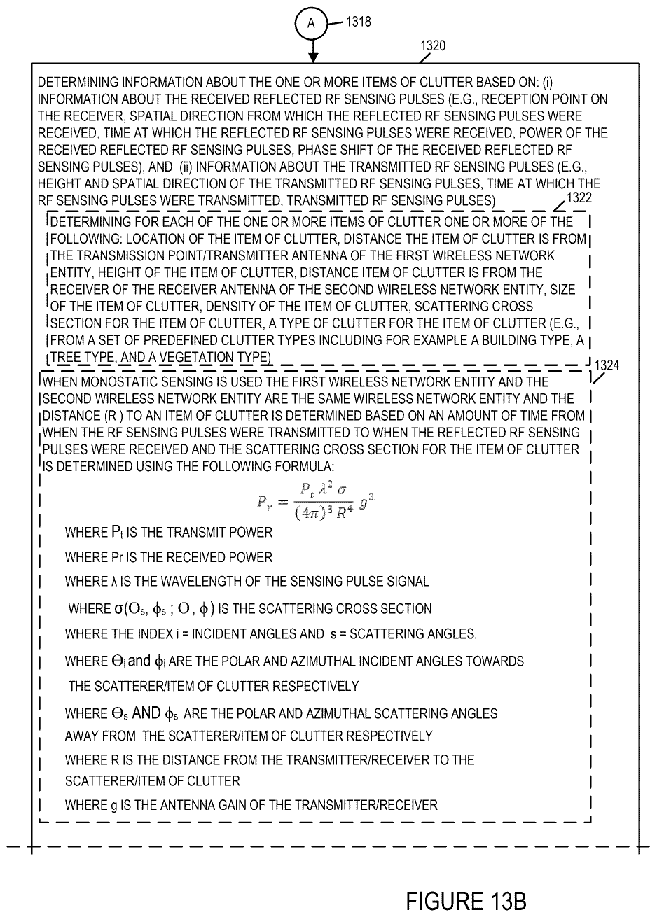

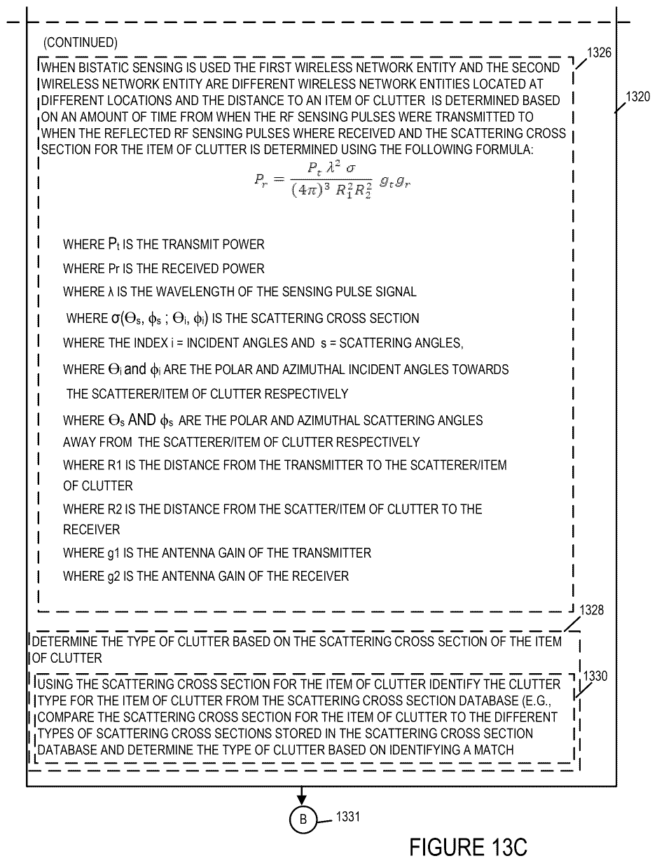

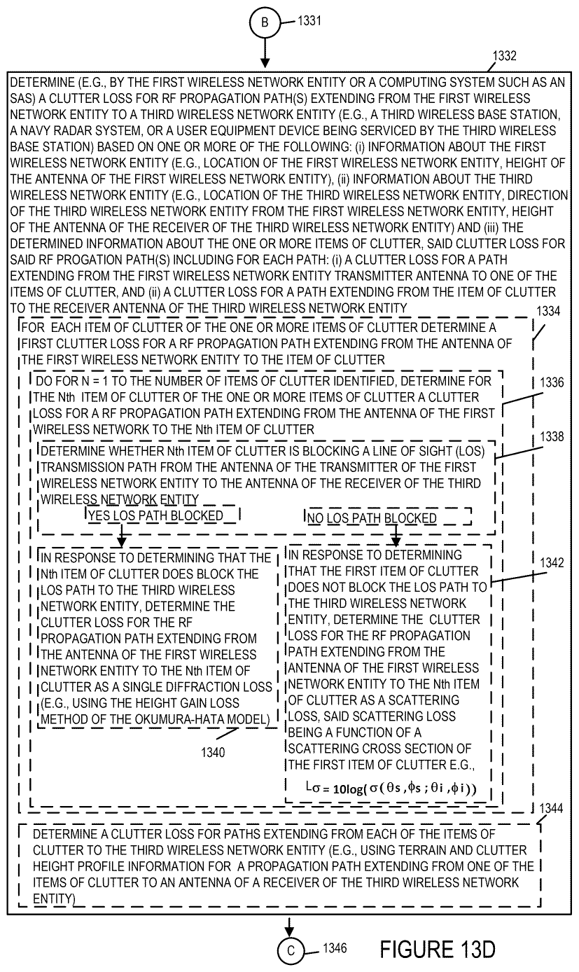

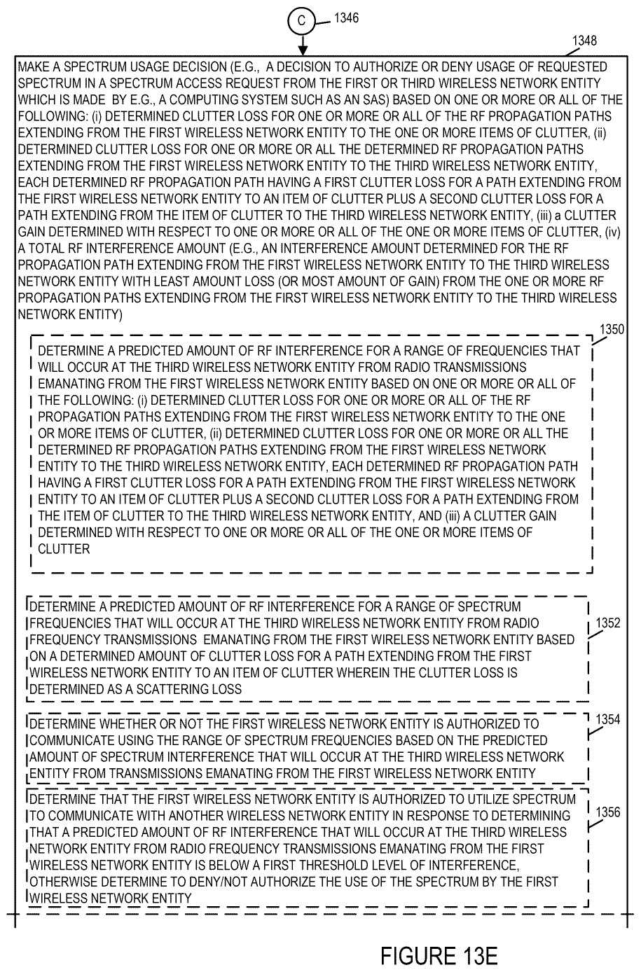

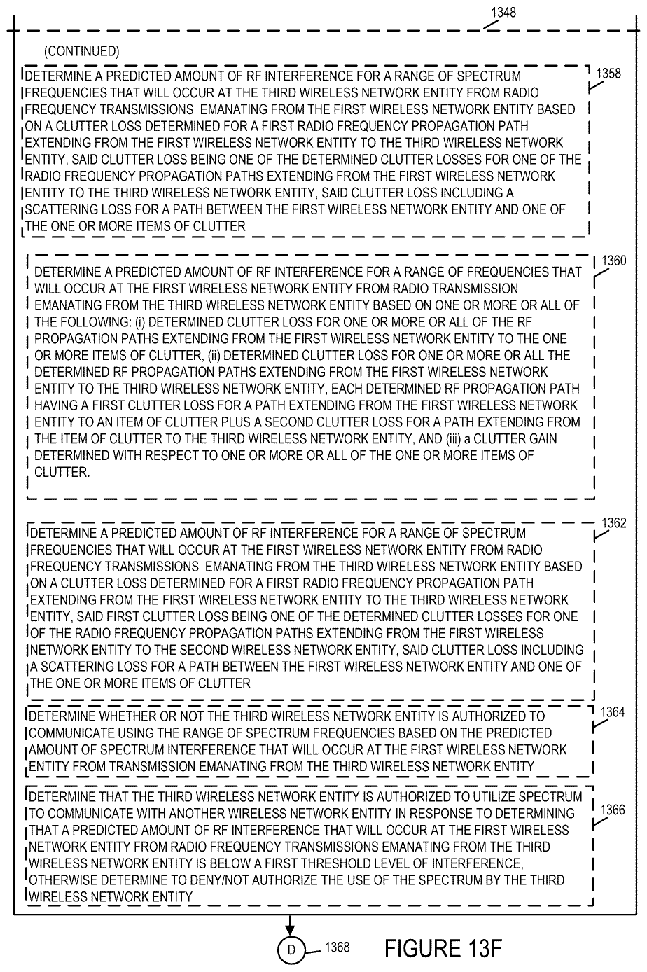

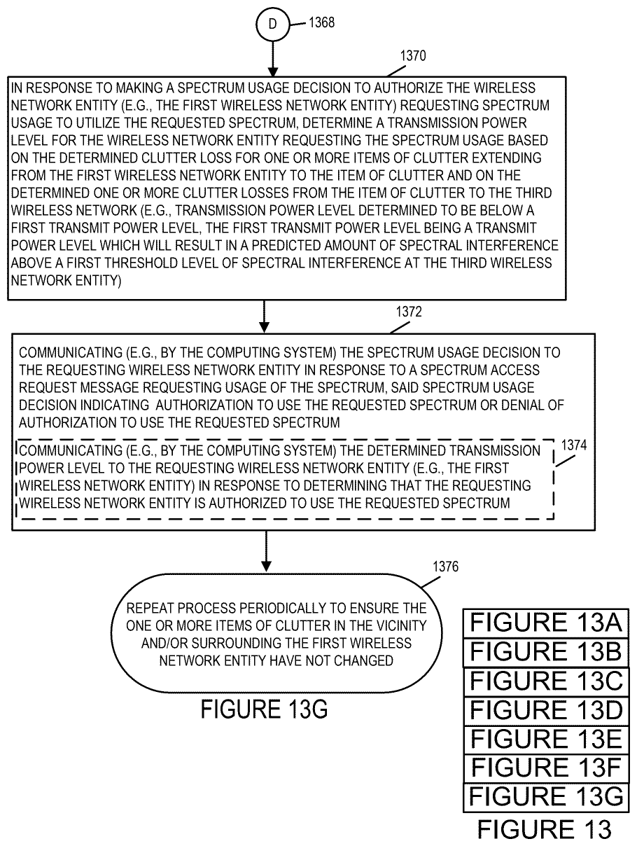

FIG. 13 comprises FIG. 13A, FIG. 13B, FIG. 13C, FIG. 13D, FIG. 13E, FIG. 13F and FIG. 13G. FIG. 13A is the first part of a flowchart of an exemplary method 1300 in accordance with an embodiment of the present invention. FIG. 13B is the second part of a flowchart of an exemplary method 1300 in accordance with an embodiment of the present invention. FIG. 13C is the third part of a flowchart of an exemplary method 1300 in accordance with an embodiment of the present invention. FIG. 13D is the fourth part of a flowchart of an exemplary method 1300 in accordance with an embodiment of the present invention. FIG. 13E is the fifth part of a flowchart of an exemplary method 1300 in accordance with an embodiment of the present invention. FIG. 13F is a sixth part of a flowchart of an exemplary method 1300. FIG. 13G is a seventh part of a flowchart of an exemplary method 1300.

While it will be readily understood that additional steps are performed in connection with communicating information, data, and messages between devices, the method 1300 focuses on and discusses the steps for understanding the invention. The method 1300 will be discussed in connection with the exemplary system 100 but is not limited to being implemented on system 100 and can be implemented on other systems. The computing system of the method 1300 may be, and in some embodiments is, the computing system 10 of the exemplary environment/system 100 illustrated in FIG. 1. The first wireless network entity in the method 1300 may be, and in some embodiments is, the first wireless network entity device 18 of the exemplary environment/system 100 illustrated in FIG. 1. The second wireless network entity in the method 1300 may be, and in some embodiments is, the base station network entity 30 of the exemplary environment/system 100 or the second wireless network entity device 58 of the exemplary environment/system 100 illustrated in FIG. 1. The third wireless network entity in the method 1300 may be, and in some embodiments is third wireless network entity device 59 of system 100 illustrated in FIG. 1. The items of clutter in the vicinity and/or surrounding the first wireless network entity are the clutter items CL 1 61, CL 2 62, CL 3 63, CL 4 64, CL 5 65, . . . , CL N 66 of the exemplary environment/system 100. In some embodiments such as when monostatic sensing is being performed, the first wireless network entity of the method 1300 and the second wireless network entity of the method 1300 are the same wireless network entity (e.g., the first wireless network entity device 18 of system 100. In some embodiments such as when bistatic sensing is performed the first wireless network entity and the second wireless network entity are different wireless network entities located at different locations. In some embodiments, the first wireless network entity, the second wireless network entity and the third wireless network entity of the method 1300 are wireless base stations operating using shared spectrum resources (e.g., shared CBRS spectrum). In some embodiments, the first wireless network entity is a first CBSD of a first CBRS system being operated by a first wireless operator, the second wireless network entity is a second CBSD being operated by the first wireless operator, and the third wireless network entity is a CBSD being operated by a second wireless operator having a higher priority than the first wireless operator or is wireless system operated by the government (e.g., a Navy radar system). The first wireless network entity and the second wireless network entity include integrated sensing and communications components (e.g., software and/or hardware components such as circuitry for implementing integrated sensing and communications capabilities.)

It is to be understood that while the method 1300 only addresses potential interference at third wireless network entity device, the computing system may identify other wireless network entities that may be affected by the first wireless network entity using the requested spectrum and the computing system may determine for each of these other wireless network entities that may be affected clutter loss and a propagation path loss for a propagation path from the first wireless network entity to a reception endpoint such as an antenna of a receiver at each of the other wireless network entities and make the spectrum usage decision based on predicted amount of RF interference at each of these other reception endpoints of the other wireless network entities.

Method 1300 begins in start step 1302 shown on FIG. 10A. Operation proceeds from start step 1302 to step 1304.

In step 1304, a scattering cross section database including scattering cross section information for different types of clutter (e.g., buildings, trees, vegetation is developed. The information may, and in some embodiments does include, scattering cross section values for the different types of clutter. In some embodiments, the scatter cross section information includes scattering cross section loss values for the different types of clutter such as shown in table 1102 of FIG. 11. Operation proceeds from step 1304 to step 1306.

In step 1306, the first wireless network entity 1306 which may be for example a wireless base station (e.g., a CBSD of a CBRS system) radio frequency (RF) sensing pulses. In some embodiments, step 1306 includes one or more sub-steps 1308, 1310, and 1312. In sub-step 1308, the first wireless network entity transmits the RF sensing pulses along with communications data as part of a communications signal (e.g., OFDM symbols of a wireless data communication). In some embodiments, the RF sensing pulses form a plurality of pulse-Doppler-based radar pulse trains which have been integrated into an OFDM resource grid being used for wireless communications. In sub-step 1310, the RF sensing pulses are transmitted in a plurality of different directions (e.g., in all direction from an antenna of a transmitter of the first wireless network entity). In sub-step 1312, the RF sensing pulses are transmitted from a first transmitter of the first wireless network entity separately from communications signals transmitted from the first transmitter of the first wireless network entity (e.g., with the first transmitter transmitting the RF sensing pulse and the communications signals during separate/different time periods). In some embodiments, the RF sensing pulses are transmitted at different degrees of elevation from the antenna of the first wireless network entity and in different directions (e.g., 0 degree vertical sweep from an antenna pointing directly down at the ground/terrain to an antenna pointing directly upward which is a 180 degree elevation with respect to the ground/terrain) with the elevation change being in increments (e.g., 0.5 or 1 degree increments) while at each increment the direction of the antenna is varied from 0 degrees to 360 degrees in increments (e.g., 0.5 or 1 degree increments) along the horizontal plane to perform a horizontal sweep). In some embodiments, the RF sensing pulses are transmitted in different directions performing vertical and horizontal sweeps around the first transmitter of the first wireless network entity to obtain information on clutter in the vicinity and/or surrounding the first transmitter. In some embodiments, the antennas of the first transmitter of the first wireless network entity are mechanically moved (e.g., tilted, rotated, and/or angled) and/or use beamforming where different antenna elements of an antenna array are used for transmitting the RF sensing pulses in different directions. In some embodiments, the RF sensing pulses are transmitted in a spherically or hemi-spherically pattern around the transmitter. In some embodiments, the first wireless base station uses beamforming to spatially direct the transmission of the radio frequency sensing pulses. The first wireless network entity having a transmitter with an antenna array configured for spatially directing the transmission of radio frequency signals. Operation proceeds from step 1306 to step 1314.

In step 1314, a second wireless network entity receives reflected RF sensing pulses which have been reflected by one or more items of clutter in the vicinity of or surrounding the first wireless network entity. In various embodiments, the reflected RF sensing pulses include backscattered sensing pulses. In some embodiments, step 1314 includes sub-step 1316. In some embodiments, the reflected RF sensing pulses are received along with communications data as part of a received reflected communications signal. In sub-step 1316, the second wireless network entity detects the received reflected RF sensing pulses from a received reflected communications signal when the RF sensing pulses have been transmitted as part of and/or along with a communications signal which also includes communications data/information. In some embodiments, detecting, by the second wireless network entity, the received reflected sensing pulses from the received reflected communications signal include filtering the received reflected communications signal to separate the RF sensing pulses in the reflected communications signal from the communications data in the reflected communications signal. In some embodiments, detecting, by the second wireless network entity, the received reflected RF sensing pulses from the received reflected communications signal includes filtering the received reflected communications signal to pass the received reflected sensing pulses in the reflected communications signal while removing the communications data in the reflected communications signal to generate a plurality of received reflected RF sensing pulse trains. In various embodiments, the second wireless network entity uses beamforming to determine the spatial direction of the received reflected RF sensing pulses. In some embodiments, both the first and the second wireless network entities have a transmitter with an antenna array capable of spatially directing RF transmission using beamforming and a receiver with an antenna array and/or beamforming array sensor. In some embodiments, receiving the reflected RF sensing pulses includes collecting and/or determining information about the received reflected RF sensing signals.

In some embodiments such as when monostatic sensing is being performed, the first wireless network entity and the second wireless network entity are the same wireless network entity. In some embodiments such as when bistatic sensing is performed the first wireless network entity and the second wireless network entity are different wireless network entities located at different locations.

Operations proceed from step 1314 via node A 1318 to step 1320 shown on FIG. 13B.

In step 1320, information is determined about the one or more items of clutter based on: (i) information about the received reflected RF sensing pulses (e.g., reception point at the receiver, spatial direction from which the reflected RF sensing pulses were received, time at which the reflected RF sensing pulses were received, power of the received reflected RF sensing pulses, phase shift of the received RF sensing pulses) and (ii) information about the transmitted RF sensing pulses (e.g., height and spatial direction of the transmitted RF sensing pulses, time at which the RF sensing pulses were transmitted, power of the transmitted RF sensing pulses. In some embodiments, the information determined about the one or more items of clutter is further based on one or more of the following (e.g., when bistatic sensing is used): location of the first wireless network entity (e.g., transmitter antenna location), the location of the second wireless network entity (e.g., receiver antenna location), the distance between the first wireless network entity and the second wireless network entity, timing of when non-reflected sensing pulses are received at the second wireless network entity and power of the non-reflected sensing pulses received at the second wireless network entity. In some embodiments, step 1320 is performed by a computing system (e.g., an SAS) which receives the information on which the determination of information about the one or more items of clutter is based from the first wireless network entity and the second wireless network entity. In some embodiments, the first wireless network entity or the second wireless network entity perform the step 1320 based on information it has and information provided by the other wireless network entity (e.g., first wireless network entity using information it has pulse information it receives from the second wireless network entity such as times of reception and power level of received reflected sensing pulses, times of reception and power level of received non-reflected pulses). In some embodiments step 1320 includes one or more sub-steps 1322, 1324, 1326, and 1328.

In sub-step 1322, for each of the one or more items of clutter determine one or more of the following: location of the item of clutter, distance the item of clutter is from the transmission point/transmitter antenna of the first wireless network entity, height of the item of clutter, distance item of clutter is from receiver of the receiver antenna of the second wireless network entity, size of the item of clutter, density of the item of clutter, scattering cross section for the item of clutter, a clutter type for the item of clutter (e.g., from a set of predefined clutter types including for example a building type, a tree type, and a vegetation type) for example from the scattering cross section database based on the determined scattering cross section of the item of clutter. The scattering cross section database information may be and in some embodiments is included in the computing system and/or the first wireless network and/or the second wireless network. In some embodiments, it is a separate database which is accessible to the first wireless network entity, the second wireless network entity and/or the computing system.

In sub-step 1324, when monostatic sensing is used, the first wireless network entity and the second wireless network entity are the same wireless network entity. The distance (R) to an item of clutter from the first wireless network transmitter/receiver is determined based on an amount of time from when the RF sensing pulses were transmitted by the first wireless network entity to when the reflected RF sensing pulses were received by the first wireless network entity. The scattering cross section for the item of clutter is determined using the monostatic received power formula where value of the received power and the value of all of the other parameters (transmitted power (known), wavelength of the transmitted sensing pulse signal (known), gain of the first wireless network antenna (known), distance to the item of clutter (determined using the time delay from when sensing pulses are transmitted by the transmitter/receiver to when the reflected sensing pulses are received by the transmitter/receiver) are known or have been determined except for the scattering cross section.

$${P}_{r} = \frac{{P}_{t} {λ}^{2} σ}{{( 4 π )}^{3} {R}^{4}} {ℊ}^{2}$$

solving for the monostatic scattering cross section σ yields:

$$σ = \frac{{( 4 π )}^{3} {R}^{4} {P}_{r}}{{P}_{t} {λ}^{2} {ℊ}^{2}}$$

where Pₜ is the transmit power (in watts);
where Pr is the received power (in watts);
where λ is the wavelength (in meters) of the sensing pulse signal;
where σ(θₛ, φₛ; θᵢ, φᵢ) (in dB square meters (dBsm)) is the monostatic scattering cross section where the index i=incident angles and s=scattering angles (i=s in the monostatic case), where θᵢ and φᵢ are the polar and azimuthal incident angles towards the scatterer (which is the clutter) and θₛ and φₛ are the polar and azimuthal scattering angles away from the scatterer (which is the clutter);
where R is the distance (in meters) from the transmitter/receiver to the scatterer which is the clutter; and
where g is the antenna gain of the transmitter/receiver.

In sub-step 1326 shown on FIG. 13C, when bistatic sensing is used, the first wireless network entity and the second wireless network entity are different wireless network entities at different locations as discussed above. The scattering cross section for the item of clutter is determined using the bistatic sensing received power formula shown below where the received power value and the value of each of the other parameters of the equation are known or have been determined except for the scattering cross section of the item of clutter.

$${P}_{r} = \frac{{P}_{t} {λ}^{2} σ}{{( 4 π )}^{3} {R}_{1}^{2} {R}_{2}^{2}} {ℊ}_{t} {ℊ}_{r}$$

solving for the bistatic cross section σ yields:

$$σ = \frac{{( 4 π )}^{3} {R}_{1}^{2} {R}_{2}^{2} {P}_{r}}{{P}_{t} {λ}^{2} {ℊ}_{t} {ℊ}_{r}}$$

where Pₜ is the transmit power (in watts) (known from transmitter);
where Pr is the received power (in watts) (measured/determined when signal received);
where λ is the wavelength (in meters) of the sensing pulse signal (known by transmitter);
where σ(θₛ, φₛ; θᵢ, φᵢ) is the bistatic scattering cross section in square meters where the index i=incident angles and s=scattering angles, where θᵢ and φᵢ are the polar and azimuthal incident angles towards the scatterer (which is the clutter) and θₛ and φₛ are the polar and azimuthal angles scattering angles away from the scatterer (which is the clutter), respectively as shown in FIG. 10;
where R1 is the distance in meters from the transmitter to the scatterer which is the clutter (determined e.g., from time delays of reflected and non-reflected pulses and locations of first wireless network entity and second wireless network entity);
where R2 is the distance in meters from the scatterer which is the clutter to the sensor receiver (determined e.g., from time delays of reflected and non-reflected pulses and locations of first wireless network entity and second wireless network entity); and
where gₜ and gᵣ are the gain of the transmitter antenna and sensor-receiving antenna respectively (antenna transmitter and receiver gains are known parameters of the first and second wireless network entities respectively).

In sub-step 1328, the type of clutter of each item of clutter is determined based on the scattering cross section of the item of clutter. In some embodiments, sub-step 1328 includes sub-step 1330.

In sub-step 1330, the scattering cross section for an item of clutter is used to identify the clutter type for the item of clutter from the scattering cross section database (e.g., by comparing the determined scattering cross section for the item of clutter to the different types of clutter stored in the scattering cross section database and determining the type of clutter based on identifying a match. Operation proceeds from step 1320 via node B 1331 to step 1332 shown on FIG. 13D.

In step 1332, determine (e.g., by the first wireless network entity or a computing system such as an SAS) a clutter loss for RF propagation path(s) extending from the first wireless network entity to a third wireless network entity (e.g., a third wireless base station, a navy radar system, or a user equipment device being serviced by the third wireless network entity) based on one or more of the following: (i) information about the first wireless network entity (e.g., location of the first wireless network entity, height of the antenna of the first wireless network entity), (ii) information about the third wireless network entity (e.g., location of the third wireless network entity, direction of the third wireless network entity from the from the first wireless network entity), and (iii) the determined information about the one or more items of clutter. The clutter loss for the RF propagation path(s) include for each path: (i) a clutter loss for a path extending from the first wireless network entity transmitter antenna to an item of clutter from the one or more items of clutter, and (ii) a clutter loss for a path extending from the item of clutter to the receiver antenna of the third wireless network entity. The clutter loss of a RF propagation path loss being the sum of the clutter loss for the path extending from the first wireless network entity transmitter antenna to the item of clutter and the clutter loss for the path extending from the item of clutter to the receiver antenna of the third wireless network entity. In some embodiments, a clutter loss is determined for each path from the first wireless network entity to each item of clutter and then summed with the clutter loss determined for the path from the item of clutter to the third wireless network entity.

In various embodiments, a RF propagation path loss for a path extending from the first wireless network entity to the third wireless network entity is determined for each item of clutter of the one or more items of clutter for example by summing the clutter loss for the path from the first wireless network entity (e.g., antenna of the first wireless network entity) to the item of clutter with the clutter loss from the item of clutter to the third wireless network entity (e.g., antenna of third wireless network entity).

In some embodiments step 1332 includes one or more sub-steps 1334 and 1344.

In sub-step 1334, for each item of clutter of the one or more items of clutter determine a first clutter loss for a RF propagation path extending form the antenna of the first wireless network entity to the item of clutter. In some embodiments, step 1334 incudes sub-step 1336. In sub-step 1336, for N=1 to the number of items of clutter identified in the vicinity or surrounding the first wireless network entity, the following operation are performed or done. Determine for the Nth item of clutter of the one or more items of clutter a clutter loss for a RF propagation path extending form the antenna of the first wireless network entity to the Nth item of clutter. In some embodiments, sub-step 1336 includes one or more of the following: sub-steps 1338 and 1342. In sub-step 1338, determine whether the Nth item of clutter is blocking a line of sight (LOS) transmission path from the antenna of the transmitter of the first wireless network entity to the antenna of the receiver of the third wireless network entity. When the determination is yes, the Nth item of clutter is blocking the LOS path from the first wireless network entity to the third wireless network entity operation proceeds from sub-step 1338 to sub-step 1342. When the determination is no, the Nth item of clutter is not blocking the LS path from the first wireless network entity to the third wireless network entity then operation proceeds from sub-step 1338 to sub-step 1342. The location of the first wireless network entity, the height of the antenna of the first wireless network entity, the location of the third wireless network entity, the height of the antenna of the third wireless network entity are known, and the height of the Nth item of clutter was previously determined via the use of the sensing pulses, and the spatial direction from the first wireless base station and location of the Nth item of clutter was previously determined via the use of the sensing pulses. Using this information, the heading or direction of a line of sight transmission path from the first wireless network entity to the third wireless network entity can be determined as well as whether the Nth item of clutter blocks that line of sight transmission path (e.g., from the direction of the line of sight path and height of the Nth item of clutter vs the height of the antenna of the first wireless base station and the third wireless base station).

In sub-step 1340, in response to determining that the Nth item of clutter does block the LOS path to the third wireless network entity, determine clutter loss for the RF propagation path extending from the antenna of the first wireless network entity to the Nth item of clutter as a single diffraction loss (e.g., using the height gain loss method of the Okumura-Hata model.

In sub-step 1342, in response to determining that the first item of clutter does not block the line of sight path extending from the first wireless network entity to the third wireless network entity but does scatter a signal transmitted from the first wireless network entity toward the receiver of third wireless network entity (e.g., this occurs when the Nth item of clutter is not in the plane containing the transmitter of the first wireless network entity and the receiver of the third wireless network entity but is transmitter is in a line of sight to the Nth item of clutter (diagram 1260 of FIG. 12 shows an example of this where the building 1220 scatters the transmitted signal 1264 toward the receiver but the building 1220 is not in the line of sight path from the transmitter to the receiver), the clutter loss for the RF propagation path extending from the antenna of the first wireless network entity to the Nth item of clutter as a scattering loss. The scattering loss is determined as a function of the scattering cross section of the first item of clutter. In some embodiments, the scattering loss is determined as Lσ=10 log(σ(θs, φs; θi, φi)) which is a loss for a scattering cross section of the Nth item of clutter and depends on the direction of propagation of the signal from the transmitter antenna of the first wireless network entity to the Nth item of clutter and the direction of propagation from the Nth item of clutter to the receiver antenna of the third wireless network entity. σ(θs, φs; θi, φi)) is a bistatic cross section where the index i=incident angles and s=scattering angles; θi, σi are the polar and azimuthal incident angles of the signal transmitted towards the Nth item of clutter respectively; and θs, φs are the polar and azimuthal scattering angles of the signals away from the Nth item of clutter respectively. An example of this scattering cross section loss is explained in further detail in connection with FIGS. 10 and 11. In some embodiments, the scattering loss is determined from information contained in a look up table or the scattering cross section database based on the identified type of clutter, the θs, φs; θi, φi angles, the scattering losses having been determined in advance for the type of clutter and stored in the look up table and/or in the scattering cross section database. In some embodiments, information for both monostatic scattering cross section information and bistatic scattering cross section information is stored in the scattering cross section database and/or in other storage devices such as memory of the first wireless network entity or a memory of computing system making scattering loss determinations.

In sub-step 1344, a clutter loss for paths extending from each of the items of clutter to the third wireless network entity is determined (e.g., using terrain and clutter height profiles for a propagation path extending from the item of clutter to an antenna of a receiver of the third wireless network entity).

The terrain heights may be, and in some embodiments are determined from geographical databases and/or survey information including terrain heights such as in the geographical area of the United States from the United States Geological Survey (USGS) database. Clutter heights above terrain may be, and in some embodiments are, obtained from LIDAR and/or National Land Cover Dataset (NLCD).

In some embodiments, the clutter loss from an item of clutter to the third wireless network entity is determine using the Okumura-Hata model.

In some embodiments, step 1332 further includes determining the clutter gain (negative of the clutter loss value) for each of the one or more items of clutter (n) (n=1, 2, . . . , total number of items of clutter) as the sum of the clutter gains for two RF transmission paths (RF transmission path from the transmitter to the item of clutter/scatterer (n) and RF transmission path from the item of clutter/scatterer (n) to the receiver) for each item n of clutter.

$${G}_{n} = {G}_{tx - scn} + {G}_{scn - rx}$$

$${L}_{n} = - {G}_{n}$$

Using the RF propagation path loss (Lₙ) or the RF propagation path gain (Gₙ) for each of the n-RF propagation paths extending from the transmitter of the first wireless network entity to the receiver of the third wireless network entity, an amount of RF interference that will be caused at the receiver of the third wireless network entity from RF transmissions emanating from the transmitter of the first wireless network entity can be determined. In some embodiments, a total amount of interference or total predicted amount of interference that will occur or be caused at the third wireless network entity from RF transmissions emanating from the first wireless network entity will be determined to be the maximum interference amount determined from the n interference amounts determined for each of the n-RF propagation paths. The RF propagation path of the n-RF propagation paths with the smallest or lowest loss value which is also the RF propagation path with the highest or biggest gain value will cause the most or maximum amount of RF interference at the third wireless network entity from the n-RF propagation paths as it will be the RF path having the highest signal received power. In some other embodiments, the total amount of interference or total predicted amount of interference that will occur or be caused at the third wireless network entity from RF transmissions emanating from the first wireless network entity will be determined at the receiver of the third wireless network entity by adding the interference coming from each of the n-RF propagation paths. Operation proceeds from step 1332 via connection node 1346 to step 1348 shown on FIG. 13E.

In step 1348, a spectrum usage decision (e.g., a decision to authorize or deny usage of requested spectrum in a spectrum access request from the first wireless network entity or the third wireless network entity) is made (e.g., by a computing system such as an SAS) based on one or more or any combination of the following: (i) determined clutter loss for one or more or all or any combination of RF propagation paths extending from the first wireless network entity to the one or more items of clutter, (ii) determined clutter loss for one or more or all or any combination of the determined RF propagation paths extending from the first wireless network entity to the third wireless network entity, each determined RF propagation path having a first clutter loss for a path extending from the first wireless network entity to an item of clutter plus a second clutter loss for a path extending from the item of clutter to the third wireless network entity, (iii) a clutter gain determined with respect to one or more or all or any combination of the one or more items of clutter, and (iv) a total RF interference amount. In some embodiments, the total RF interference amount is determined by adding the interference at the receiver of the third wireless network entity coming from each of the one or more RF propagation paths. The amount of interference from each of the one or more RF propagation paths being determined based on the propagation path loss or propagation path gain determined for the propagation path. In the some embodiments, the total RF interference amount is the RF interference amount determined for the RF propagation path with the least amount of loss or the most amount of gain from the one or more RF propagation paths extending from the first wireless network entity to the third wireless network entity. That is the RF propagation path which will cause the maximum amount of RF interference at the third wireless network entity from each of the RF propagation paths extending from the first wireless network entity to the third wireless network entity (e.g., n-RF propagation paths result in n-determined interference amounts and the RF interference amount that is the highest from among the n-determined interference amounts is determined to be the total RF interference amount). In some embodiments, when there are a plurality of three or more RF propagation paths extending from the first wireless network entity to the third wireless network entity, the total interference amount is determined based on adding two or more (or any combination) of the RF interference amounts corresponding to the plurality of RF propagation paths extending from the first wireless network entity to the third wireless network entity.

In some embodiments, step 1348 includes one or more sub-steps 1350, 1352, 1354, 1356, 1358, 1360, 1362, 1366, 1368.

In sub-step 1350, a predicted amount of RF interference for a range of frequencies that will occur at the third wireless network entity from radio transmissions emanating from the first wireless network entity is determined based on one or more or all or any combination of the following: (i) determined clutter loss for one or more or all or any combination of RF propagation paths extending from the first wireless network entity to the one or more items of clutter, (ii) determined clutter loss for one or more or all or any combination of the determined RF propagation paths extending from the first wireless network entity to the third wireless network entity, each determined RF propagation path having a first clutter loss for a path extending from the first wireless network entity to an item of clutter plus a second clutter loss for a path extending from the item of clutter to the third wireless network entity, and (iii) a clutter gain determined with respect to one or more or all or any combination of the one or more items of clutter.

In sub-step 1352, a predicted amount of RF interference for a range of frequencies that will occur at the third wireless network entity from radio transmissions emanating from the first wireless network entity is determined based on a determined amount of clutter loss for a path extending from the first wireless network entity to an item of clutter which is determined as a scattering loss, said scattering loss being determined based on or as a function of a scattering cross section of the item of clutter.

In sub-step 1354, a determination is made as to whether or not the first wireless network entity is authorized to communicate using the range of spectrum frequencies based on the predicted amount of interference that will occur at the third wireless network entity from transmissions emanating from the first wireless network entity. In some embodiments, the determination is further made based on the priority or tier of the operator of the first wireless network entity and the third wireless network entity. For example, if the operator has a higher priority or is a higher tier than the operator of the third wireless network entity, then a determination in some embodiments is made to grant a spectrum authorization to the first wireless network entity which has a lower priority or is in a lower tier while cancelling a grant of spectrum currently authorized for use by the third network entity so as to avoid interference.

In sub-step 1356, determine that the first wireless network entity is authorized to utilize the range of spectrum to communicate with another wireless network entity in response to determine that a predicted amount of RF interference that will occur at the third wireless network entity from radio transmissions emanating from the first wireless network entity is below a first threshold level of interference, otherwise in response to determining that the predicted amount of RF interference is not below the first threshold level of interference determine that the first wireless network entity is not authorized or is denied authorization to use the range of spectrum to communicate with another wireless network entity.

In sub-step 1358 shown on FIG. 13F, a predicted amount of RF interference for a range of spectrum frequencies that will occur at the third wireless network entity from radio frequency transmissions emanating from the first wireless network entity is determined based on a clutter loss determined for a first radio frequency propagation path extending from the first wireless network entity to the third wireless network entity. The clutter loss being one of the determined clutter losses for one for the radio frequency propagation paths extending from the first wireless network entity to the third wireless network entity. The clutter loss also including a scattering loss for a path between the first wireless network entity and the one or more items of clutter, said scattering loss being determined based on a scattering cross section of the item of clutter.

In sub-step 1360, a predicted amount of RF interference for a range of frequencies that will occur at the first wireless network entity from radio transmissions emanating from the third wireless network entity is determined based on one or more or all of the following: (i) determined clutter loss for one or more or all of RF propagation paths extending from the first wireless network entity to the one or more items of clutter, (ii) determined clutter loss for one or more or all of the determined RF propagation paths extending from the first wireless network entity to the third wireless network entity, each determined RF propagation path having a first clutter loss for a path extending from the first wireless network entity to an item of clutter plus a second clutter loss for a path extending from the item of clutter to the third wireless network entity, and (iii) a clutter gain determined with respect to one or more or all of the one or more items of clutter.

In sub-step 1362, a predicted amount of RF interference for a range of spectrum frequencies that will occur at the first wireless network entity from radio frequency transmissions emanating from the third wireless network entity is determined based on a clutter loss determined for a first radio frequency propagation path extending from the first wireless network entity to the third wireless network entity. The clutter loss being one of the determined clutter losses for one for the radio frequency propagation paths extending from the first wireless network entity to the third wireless network entity. The clutter loss also including a scattering loss for a path between the first wireless network entity and the one or more items of clutter, said scattering loss being determined based on a scattering cross section of the item of clutter.

In sub-step 1364, a determination is made as to whether or not the third wireless network entity is authorized to communicate using the range of spectrum frequencies based on the predicted amount of interference that will occur at the first wireless network entity from transmission emanating from the third wireless network entity.

In sub-step 1366, a determination is made that the third wireless network entity is authorized to utilize spectrum to communicate with another wireless network entity in response to determining that a predicted amount of RF interference that will occur at the first wireless network entity from radio frequency transmissions emanating from the third wireless network entity is below a first threshold level of interference, otherwise a determination is made to deny/not authorize the use of the spectrum by the third wireless network entity.

Operation proceeds from step 1366 via connection node D 1368 to step 1370 shown on FIG. 13G.

In step 1370, in response to making a spectrum usage decision to authorize a wireless network entity requesting spectrum usage (e.g., the first wireless network entity requesting spectrum usage) to utilize the requested spectrum, determine a transmission power level for the wireless network entity requesting spectrum usage based on one or more or all of the determined clutter losses for the determined radio frequency propagation paths extending from the first wireless network entity to the third wireless network entity (e.g., a power transmission level determined to be below a first transmit power level, the first transmit power level being a transmit power level which will result in a predicted amount of spectral interference above a first threshold level of spectral interference at the third wireless network entity.). In some embodiments, step 1370 is performed by a computing system for example an SAS. Operation proceeds from step 1370 to step 1372.

In step 1372, the spectrum usage decision is communicated to the requesting wireless network entity (e.g., the first wireless network entity) in response to a spectrum access request message requesting usage of the spectrum, said spectrum usage decision indicating authorization to use the requested spectrum or denial of authorization to use the requested spectrum. In some embodiments, a central computing system such as an SAS performs step 1372. In some embodiments, step 1372 includes sub-step 1374. In sub-step 1374, the determined transmission power level is communicated (e.g., by a computing system such as an SAS) to the requesting wireless network entity (e.g., the first wireless network entity) in response to determining that the requesting wireless network entity is authorized to use the requested spectrum. In some embodiments, the determined transmission power level is included with the spectrum usage decision. In some embodiments, the transmission power level is sent as a separate message from the spectrum usage message. In some embodiments, sub-step 1372 is not a sub-step of step 1372 but a step which comes after step 1372. Operation proceeds from step 1372 to step 1376.

In step 1376, the process is periodically repeated to ensure the one or more items of clutter in the vicinity and/or surrounding the first wireless network entity have not changed and/or in response to additional spectrum access requests with respect to a different range of spectrum frequencies. The process can also be repeated with respect to other wireless network entities other than the third wireless network entity such as performing the process for the first wireless network entity and the second wireless network entity or a fourth wireless network entity located at a different position than the third wireless network entity. In some embodiments, the third wireless network entity is replaced with a reception at a boundary point or the edge of a zone of geographical area (e.g., restricted geographical zone) to determine whether the spectral interference from the first wireless network entity will interfere with wireless transmissions by other entities within the boundary or zone.

In some embodiments, the determination of the cutter loss due to the one or more items is used in network planning such as for example, planning to add additional wireless base stations because the coverage area of the first wireless network entity is not sufficient or determining a different location for the first wireless network entity if the predicted spectral interference with the third wireless network entity causes an amount of denials of spectrum access which exceeds a first threshold level of service during a defined period of time (e.g., inability to provide services over a period of time due to spectrum access denials resulting in poor customer performance in the area covered by the first wireless network entity).

When the exemplary method 1300 is implemented in a shared wireless spectrum network it improves the spectral efficiency as well as the operation of the wireless network by being able to more accurately predict the degree, amount and/or level of RF interference between wireless network entities than systems that use RF interference analysis which ignores and/or minimizes the affect of clutter.

FIG. 6 is a drawing of an exemplary computing system/device (e.g., computer system, compute node, network equipment device, network entity, system, server, node, Spectrum Access System, Propagation Path Loss Determination System, RF interference Determination/Prediction System) in accordance with an embodiment of the present invention.

The computing system/device 600 includes a plurality of network interfaces 605, . . . , 690, e.g., a wired or optical interface, a processor(s) 606 (e.g., one or more processors), e.g., a CPU, an assembly of hardware components 608, e.g., an assembly of circuits, and I/O interface 610 and memory 612 coupled together via a bus 609 over which the various elements may interchange data and information. The computing system/device 600 further includes a speaker 652, a display 654, switches 656, keypad 658 and mouse 659 coupled to I/O interface 610, via which the various I/O devices (652, 654, 656, 658, 659) may communicate with other elements (605, . . . , 690, 606, 608, 612) of the computing system/device 600. Network interface 605 includes a receiver 678 and a transmitter 680. The network interface 605 is typically used to communicate with other devices, e.g., core network equipment, OSS, databases, wireless base stations, network management system, planning and geodata server, statistical calculation server, performance parameter application server, performance data feedback collector server, decision tree server, cloud system. In some embodiments, receiver 678 and transmitter 680 are part of a transceiver 684. Network interface 690 includes a receiver 694 and a transmitter 696. The network interface 690 is typically used to communicate with other devices, e.g., network nodes in a core, wireless base stations, OSS elements, cloud system, servers, etc. In some embodiments, receiver 694 and transmitter 696 are part of a transceiver 692. Memory 612 includes an assembly of component 614, e.g., an assembly of software components, and data/information 616. Data/information 616 includes UE (or wireless device) information 630, wireless base station information 632, base station category parameter information 634, performance parameter and metrics information 636, planning and geodata server information (e.g., propagation model(s) and geographical information including clutter information) 640, statistical information (e.g., scattering cross section information (e.g., scattering cross section database), information and/or analysis of clutter types, signaling information, user equipment location/density per coverage area per base station, reported and/or determined clutter information including clutter locations, heights, distances for base stations, clutter losses from clutter paths from wireless network equipment entities to items of clutters, sensing information reported from wireless network equipment entities for use in determining clutter in the vicinity or surrounding the wireless network equipment entities, RF interference prediction information, propagation paths and path loss information) 642. The specific information included in data/information 616 depends on the specific network equipment device implemented. For example, planning and geodata information such as clutter type per location for the wireless system's coverage area would be included if the network equipment device was a planning and geodata server but would not be included if the network equipment device was a decision tree server. In some embodiments, the computing system 600 also includes a wireless interface through which it can communicate with other devices for example through which it can obtain information (e.g., terrain and clutter information), spectrum access requests for spectrum usage, and communicate responses to spectrum access requests for spectrum usage.

In some embodiments, the computing system/devices/entities discussed in the Figures and/or in connection with the embodiments of the present invention described are implemented in accordance with computing system/device 600. For example, the computing system 10, may be, and in some embodiments is, implemented in accordance with the computing system/device 600. In such embodiments, the processor device(s) 12 are the processor(s) 606 of computing system 600. The propagation module 16, propagation information generator 44, and Spectrum Access System 22 of computing system 10 are implemented as software components 616, hardware components 608, and/or a combination of software components 616 and hardware components 608. The memory 16 is memory 612 of computing system 600. While various types of information are disclosed in computing system 10 as being stored in the memory 16, one or more pieces of information may be, and in some embodiments is, stored in a separate storage device (e.g., a database server). For example, clutter scattering cross section information including information for different scattering cross sections for different types of clutter and information for clutter scattering cross section losses, topographic information and clutter information may be, and in some embodiments is, stored in a separate database which responds to queries from the computing system when the information for a specific propagation path, geographic area, or clutter scattering cross section information is needed. Parameters and formulas for calculating, determining and/or generating scattering cross sections for clutter, propagation path losses between locations, e.g., between transmitters and clutter, between fixed locations of the base stations, in a geographic area, antenna heights, elevation angle of transmission point above sea level, clutter/obstruction heights along propagation paths between fixed location base station, etc. may be stored in advance so that only spectrum information needs to be inputted in the propagation model to determine a propagation loss. In some embodiments, the propagation path loss formulas are determined in advance using known location information of transmission points and reception points of fixed locations wireless network entity devices (e.g., base stations), terrain information, and clutter information along the radio frequency propagation paths so that upon receipt of a request for spectrum usage identifying the spectrum frequency, channel, and/or band for usage, an identified frequency (e.g., center frequency of requested spectrum) can be input into the formula and a propagation path loss (e.g., a total propagation path loss) can be determined for the fixed location wireless network entity devices (e.g., base stations) without performing the steps of obtaining and/or generating obstruction information, topographic information, clutter information, critical point identification information along a propagation path between the fixed location wireless network entities as these steps will have been performed in advance. The computing system 10 can include a monitoring module or component which monitors for updates to clutter information and/or terrain information (e.g., release of updated survey information in the NCLD) and in response learning of updated information availability obtaining the updated information and re-calculating the total propagation path loss formulas using the updated information.

FIG. 7 is a drawing of an exemplary wireless network entity device 400 (e.g., a wireless base station, wireless node, wireless device) in accordance with an exemplary embodiment. The wireless network entity device 400 may be, and in some embodiments is an eNodeB, gNodeB, Citizens Broadband Radio Service Device (CBSD), a wireless user equipment device, wireless communications entity, customer premises equipment wireless device, radar system, in accordance with an exemplary embodiment. Exemplary wireless network entity device 400 includes wireless interfaces 404, a network interface 405, e.g., a wired or optical interface, a processor 406, e.g., a CPU, an assembly of hardware components 408, e.g., an assembly of circuits, and I/O interface 410, and memory 412 coupled together via a bus 409 over which the various elements may interchange data and information. Wireless network entity device 400 further includes a speaker 452, a display 454, switches 456, keypad 458 and mouse 459 coupled to I/O interface 410, via which the various I/O devices (452, 454, 456, 458, 459) may communicate with other elements (404, 405, 406, 408, 412) of the wireless network entity device 400. Network interface 405 includes a receiver 478 and a transmitter 480. In some embodiments, receiver 478 and transmitter 480 are part of a transceiver 484. Wireless interfaces 404 include a plurality of wireless interfaces including first wireless interface 424, second wireless interface 450, . . . , Kth wireless interface 455, K being an integer greater than 2. The wireless interfaces are used to communicate with the wireless devices, e.g., user equipment device. The first wireless interface 424 is used for example to communicate with a first user equipment device using a first spectrum band. The second wireless interface can be used to communicate with a second user equipment device using a second spectrum band. The first wireless interface 424 includes wireless receiver 438 and a wireless transmitter 440. In some embodiments, receiver 438 and transmitter 440 are part of a transceiver. In various embodiments, the first wireless interface 424 includes a plurality of wireless receivers and a plurality of wireless transmitters. Wireless receiver 438 is coupled to a plurality of receive antennas (receive antenna 1 439, . . . , receive antenna M 441), via which wireless network entity device 400 can receive wireless signals from other wireless communications devices including a second wireless communications device, e.g., a user equipment device. Wireless transmitter 440 is coupled to a plurality of wireless transmit antennas (transmit antenna 1 443, . . . , transmit antenna N 445) via which the wireless network entity device 400 can transmit signals to other wireless communications devices including a second wireless communications device, e.g., a user equipment device.

The second wireless interface 450 includes wireless receiver 452 and a wireless transmitter 454. In some embodiments, receiver 452 and transmitter 454 are part of a transceiver. In various embodiments, the second wireless interface 450 includes a plurality of wireless receivers and a plurality of wireless transmitters. Wireless receiver 452 is coupled to one or more receive antennas (receive antenna 1 456, . . . , receive antenna M 457), via which wireless network entity device 400 can receive wireless signals from other wireless communications devices including a second wireless communications device, e.g., a UE device, using the same or a different wireless protocol than the first wireless interface. Wireless transmitter 454 is coupled to one or more wireless transmit antennas (transmit antenna 1 458, . . . , transmit antenna N 460) via which the wireless network entity device 400 can transmit signals to other wireless communications devices including a second wireless communications device, e.g., UE device. The wireless base station network interface 405 may be coupled to a cable modem, a core network, other networks, e.g., internet, or other wireless base stations. In some embodiments, the wireless network entity device 400 includes multiple network interfaces so that it can connect to multiple networks (e.g., a cable network and a core network) via the different interfaces.

Memory 412 includes an assembly of components 414, e.g., an assembly of software components, and data/information 416. The assembly of components includes a control routines component 470 which controls the operation of the wireless network entity device 400 and a Integrated Sensing and Communications component 472 which performs operations and functions for and/or relating to sensing operations such as for example transmitting of sensing signals, receiving of sensing signals, processing of sensing signals, determination of clutter scattering cross sections, determination of clutter information, determination of propagation losses.

Data/information 416 includes UE information 462 (e.g., wireless device information including location information and configuration parameters, session information, reporting signaling information, reported performance metrics) for the UE devices to which it is providing services, wireless base station operational information 464 (e.g., set of configuration parameters used for operating the wireless base station including for example base station transmit power level (e.g., max power level), user equipment device transmit power level (e.g., UE max transmission power level), cell reselection and/or handover parameters (e.g., hysteresis, minimum signal strength, signal offset), and antenna tilt information, spectrum information (e.g., spectrum such as CBRS spectrum to use for wireless communications with UE devices when the wireless base station is a CBRS wireless base station). The data/information 416 also includes wireless base station information and metrics 466 (e.g., wireless base station performance metrics collected and reported to the OSS of the wireless system such as for example successful connections, failed connections, successful handovers, failed handovers, signaling information such as signaling interference information, etc.). The data/information 4165 also includes ISAC information such as sensing pulse transmission times, reflected sensing pulse reception times, locations of base stations receiving the sensing pulses in bistatic sensing, scattering cross section information (e.g., scattering cross section information for different types of clutter (monostatic and bistatic cross section information), scattering cross section loss information for different clutter types). In some embodiments, wireless network entity device 400 includes a software and/or hardware a control routines component which controls the operation of the wireless network entity device. In some embodiments, the wireless network entity device 400 includes a Global Position System (GPS) receiver component which generates GPS coordinates corresponding to the location of the wireless network entity device 400. In some embodiments, 416 also includes information on other base stations/wireless network entity devices such as for example location and height of transmitter and receiver antennas, information from which propagation losses can be determined, information from which timing delays can be determined for sensing pulses, information which when combined with sensing operations can be used for identifying and generating information about items of clutter such as clutter heights and locations.

While the details of the first and second wireless interfaces are shown, the other wireless interfaces of the wireless base station, e.g., wireless interface K where K is an integer greater than 2 also include multiple receivers and transmitters so that the wireless network entity device 400 can provide wireless services to for example a plurality of wireless devices such as user equipment devices. In some embodiments, one or more of the wireless network entities, wireless nodes, and/or wireless base stations discussed and/or shown in the Figures and/or in connection with the methods discussed herein are implemented in accordance with the wireless network entity device 400. For example, the first wireless network entity device 18, second wireless network entity device 58, third wireless network entity device 59, and base station network entity 30 of exemplary environment/system 100 of FIG. 1 may be, and in some embodiments are, implemented in accordance with the wireless network entity device 400. In some embodiments, the wireless network entities described in the FIGS. 3, 4, 5, and 12 are implemented in accordance with wireless network entity device 400. In some embodiments, the transmitter 1002 and sensor receiver 1006 are part of wireless network entity devices implemented in accordance with wireless network entity device 400. The wireless interfaces of wireless network entity 400 support antenna beamforming. The antennas shown are sometimes antenna arrays and include antenna array sensors for beamforming. In some embodiments, the transmitter and receivers can be mechanically moved to change transmission and reception directions. In some embodiments, the base station 400 has full duplex capability with respect to transmission and reception of signals such as sensing pulse signals.

FIG. 8 is a drawing of an exemplary assembly of components 800 which may be included in an exemplary wireless network entity device (e.g., exemplary wireless network entity device 400 of FIG. 7), in accordance with an exemplary embodiment. The components in the assembly of components 800 can, and in some embodiments are, implemented fully in hardware within a processor, e.g., processor 406, e.g., as individual circuits. The components in the assembly of components 800 can, and in some embodiments are, implemented fully in hardware within the assembly of hardware components 408, e.g., as individual circuits corresponding to the different components. In other embodiments some of the components are implemented, e.g., as circuits, within processor 406 with other components being implemented, e.g., as circuits within assembly of components 408, external to and coupled to the processor 406. As should be appreciated the level of integration of components on the processor and/or with some components being external to the processor may be one of design choice. Alternatively, rather than being implemented as circuits, all or some of the components may be implemented in software and stored in the memory 412 of the wireless network entity device 400, with the components controlling operation of wireless network entity device 400 to implement the functions corresponding to the components when the components are executed by a processor e.g., processor 406. In some such embodiments, the assembly of components 800 is included in the memory 412 as assembly of software components 414. In still other embodiments, various components in assembly of components 800 are implemented as a combination of hardware and software, e.g., with another circuit external to the processor providing input to the processor which then under software control operates to perform a portion of a component's function.

When implemented in software the components include code, which when executed by a processor, e.g., processor 406, configure the processor to implement the function corresponding to the component. In embodiments where the assembly of components 800 is stored in the memory 412, the memory 412 is a computer program product comprising a computer readable medium comprising code, e.g., individual code for each component, for causing at least one computer, e.g., processor 406, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 8 control and/or configure the wireless network entity device 400 or elements therein such as the processor 406, to perform the functions of corresponding steps illustrated and/or described in the method of one or more of the flowcharts, signaling diagrams and/or described with respect to any of the Figures. Thus the assembly of components 800 includes various components that perform functions of corresponding one or more described and/or illustrated steps of an exemplary method.

Assembly of components 800 includes a control routines component 802, a communications component 804, a message generator component 806, a message processing component 808, a determinator component 810, a storage component 812, and a location determination component (e.g., a GPS receiver component) 814, and Integrated Sensing and Communications component 816.

The control routines component 802 is configured to control operation of the wireless network entity device (e.g., base station, smartphone, wireless access point, gNodeB, eNodeB, CBSD, wireless node, etc.).

The communication component 704 is configured to handle communications, e.g., transmission and reception of messages, and protocol signaling for the wireless network entity device (e.g., communications with other wireless devices and other network equipment (e.g., Spectrum Access System), components, functions, devices, and servers in its network, other networks and/or OSS).

The message generator component 806 is configured to generate messages for transmission to other devices, e.g., spectrum access request messages, heartbeat request messages, spectrum usage request messages, response messages, notification messages, messages for sharing information (e.g., spectrum channels to utilize and power transmission instructions such as maximum transmission power levels), communications messages with network equipment devices, communications messages with user equipment devices. In some embodiments, the message generator component 806 is a sub-component of the communications component 804.

The message processing component 808 is configured to process messages received from other devices and implement operations in response to instructions and/or information included in the processed message, e.g., processing and implementing operations in connection with messages authorizing or denying access and/or usage of spectrum. In some embodiments, the message processing component 808 is a sub-component of the communications component 804.

The determinator component 810 is configured to make determinations and decisions for the wireless network entity device including for example: determining what spectrum range and/or channels to request for utilization, determining whether a response indicates authorization to utilize requested spectrum, determination of whether a response indicates denial of authorization to utilize requested spectrum, determining timing delays being transmitted and received sensing pulses, determining clutter information, determining clutter loss information for propagation path between the wireless network entity device and an item of clutter, determining propagation path losses, determining scattering cross sections for items of clutter, determining clutter type for an item of clutter based on the determined scattering cross section of an item of clutter, determining whether an item of clutter is blocking a propagation path extending from the wireless network entity to another wireless network entity, determining predicted RF interference based on clutter information.

The storage component 812 is configured to manage the storage, and retrieval of data and/or instructions to/and from memory, buffers in memory, hardware buffers and/or storage device coupled and/or connected to the wireless base station such as for example, ISAC information, sensing information, scattering cross section information for different types of clutter, obstruction information, clutter information, terrain information, information for points along a propagation path, propagation information (e.g., propagation path loss models, formulas, equations, determined/calculated/generated propagation path loss for portions of propagation paths and/or total propagation path loss for propagation paths, clutter propagation path losses, single diffraction propagation path losses, tropo-scattering paths), predicted RF interference information), path loss information (e.g., determined/calculated/generated clutter losses, propagation path loss for portions of propagation paths and/or total propagation path loss for propagation paths, clutter propagation path losses, diffraction propagation path losses, tropo-scattering paths), authorized spectrum usage information).

The location component 814 can determine the location of the wireless network entity device and provide the information with spectrum access and/or usage requests and/or in response to queries received for the location of the wireless network entity device. In some embodiments, the location component 814 determines the information from GPS coordinates received from a GPS receiver. In some embodiments, the location component 814 is a GPS receiver component that determines GPS coordinates for the device from received GPS signals. In some embodiments, the location component device 814 determines its location from registration information (e.g., CBSD registration information which include location information, antenna height, etc. stored in its memory for registering with an SAS).

Integrated Sensing and Communications component 816 is configured to performs operations and functions for and/or relating to sensing operations and communications operations such as for example transmitting of sensing signals, receiving of sensing signals, processing of sensing signals, determination of clutter scattering cross sections, determination of clutter information, determination of propagation losses, transmitting integrated sensing pulses and communications data signals, receiving and processing reflected integrated sensing pulses and communications data signals, transmitting sensing pulse signals, receiving and processing reflected sensing pulse signals. In some embodiments, determination made with respect to sensing, determining clutter information, determining clutter losses and propagation path losses, predicting RF interference, determining transmission power levels, determining base station site locations are made the ISAC component 816.

FIG. 9 is a drawing of an exemplary assembly of components 900 which may be included in a computing system 600 of FIG. 6, in accordance with an exemplary embodiment. The components in the assembly of components 900 can, and in some embodiments are, implemented fully in hardware within a processor or one or more processors, e.g., processor(s) 606, e.g., as individual circuits. The components in the assembly of components 900 can, and in some embodiments are, implemented fully in hardware within the assembly of hardware components 608, e.g., as individual circuits corresponding to the different components. In other embodiments some of the components are implemented, e.g., as circuits, within processor(s) 606 with other components being implemented, e.g., as circuits within assembly of components 608, external to and coupled to the processor(s) 606. As should be appreciated the level of integration of components on the processor and/or with some components being external to the processor may be one of design choice. Alternatively, rather than being implemented as circuits, all or some of the components may be implemented in software and stored in the memory 612 of the computing system 600, with the components controlling operation of the computing system 600 to implement the functions corresponding to the components when the components are executed by a processor e.g., processor 606. In some such embodiments, the assembly of components 900 is included in the memory 612 as assembly of software components 614. In still other embodiments, various components in assembly of components 900 are implemented as a combination of hardware and software, e.g., with another circuit external to the processor providing input to the processor which then under software control operates to perform a portion of a component's function.

When implemented in software the components include code, which when executed by a processor or one or more processors, e.g., processor(s) 606, configure the processor(s) to implement the function corresponding to the component. In embodiments where the assembly of components 900 is stored in the memory 612, the memory 612 is a computer program product comprising a computer readable medium comprising code, e.g., individual code for each component, for causing at least one computer, e.g., processor 606, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 9 control and/or configure the computing system 600 or elements therein such as the processor(s) 606, to perform the functions of corresponding steps illustrated and/or described in the method of one or more of the flowcharts, signaling diagrams and/or described with respect to any of the Figures. Thus the assembly of components 900 includes various components that perform functions of corresponding one or more described and/or illustrated steps of an exemplary method.

Assembly of components 900 includes a control routines component 902, a communications component 904, a message generator component 906, a message processing component 908, a propagation component 910, a determinator component 912, a storage component 914, a propagation information generator component 922, a spectrum access system component 924, a propagation path loss generator component 926, a propagation mode selector component 928, a RF interference prediction component 930, a wireless network entity device location determination component 932, and a spectrum usage determination component 934.

The control routines component 902 is configured to control operation of the computing system. The communication component 904 is configured to handle communications, e.g., transmission and reception of messages, and protocol signaling for the computing system. The message generator component 906 is configured to generate messages for transmission to other devices. Exemplary messages which are generated include spectrum access response messages which includes decisions on spectrum usage and response to spectrum access/usage requests. The message processing component 908 is configured to process messages and implement procedures/operations in response to messages or based on the contents of messages. This includes messages received from other devices, e.g., messages from wireless network entities, UEs, wireless base stations, core network, OSS, geographical mapping databases.

The propagation component 910 performs the operations for generating and/or determining a total propagation loss between two endpoints and/or a prediction of a degree/amount/level of RF interference based on the determined total propagation loss. The propagation component 910 further performs the operations described in connection with the propagation module 16 of system 10.

The determinator component 912 is configured to make determinations and decisions for the system including for example: determining point heights, critical points, sampled points, clutter losses, Free Space Loss for path, ITM propagation loss for a path and/or a portion of radio frequency propagation path (e.g., using point data, critical point data, obstruction height data, terrain and clutter information), total propagation loss for a radio reference propagation path between two endpoints, determine whether or not to authorize use of spectrum, determine horizon points, determine critical points along a propagation path, determine heights of points and/or clutter with respect to a reference point, determine height of terrain with respect to a reference point, determine high fidelity obstruction information).

The storage component 914 is configured to manage the storage, and retrieval of data and/or instructions to/and from memory, and/or storage devices e.g., storage and retrieval of geographical information, terrain information, clutter information, spectrum usage information, wireless network entity devices information such as for example (identity, location, antenna height, spectrum authorized to use, device type, device owner type (tier or priority for spectrum usage (e.g., incumbent, priority access licensee, general authorized access), clutter information, scattering cross section information, sensing data (e.g., reported by base stations from which to determine information about clutter in the vicinity of the base station), clutter loss information for different propagation paths, propagation information (e.g., propagation loss information for a path between two endpoints), path loss information, propagation model information (e.g., Okumura-Hata model information, ITM model information), spectrum usage by device with spectrum to managed spectrum, etc.)

The Integrated Sensing and Communications component 916 Integrated Sensing and Communications component 816 is configured to performs operations and functions for and/or relating to sensing operations and communications operations such as for example processing information about transmitted and received sensing signals, determination of clutter scattering cross sections, determination of clutter information, determination of propagation losses, transmitting integrated sensing pulses and communications data signals, receiving and processing reflected integrated sensing pulses and communications data signals, transmitting sensing pulse signals, receiving and processing reflected sensing pulse signals. In some embodiments, determination made with respect to sensing, determining clutter information, determining clutter losses and propagation path losses, predicting RF interference, determining transmission power levels, determining base station site locations are made the ISAC component 816.

The propagation information generator 922 also performs the operations described in connection with the propagation information generator 922 of computing system 10. The spectrum access system component 924 manages spectrum access and usage for a network's spectrum (e.g., shared shared). The spectrum access system component makes spectrum access and/or usage decisions with respect to a region of spectrum (e.g., CBRS shared spectrum). The spectrum access system performs the operations of a CBRS spectrum access system when managing a CBRS system's spectrum. The spectrum access system also determines the maximum transmission level a wireless network entity is authorized to transmit at. The spectrum access system determines predicted RF interference levels based on total propagation loss between two endpoints (e.g., transmitter and receiver). The spectrum access system component 924 also performs the operation described of the SAS 22 of computing system 10. The propagation path loss generator component 926 generates propagation path losses for propagation paths. In some embodiments the propagation path loss generator is a sub-component of the propagation component 910 and/or the propagation information generator component 922. The propagation mode selector component 928 performs the operations described in connection with propagation mode selector 48 of computing system 10. The RF interference prediction component 930 determines predicted RF interference degrees, amounts, and/or levels based on propagation path loss information. The wireless network entity device location determination component 932 determines a wireless network entity device's location and height information (e.g., antenna height) (e.g., based on device identification information, location information received from the device, device registration information, pre-stored location information). The spectrum usage determination component 934 determines spectrum usage for wireless network entities based on user tier or priority, RF interference levels, propagation loss information. In some embodiments, spectrum usage determination component is a sub-component of the spectrum access system component 924.

The specific components of the assembly of components 900 included in any particular computing system may, and typically does vary depending on the specific system/device and the functionality required for the system/device and/or the operations the system/device is responsible for performing.

Various exemplary numbered embodiments illustrating different features of the present invention will now be discussed. The various features discussed may be used in variety of different combinations. It should be appreciated that not necessarily all embodiments include the same features and some of the features described below are not necessary but can be desirable in some embodiments. The numbered embodiments are only exemplary and are not meant to be limiting to the scope of the invention. The various method embodiments may be, and in some embodiments are, implemented on system 100 of FIG. 1. While many of the numbered embodiments include one or more wireless base stations, this is only exemplary. Each wireless base station in the numbered embodiments can be, and in some embodiments is, replaced with a wireless network entity or a wireless entity/device. The wireless entity or device is typically a wireless communications entity or device used for communications such as for example access points, wireless customer premises equipment devices, wireless user equipment devices, mobile phones, smartphones, laptops, tablets, and network equipment with wireless interfaces.

### LIST OF EXEMPLARY NUMBERED METHOD EMBODIMENTS

Method Embodiment 1. A method comprising: transmitting, by a first wireless base station (e.g., a first CBSD), radio frequency sensing pulses; receiving, by a second wireless base station (e.g., a second CBSD), reflected radio frequency sensing pulses, said reflected radio frequency sensing pulses being the transmitted radio frequency sensing pulses which have been reflected by one or more items of clutter in the vicinity of the first wireless base station; determining information about the one or more items of clutter in the vicinity of the first wireless base station based on information about the received reflected radio frequency sensing pulses; determining a clutter loss for one or more radio frequency propagation paths extending from the first wireless base station to a third wireless base station based on the determined information about the one or more items of clutter, said one or more radio frequency propagation paths including a first radio frequency propagation path.

Method Embodiment 1A. A method comprising: transmitting, from a first transmission point of a first wireless network entity device (e.g., a first base station antenna), radio frequency sensing pulses; receiving, at reception point of a second wireless base station (e.g., a second base station antenna), reflected radio frequency sensing pulses, said reflected radio frequency sensing pulses being transmitted radio frequency sensing pulses which have been reflected by one or more items of clutter surrounding the first wireless base station; determining information about the one or more items of clutter surrounding the first wireless base station based on information about the received reflected radio frequency sensing pulses; determining a clutter loss for a first radio frequency propagation path extending from the first wireless base station transmission point to a reception point in a geographical area designated for use by a licensed wireless network entity device (e.g., CBRS licensed geographic area in which a CBSD is operating) or for Navy radar system use based on one or more of the following: (i) information about the received reflected radio frequency sensing pulses, and (ii) the determined information about the one or more items of clutter surrounding the first wireless base station.

Method Embodiment 1B. A method comprising: transmitting, by a first wireless network entity device (e.g., a first base station), radio frequency sensing pulses; receiving, by a second wireless base station (e.g., a second base station), reflected radio frequency sensing pulses, said reflected radio frequency sensing pulses being transmitted radio frequency sensing pulses which have been reflected by one or more items of clutter surrounding the first wireless base station; determining information about the one or more items of clutter surrounding the first wireless base station based on information about the received reflected radio frequency sensing pulses; determining a clutter loss for a first radio frequency propagation path extending from the first wireless base station to a third wireless network entity device (e.g., a third wireless base station or a Navy radar system) based on one or more of the following: (i) information about the received reflected radio frequency sensing pulses, and (ii) the determined information about the one or more items of clutter surrounding the first wireless base station.

Method Embodiment 1C. The method of Method Embodiment 1 wherein said information about the one or more items of clutter in the vicinity of the first wireless base station based on information about the received reflected radio frequency sensing pulses includes one or more or all or any combination of the following: (i) a location of each of the one or more items of clutter, (ii) a distance to each of the one or more items of clutter from a first transmitter of the first wireless base station, (iii) a height of each of the one or more items of clutter with respect to the ground or terrain, (iv) a height of each of the one or more items of clutter with the respect to a height of a first transmitter of the first wireless base station, (v) a size of the one or more items of clutter, (vi) a density of each of the one or more items of clutter, and (vii) a type of clutter for each of the one or more items of clutter (e.g., building, tree, vegetation).

Method Embodiment 1D. A method comprising: transmitting, from a first transmission point of a first wireless network entity device (e.g., a first wireless network entity antenna), radio frequency sensing pulses; receiving, at reception point of a second wireless network entity (e.g., a second wireless network entity antenna), reflected radio frequency sensing pulses, said reflected radio frequency sensing pulses being transmitted radio frequency sensing pulses which have been reflected by one or more items of clutter in the vicinity of the first wireless network entity; determining information about the one or more items of clutter in the vicinity of the first wireless network entity device based on information about the received reflected radio frequency sensing pulses; determining one or more wireless base station site locations based on the determined information about the on or more items of clutter.

Method Embodiment 1E. A method comprising: transmitting, from a first transmission point of a first wireless network entity (e.g., a first wireless network entity device antenna), radio frequency sensing pulses; receiving, at reception point of a second wireless network entity (e.g., a second wireless network entity antenna), reflected radio frequency sensing pulses, said reflected radio frequency sensing pulses being transmitted radio frequency sensing pulses which have been reflected by one or more items of clutter in the vicinity of the first wireless network entity; determining information about the one or more items of clutter in the vicinity of the first wireless network entity based on information about the received reflected radio frequency sensing pulses; determining transmission power levels for one or more wireless network entity devices (e.g., the first wireless network entity device) based on the determined information about the one or more items of clutter.

Method Embodiment 2. The method of Method Embodiment 1, wherein the radio frequency sensing pulses are transmitted along with communications data as part of a communications signal (e.g., OFDM symbols of a wireless data communication).

Method Embodiment 2A. The method of Method Embodiment 1, wherein the radio frequency sensing pulses are transmitted from a first transmitter of the first wireless base station separately from communications signals transmitted from the first transmitter of the first wireless base station (e.g., the first transmitter is used to send sensing pulses in a plurality of directions and elevations from the first transmitter for a first periods of time and then the first transmitter is used to send communications signals during second periods of time (e.g., wireless communications signals transmitted to a user equipment device being serviced by the first wireless base station).

Method Embodiment 2B. The method of Method Embodiment 2A, wherein the radio frequency sensing pulses are transmitted in different directions.

Method Embodiment 2C. The method of Method Embodiment 2A, wherein the radio frequency sensing pulses are transmitted at different degrees of elevation and in different directions (e.g., 0 degree vertical sweep from an antenna pointing directly down at the ground/terrain to an antenna pointing directly upward which is a 180 degree elevation with respect to the ground/terrain with the elevational change being in 1 degree increments while at each increment the elevation of the antenna is varied between 0 degrees to 360 degrees in 1 degree intervals along the horizontal plane to perform a horizontal sweep).

Method Embodiment 2D. The method of Method Embodiment 2A, wherein the radio frequency sensing pulses are transmitted in different directions performing vertical and horizontal sweeps around the first transmitter to obtain information on clutter in the vicinity of the first transmitter.

Method Embodiment 2E. The method of Method Embodiment 2B, wherein the antennas of the first transmitter are mechanically moved to (e.g., tilted, rotated, and/or angled) or wherein beamforming is used where different antenna elements of an antenna array are used for transmitting the radio frequency sensing pulses in different directions.

Method Embodiment 3. The method of Method Embodiment 2, wherein the radio frequency sensing pulses form a plurality of pulse-Doppler-based radar pulse trains which have been integrated into an OFDM resource grid being used for wireless communications.

Method Embodiment 3A. The method of Method Embodiment 3, wherein the reflected radio frequency sensing pulses are received along with the communications data as part of a received reflected communications signal; the method further comprising: detecting, by the second wireless base station, the sensing pulses from the received reflected communications signal.

Method Embodiment 3B. The method of Method Embodiment 3A, wherein said detecting, by the second wireless base station, the received reflected radio frequency sensing pulses from the received reflected communications signal includes filtering the received reflected communications signal to separate the radio frequency sensing pulses in the reflected communications signal from the communications data in the reflected communications signal.

Method Embodiment 3C. The method of Method Embodiment 3A, wherein said detecting, by the second wireless base station, the received reflected radio frequency sensing pulses from the received reflected communications signal includes filtering the received reflected communications signal to pass the received reflected radio frequency sensing pulses in the reflected communications signal while removing the communications data in the reflected communications signal to generate a plurality of received reflected radio frequency sensing pulse trains.

Method Embodiment 4. The method of Method Embodiment 1, wherein the first wireless base station and the second wireless base station are the same wireless base station (e.g., monostatic sensing).

Method Embodiment 5. The method of Method Embodiment 1, wherein the first wireless base station and the second wireless base station are different wireless base stations which are not co-located (e.g., bistatic sensing with the first and second wireless base station located in different locations).

Method Embodiment 6. The method of Method Embodiment 1, wherein the first wireless base station, the second wireless base station and the third wireless base station utilize shared spectrum resources (e.g., shared CBRS spectrum) to provide wireless services to user equipment devices.

Method Embodiment 7. The method of Method Embodiment 6, wherein the first wireless base station is a first CBSD of a first CBRS system; and wherein the second wireless base station is a second CBSD (e.g., a second CBSD of the first CBRS system or a first CBSD of a second CBRS system); and wherein the third wireless base station is a third CBSD (e.g., a tier 2 licensed CBSD of a second CBRS wireless system).

Method Embodiment 8. The method of Method Embodiment 1, wherein the first wireless base station and the second wireless base station include integrated sensing and communication components (e.g., software and/or hardware components such as circuitry for implementing integrated sensing and communication capabilities).

Method Embodiment 9. The method of Method Embodiment 1, wherein said information about the received reflected radio frequency sensing pulses includes an amount of time from when the radio frequency sensing pulses were transmitted from the first wireless base station to when the reflected radio frequency sensing pulses were received by the second wireless base station (e.g., the delay from when an RF sensing pulse is transmitted from a transmitter to when it is received by the receiver).

Method Embodiment 9A. The method of Method Embodiment 9, wherein said information about the received reflected radio frequency sensing pulses further includes a spatial direction of the received reflected radio frequency sensing pulses.

Method Embodiment 9B. The method of Method Embodiment 9A, wherein said second wireless base station uses beamforming to determine the spatial direction of the received reflected radio frequency sensing pulses, said second wireless base station having a receiver with an antenna array and a beamforming array sensor.

Method Embodiment 9C. The method of Method Embodiment 9B, wherein the first wireless base station uses beamforming to spatially direct the transmission of the radio frequency sensing pulses, said first wireless base station having a transmitter with an antenna array configured for spatially directing the transmission of radio frequency signals.

Method Embodiment 9D. The method of Method Embodiment 9C, wherein the first wireless base station and the second wireless base station are the same wireless base station (e.g., monostatic sensing).

Method Embodiment 9E. The method of Method Embodiment 9, wherein said determining information about the one or more items of clutter is further based on information about the transmitted radio frequency sensing pulses (e.g., time the radio frequency pulses were transmitted and/or spatial direction and/or transmit power).

Method Embodiment 9F. The method of Method Embodiment 9D, wherein said determining information about the one or more items of clutter based on information about the received reflected radio frequency sensing pulses includes: determining a clutter distance for each item of clutter in the vicinity of the first wireless base station based on an amount of time from when the radio frequency sensing pulses were transmitted from the first wireless base station to when the reflected radio frequency sensing pulses were received by the second wireless base station (e.g., for monostatic sensing—as the radio frequency sensing pulses travel at the speed of light the distance to an item of clutter can be determined based on the amount of time from when a sensing pulse is transmitted from a transmitter of the first wireless device to when it is received back at the receiver of the first wireless base station after being reflected by the item of clutter).

Method Embodiment 9G. The method of Method Embodiment 9F, wherein said determining information about the one or more items of clutter based on information about the received reflected radio frequency sensing pulses includes: determining a clutter height for each item of clutter in the vicinity of the first wireless base station.

Method Embodiment 9H. The method of Method Embodiment 9G, wherein said determining a clutter height for each item of clutter in the vicinity of the first wireless base station includes identifying received reflected sensing pulses which are reflected by a highest point on an item of clutter (e.g., transmit sensing pulses directed to where the item of clutter touches the ground/terrain and then elevate the direction of the pulses (as well as going along the width of the item of clutter) until the highest point of the item of clutter is identified (e.g., the highest point on the item of clutter being the point having the highest elevation transmission angle from the transmitter from which a sensing pulse is reflected from the item of clutter) (E.g., the distances from the point of transmission on the transmitter to points on the items of clutter can be calculated based on the time of receipt of a sensing pulse minus the time of transmission of the sensing pulse (also referred to as a time delay) given the sensing pulse travels at the speed of light).

Method Embodiment 10. The method of Method Embodiment 1, wherein determining information about the items of clutter based on information about the received reflected radio frequency sensing pulses includes: identifying a type, of a first item of clutter from the one or more items of clutter based on information about the transmitted radio frequency sensing pulses and the received reflected radio frequency sensing pulses.

Method Embodiment 11. The method of Method Embodiment 10 further comprising: determining a first clutter distance for the first item of clutter, said first clutter distance being the distance between a first transmitter of the first wireless base station and the first item of clutter.

Method Embodiment 11A. The method of Method Embodiment 11, wherein the first wireless base station and the second wireless base station are the same wireless station; wherein a scattering cross section (σ) for the first item of clutter is based on: (i) a transmitted power (Pₜ) of the radio frequency sensing pulses, (ii) a received power (Pᵣ) of the reflected radio frequency sensing pulses; (iii) a wavelength (λ) of the transmitted radio frequency sensing pulses, (iv) the first clutter distance; and (v) a gain of an antenna used to transmit the radio frequency sensing pulses and receive the reflected radio frequency sensing pulses.

Method Embodiment 11B. The method of Method Embodiment 11A, further comprising: identifying a clutter type for the first item of clutter based on the determined scattering cross section for the first item of clutter.

Method Embodiment 11C. The method of Method Embodiment 11B, wherein said identifying a clutter type for the first item of clutter based on the determined scattering cross section for the first item of clutter includes comparing the determined scattering cross section to a plurality of different scattering cross sections for different types of clutter stored in memory or a database (e.g., a first scattering cross section for a first type of clutter (e.g., a building), a second scattering cross section for a second type of clutter (e.g., a tree), a third type of scattering cross section for a third type of clutter (e.g., a shrub), a fourth type of clutter being an electrical transmission tower, a fifth type of clutter being a wall, a sixth type of clutter being a fence, a seventh type of clutter being a telephone pole, an eighth type of clutter being a vehicle, etc.)).

Method Embodiment 11D. The method of Method Embodiment 11C, further comprising: prior to identifying the clutter type for the first item of clutter, generating different scattering cross sections for different types of clutter (e.g., (e.g., a first scattering cross section for a first type of clutter (e.g., a building), a second scattering cross section for a second type of clutter (e.g., a tree), a third type of scattering cross section for a third type of clutter (e.g., a shrub), a fourth type of clutter being an electrical transmission tower, a fifth type of clutter being a wall, a sixth type of clutter being a fence, a seventh type of clutter being a telephone pole, an eighth type of clutter being vehicle, etc.) (the clutter types can in clutter type sets such as a first set of clutter types including types: tree, building, vegetation and then sub-sets of clutter types (tree clutter sub-set type including (oak, fur, evergreen, chestnut, elm, conifer), building sub-sets (brick, wood, glass, cement, metal), vegetation sub-set (farmland vegetation, flowers, shrubs). In some embodiments, vegetation the tree clutter type is a sub-set of the vegetation type. The sub-sets being determined based on the different reflection and/or scattering characteristics of the clutter); storing the different scattering cross sections for the different types of clutter in said memory or said database.

Method Embodiment 11E. The method of Method Embodiment 11D, wherein the first scattering cross section for the first item of clutter is determined by solving the following equation:

$$σ = \frac{{( 4 π )}^{3} {R}^{4} {P}_{r}}{{P}_{t} {λ}^{2} {ℊ}^{2}}$$

where Pₜ is the transmit power (in watts);
where Pr is the received power (in watts);
where λ is the wavelength (in meters) of the sensing pulse signal;
where σ is σ(θₛ, φₛ; θᵢ, φᵢ) (in dB square meters (dBsm)) is the scattering cross section where the index i=incident angles and s=scattering angles and (s=i), where θᵢ and φᵢ are the polar and azimuthal incident angles towards the scatterer (which is the clutter) and θₛ and φₛ are the polar and azimuthal scattering angles away from the scatterer (which is the clutter), respectively;
where R is the distance (in meters) from the transmitter/receiver to the scatterer which is the clutter; and
where g is the antenna gain of the transmitter/receiver.

Method Embodiment 12. The method of Method Embodiment 1, further comprising: making a spectrum usage decision based on a first radio frequency propagation path loss for the first radio frequency propagation path extending from the first wireless base station to the third wireless base station; and wherein said first radio frequency propagation path loss is based on said determined clutter loss for the first radio frequency propagation path extending from the first wireless base station to the third wireless base station.

Method Embodiment 12A. The method of Method Embodiment 1, further comprising: making a spectrum usage decision based on the determined clutter loss for the one or more radio frequency propagation paths extending from the first wireless base station to the third wireless base station, said determined clutter loss including at least one clutter loss for a path extending from the first wireless base station to one of the one or more items of clutter determined as a scattering loss determined as a function of a scattering cross section of the one or more items of clutter.

Method Embodiment 12B. The method of Method Embodiment 12, wherein the clutter loss includes a first clutter loss (L_{tx-sc}) for a first radio frequency propagation path extending from a point of transmission of a first transmitter of the first wireless base station to a first item of clutter and a second clutter loss (L_{sc-rx}) for a second radio frequency propagation path extending from the first item of clutter to the point of reception at a receiver of the third wireless base station, said first item of clutter being one of the items of clutter in the vicinity of the first wireless base station.

Method Embodiment 13. The method of Method Embodiment 12B, wherein said determining information about the one or more items of clutter in the vicinity of the first wireless base station based on information about the received reflected radio frequency sensing pulses includes: determining whether the first item of clutter blocks a line-of-sight transmission path between the first wireless base station and the third wireless base station; and wherein the method further includes: determining the first clutter loss as a single diffraction loss in response to determining that the first item of clutter blocks the line-of-sight transmission path between the first wireless base station and the third wireless base station.

Method Embodiment 13A. The method of Method Embodiment 13, wherein said determining the first clutter loss as a single diffraction loss includes: determining the first clutter loss using the height gain loss method of the Okumura-Hata model using a height of an antenna of the first transmitter of the first wireless base station (e.g., height of the transmission point of the transmitter) and a height of an antenna of a receiver of the third wireless base station (e.g., height of point of reception).

Method Embodiment 13B. The method of Method Embodiment 13A, wherein the height of the antenna of the first transmitter of the first wireless base station is provided (e.g., to a computing system such as an SAS) during registration of the first wireless base station and wherein the height of the antenna of the receiver of the third wireless base station is provided (e.g., to the computing system such as an SAS) during registration of the third wireless base station.

Method Embodiment 14. The method of Method Embodiment 13, further comprising: determining the first clutter loss as a scattering loss in response to determining that the first item of clutter does not block the line-of-sight path between the first wireless base station and the third wireless base station.

Method Embodiment 15. The method of Method Embodiment 14, wherein said determining information about the one or more items of clutter includes determining a type of clutter for the first item of clutter from a set of clutter types; and wherein the scattering loss is determined as a function of a scattering cross section of the first item of clutter.

Method Embodiment 15A. The method of Method Embodiment 15, wherein said set of clutter types includes a building type, a vegetation type, and a tree type.

Method Embodiment 15B. The method of Method Embodiment 15, wherein the scattering loss (L_{σ}) is determined using the equation L_{σ}=10 log(σ(θₛ, φₛ; θᵢ, φᵢ)), where σ(θₛ, φₛ; θᵢ, φᵢ) is the scattering cross section of the first item of clutter, where index i=incident angles and s=scattering angles, where θᵢ and φᵢ are the polar and azimuthal incident angles towards the first item of clutter from the first transmitter respectively and θₛ and φₛ are the polar and azimuthal scattering angles away from the first item of clutter respectively.

Method Embodiment 15C. The method of Method Embodiment 15B, further comprising: prior to determining the scattering loss for the first item of clutter determining the scattering loss for different types of clutter; and storing the scattering losses in memory; and wherein determining the scattering loss for the first item of clutter includes looking up the scattering loss based on the determined type of clutter of the first item of clutter and information on the scattering cross section for the first item of clutter.

Method Embodiment 16. The method of Method Embodiment 12B, wherein the second clutter loss (L_{sc-rx}) is determined using terrain and clutter heights profile information for a propagation path extending from the first item of clutter to an antenna of a receiver of the third wireless base station.

Method Embodiment 16A. The method of Method Embodiment 16, wherein the Okumura-Hata model is used to determined the second clutter loss (L_{sc-rx}).

Method Embodiment 17. The method of Method Embodiment 12, wherein said making a spectrum usage decision based on the first radio frequency propagation path loss for the first radio frequency propagation path includes: determining a predicted amount of RF interference for a range of spectrum frequencies that will occur at the third wireless base station from radio frequency transmissions emanating from the first wireless base station based on the first radio frequency propagation path loss; and determining whether or not the first wireless base station is authorized to communicate using the range of spectrum frequencies based on the predicted amount of RF interference.

Method Embodiment 17A. The method of Method Embodiment 12, wherein said one or more items of clutter include n items of clutter, n being a positive integer greater than 1; and wherein determining a clutter loss for one or more radio frequency propagation paths extending from the first wireless base station to the third wireless base station based on the determined information about the one or more items of clutter further includes: determining a clutter loss for each of the n items of clutter, each of said n clutter losses being determined for a different RF propagation path of the one or more RF propagations paths extending from the first wireless base station to the second wireless base station, each of said different RF propagation paths extending from the first wireless base station to different item of clutter of the n items of clutter and from that item of clutter to the third wireless base station, said first radio frequency propagation path being one of the different RF propagation paths; and wherein said making a spectrum usage decision based on the first radio frequency propagation path loss for the first radio frequency propagation path further includes: determining that the clutter loss for the first radio frequency propagation path is the minimum path loss from the clutter losses determined for each of the n items of clutter; determining a predicted amount of RF interference for a range of spectrum frequencies that will occur at the third wireless base station from radio frequency transmissions emanating from the first wireless base station based on the first radio frequency propagation path loss; and determining whether or not the first wireless base station is authorized to communicate using the range of spectrum frequencies based on the predicted amount of RF interference.

Method Embodiment 18. The method of Method Embodiment 12, wherein said making a spectrum usage decision based on the first radio frequency propagation path loss for the first radio frequency propagation path includes: determining a predicted amount of RF interference for a range of spectrum frequencies that will occur at the first wireless base station from radio frequency transmissions emanating from the third wireless base station based on the first radio frequency propagation path loss; and determining whether or not the third wireless base station is authorized to communicate using the range of spectrum frequencies based on the predicted amount of RF interference. (Radio frequency propagation path loss is reciprocal.)

Method Embodiment 19. The method of Method Embodiment 18, wherein said making a spectrum usage decision based on the first radio frequency propagation path loss for the first radio frequency propagation path includes: determining that the first wireless base station is authorized to utilize spectrum to communicate with another wireless network entity in response to determining that a predicted amount of RF interference that will occur at the third wireless base station from radio frequency transmissions emanating from the first wireless base station is below a first threshold level of interference.

Method Embodiment 20. The method of Method Embodiment 12, further comprising: wherein said determining the second clutter loss for the second radio frequency propagation path extending from the first item of clutter to the third wireless base station includes utilizing terrain information and clutter information for a plurality of points along the second radio frequency propagation path extending from the first item of clutter to the third wireless base station.

Method Embodiment 21. The method of Method Embodiment 20, wherein the clutter information includes clutter height information with respect to the terrain on which the clutter is located for the plurality of points on the path extending from the first item of clutter to the third wireless base station.

Method Embodiment 22. A method comprising: transmitting, by a first transmitter, radio frequency sensing pulses; receiving, by a first receiver, reflected radio frequency sensing pulses, said reflected radio frequency sensing pulses being the transmitted radio frequency sensing pulses which have been reflected by n items of clutter (e.g., located in the vicinity of the first transmitter or in an area around the first transmitter), n being a positive integer greater than 1; determining information about each of the n items of clutter based on information about the received reflected radio frequency sensing pulses; determining a clutter loss for each of the n items of clutter based on the determined information about the n items of clutter; determining a predicted amount of RF interference for a range of spectrum frequencies that will occur at a second receiver from radio frequency transmissions emanating from the first transmitter based on one or more or all (or any combination) of the determined clutter losses for each of the n items of clutter; determining whether or not the first transmitter is authorized to communicate using the range of spectrum frequencies based on the predicted amount of RF interference; and wherein each of the clutter losses determined for one of the n items of clutter is determined as the sum of two radio frequency propagation path losses, said two radio frequency propagation path losses including a first radio frequency propagation path loss and a second radio frequency propagation path loss, said first radio frequency propagation path loss being for a radio frequency propagation path extending from the first transmitter to one of the n items of clutter and the second radio frequency propagation path loss being for a radio frequency propagation path extending from that same item of clutter to the second receiver.

Method Embodiment 23. The method of Method Embodiment 22, wherein said determining a predicted amount of RF interference for a range of spectrum frequencies that will occur at a second receiver from radio frequency transmissions emanating from the first transmitter based on one or more or all (or any combination) of the determined clutter losses for each of the n items of clutter includes: determining an amount of RF interference predicted to be caused at the second receiver by RF transmissions from the first transmitter for each of the n clutter losses (each of the n clutter losses corresponding to one of n RF propagation paths extending from the first transmitter to an item of clutter (first RF propagation path of clutter loss for item of clutter) and from the item of clutter to the second receiver (second RF propagation path of clutter loss for item of clutter)); and adding together two or more or all (or any combination) of the determined n RF amounts of interference (e.g., adding together each of the n determined amounts of interference corresponding to the n RF propagation paths corresponding to the n items of clutter).

Method Embodiment 24. The method of Method Embodiment 22, wherein the predicted amount of RF interference is determined to be the amount of RF interference caused by the clutter loss with the smallest value (minimum loss) from the n clutter losses determined for the n items of clutter (e.g., the predicted amount of interference will be determined as the RF interference amount for the RF propagation path extending from the first transmitter to the second receiver via scattering with the smallest clutter loss). This is the maximum amount of interference for any of the n RF propagation paths extending from the first transmitter to the second receiver via scattering from the n items of clutter.

Method Embodiment 25. A method comprising: transmitting, by a first transmitter, radio frequency sensing pulses; receiving, by a first receiver, reflected radio frequency sensing pulses, said reflected radio frequency sensing pulses being the transmitted radio frequency sensing pulses which have been reflected by n items of clutter (e.g., located in the vicinity of the first transmitter or in an area around the first transmitter), n being a positive integer greater than 1; determining information about each of the n items of clutter based on information about the received reflected radio frequency sensing pulses; determining a clutter gain for each of the n items of clutter based on the determined information about the n items of clutter; determining a predicted amount of RF interference for a range of spectrum frequencies that will occur at a second receiver from radio frequency transmissions emanating from the first transmitter based on one or more or all (or any combination) of the determined clutter gains for each of the n items of clutter; determining whether or not the first transmitter is authorized to communicate using the range of spectrum frequencies based on the predicted amount of RF interference; and wherein each of the clutter gains determined for one of the n items of clutter is determined as the sum of two radio frequency propagation path gains, said two radio frequency propagation path gains including a first radio frequency propagation path gain and a second radio frequency propagation path gain, said first radio frequency propagation path gain being for a radio frequency propagation path extending from the first transmitter to one of the n items of clutter and the second radio frequency propagation path gain being for a radio frequency propagation path extending from that same item of clutter to the second receiver.

Method Embodiment 26. The method of Method Embodiment 25, wherein said determining a predicted amount of RF interference for a range of spectrum frequencies that will occur at a second receiver from radio frequency transmissions emanating from the first transmitter based on one or more or all (or any combination) of the determined clutter gains for each of the n items of clutter includes: determining an amount of RF interference predicted to be caused at the second receiver by RF transmissions from the first transmitter for each of the n clutter gains (each of the n clutter gains corresponding to one of n RF propagation paths extending from the first transmitter to an item of clutter (first RF propagation path of clutter gain for item of clutter) and from the item of clutter to the second receiver (second RF propagation path of clutter gain for item of clutter)); and adding together two or more or all (or any combination) of the determined n RF amounts of interference (e.g., adding together each of the n determined amounts of interference corresponding to the n RF propagation paths corresponding to the n items of clutter).

Method Embodiment 27. The method of Method Embodiment 25, wherein the predicted amount of RF interference is determined to be the amount of RF interference caused by the clutter gain with the largest value (maximum gain) from the n clutter gains determined for the n items of clutter (e.g., the predicted amount of interference will be determined as the RF interference amount for the RF propagation path extending from the first transmitter to the second receiver via scattering with the largest or maximum clutter gain). This is the maximum amount of interference for any of the n RF propagation paths extending from the first transmitter to the second receiver via scattering from the n items of clutter.

Method Embodiment 28. The method of Method Embodiment 25, wherein the clutter gain for each of the items of clutter is determined based on the clutter loss for the item of clutter (clutter gain is the negative of clutter loss).

Method Embodiment 29. The method of Method Embodiments 22-28, wherein the first transmitter is part of a first wireless network entity, wherein the first receiver is part of the first wireless network entity, and wherein the second receiver is part of a second wireless network entity located at a different geographical location than the first wireless network entity.

Method Embodiment 30. The method of Method Embodiments 22-28, wherein the first transmitter is part of a first wireless network entity, wherein the first receiver is part of a second wireless network entity located at different geographical location than said first wireless network entity, and wherein the second receiver is part of a third wireless network entity located at a different geographical location than the first wireless network entity and the second wireless network entity.

### LIST OF EXEMPLARY NUMBERED SYSTEM EMBODIMENTS

System Embodiment 1. A system comprising: a first wireless base station (e.g., a first CBSD) including a first processor configured to operate the first wireless base to transmit radio frequency sensing pulses; and a second wireless base station (e.g., a second CBSD) including a second processor configured to operate the second wireless base station to: receive reflected radio frequency sensing pulses, said reflected radio frequency sensing pulses being the transmitted radio frequency sensing pulses which have been reflected by one or more items of clutter in the vicinity of the first wireless base station; determine information about the one or more items of clutter in the vicinity of the first wireless base station based on information about the received reflected radio frequency sensing pulses; and determine a clutter loss for one or more radio frequency propagation paths extending from the first wireless base station to a third wireless base station based on the determined information about the one or more items of clutter, said one or more radio frequency propagation paths including a first radio frequency propagation path.

System Embodiment 2. The system of System Embodiment 1, wherein the radio frequency sensing pulses are transmitted along with communications data as part of a communications signal (e.g., OFDM symbols of a wireless data communication).

System Embodiment 3. The system of System Embodiment 2, wherein the radio frequency sensing pulses form a plurality of pulse-Doppler-based radar pulse trains which have been integrated into an OFDM resource grid being used for wireless communications.

System Embodiment 4. The system of System Embodiment 1, wherein said information about the received reflected radio frequency sensing pulses includes: (i) an amount of time from when the radio frequency sensing pulses were transmitted from the first wireless base station to when the reflected radio frequency sensing pulses were received by the second wireless base station (e.g., the delay from when an RF sensing pulse is transmitted from a transmitter to when it is received by the receiver) and (ii) information on a spatial direction of the received reflected radio frequency sensing pulses.

System Embodiment 4A. The system of System Embodiment 1, wherein said second processor is further configured to operate the second wireless base station to: identify a clutter type of a first item of clutter based on information about the transmitted radio frequency sensing pulses and the received reflected radio frequency sensing pulses, as part of being configured to determine information about the one or more items of clutter based on information about the received reflected radio frequency sensing pulses, and wherein said first item of clutter is one of the one or more items of clutter.

System Embodiment 5. The system of System Embodiment 4, wherein said second processor is further configured to operate the second wireless base station to: determine a first clutter distance for a first item of clutter, as part of being configured to determining information about the one or more items of clutter based on information about the received reflected radio frequency sensing pulses; wherein said first item of clutter is one of the one or more items of clutter; and wherein said first clutter distance is the distance between a first transmitter of the first wireless base station and the first item of clutter.

System Embodiment 6. The system of System Embodiment 5, wherein the first wireless base station and the second wireless base station are the same wireless station; and wherein said second processor is further configured to operate the second wireless base station to: determine a scattering cross section (G) for the first item of clutter based on: (i) a transmitted power (Pₜ) of the radio frequency sensing pulses, (ii) a received power (Pᵣ) of the reflected radio frequency sensing pulses; (iii) a wavelength (λ) of the transmitted radio frequency sensing pulses, (iv) the first clutter distance; and (v) a gain of an antenna used to transmit the radio frequency sensing pulses and receive the reflected radio frequency sensing pulses, as part of being configured to determine information about the one or more items of clutter based on information about the received reflected radio frequency sensing pulses, and wherein said second processor is further configured to operate the second wireless base station to: identify a clutter type for the first item of clutter based on the determined scattering cross section for the first item of clutter.

System Embodiment 6A. The system of System Embodiment 6, wherein the first scattering cross section for the first item of clutter is determined by solving the following equation for the scattering cross section:

$$σ = \frac{{( 4 π )}^{3} {R}^{4} {P}_{r}}{{P}_{t} {λ}^{2} {ℊ}^{2}}$$

where Pₜ is the transmit power (in watts);
where Pr is the received power (in watts);
where λ is the wavelength (in meters) of the sensing pulse signal;
where σ is σ(θₛ, φₛ; θᵢ, φᵢ) (in dB square meters (dBsm)) is the scattering cross section where the index i=incident angles and s=scattering angles and (s=i), where θᵢ and φᵢ are the polar and azimuthal incident angles towards the scatterer (which is the clutter) and θₛ and φₛ are the polar and azimuthal scattering angles away from the scatterer (which is the clutter), respectively.
where R is the distance (in meters) from the transmitter/receiver to the scatterer which is the clutter; and
where g is the antenna gain of the transmitter/receiver.

System Embodiment 7. The system of System Embodiment 1, further comprising: a spectrum access system (SAS) including a third processor configured to: make a spectrum usage decision based on a first radio frequency propagation path loss for the first radio frequency propagation path extending from the first wireless base station to the third wireless base station; and wherein said first radio frequency propagation path loss is based on said determined clutter loss for the first radio frequency propagation path extending from the first wireless base station to the third wireless base station.

System Embodiment 8. The system of System Embodiment 1, further comprising: a spectrum access system (SAS) including a third processor configured to: make a spectrum usage decision based on the determined clutter loss for the one or more radio frequency propagation paths extending from the first wireless base station to the third wireless base station, said determined clutter loss including at least one clutter loss for a path extending from the first wireless base station to one of the one or more items of clutter determined as a scattering loss determined as a function of a scattering cross section of the one or more items of clutter.

System Embodiment 9. The system of System Embodiment 7, wherein the clutter loss includes a first clutter loss (L_{tx-sc}) for a first radio frequency propagation path extending from a point of transmission of a first transmitter of the first wireless base station to a first item of clutter and a second clutter loss (L_{sc-rx}) for a second radio frequency propagation path extending from the first item of clutter to the point of reception at a receiver of the third wireless base station, said first item of clutter being one of the items of clutter in the vicinity of the first wireless base station.

System Embodiment 10. The system of System Embodiment 9, wherein said second processor is further configured to operate the second wireless base station to: determine whether the first item of clutter blocks a line-of-sight transmission path between the first wireless base station and the third wireless base station, as part of being configured to determine information about the one or more items of clutter in the vicinity of the first wireless base station based on information about the received reflected radio frequency sensing pulses; and determine the first clutter loss as a single diffraction loss in response to determining that the first item of clutter blocks the line-of-sight transmission path between the first wireless base station and the third wireless base station.

System Embodiment 10A. The system of System Embodiment 10, wherein said second processor is configured to operate the second wireless base station to: determine the first clutter loss using the height gain loss method of the Okumura-Hata model using a height of an antenna of the first transmitter of the first wireless base station (e.g., height of the transmission point of the transmitter) and a height of an antenna of a receiver of the third wireless base station (e.g., height of point of reception), as part of being configured to determine the first clutter loss as a single diffraction loss.

System Embodiment 10B. The system of System Embodiment 10A, wherein the height of the antenna of the first transmitter of the first wireless base station is provided (e.g., to a computing system such as an SAS) during registration of the first wireless base station and wherein the height of the antenna of the receiver of the third wireless base station is provided (e.g., to the computing system such as an SAS) during registration of the third wireless base station.

System Embodiment 11. The system of System Embodiment 10, wherein said second processor is further configured to operate the second wireless base station to: determine the first clutter loss as a scattering loss in response to determining that the first item of clutter does not block the line-of-sight path between the first wireless base station and the third wireless base station; determine a type of clutter for the first item of clutter from a set of clutter types, as part of being configured to determine information about the one or more items of clutter; wherein said set of clutter types includes a building clutter type and a tree clutter type; and wherein the scattering loss is determined as a function of a scattering cross section of the first item of clutter.

System Embodiment 12. The system of System Embodiment 11, wherein the scattering loss (L_{σ}) is determined using the equation L_{σ}=10 log(σ(θₛ, φₛ; θᵢ, φᵢ)), where σ(θₛ, φₛ; θᵢ, φᵢ) is the scattering cross section of the first item of clutter, where index i=incident angles and s=scattering angles, where θᵢ and i are the polar and azimuthal incident angles towards the first item of clutter from the first transmitter respectively and θₛ and φₛ are the polar and azimuthal scattering angles away from the first item of clutter respectively.

System Embodiment 12A. The system of System Embodiment 12, wherein said second processor is further configured to operate the second wireless base station to: determine the scattering loss for different types of clutter prior to determining the scattering loss for the first item of clutter; and store the scattering losses in memory; and look up the scattering loss based on the determined type of clutter of the first item of clutter and information on the scattering cross section for the first item of clutter, as part of being configured to determine the scattering loss for the first item of clutter.

System Embodiment 12B. The system of System Embodiment 9, wherein the second clutter loss (L_{sc-rx}) is determined using terrain and clutter height profile information for a propagation path extending from the first item of clutter to an antenna of a receiver of the third wireless base station.

System Embodiment 13. The system of System Embodiment 7, wherein said third processor is further configured to: determine a predicted amount of RF interference for a range of spectrum frequencies that will occur at the third wireless base station from radio frequency transmissions emanating from the first wireless base station based on the first radio frequency propagation path loss; and determine whether or not the first wireless base station is authorized to communicate using the range of spectrum frequencies based on the predicted amount of RF interference, as part of being configured to make a spectrum usage decision based on the first radio frequency propagation path loss for the first radio frequency propagation path.

System Embodiment 13A. The system of System Embodiment 7, wherein third processor is further configured to: determine that the first wireless base station is authorized to utilize spectrum to communicate with another wireless network entity in response to determining that a predicted amount of RF interference that will occur at the third wireless base station from radio frequency transmissions emanating from the first wireless base station is below a first threshold level of interference, as part of being configured to make a spectrum usage decision based on the first radio frequency propagation path loss for the first radio frequency propagation path.

System Embodiment 14. A system comprising: a first transmitter that transmits radio frequency sensing pulses; and a first receiver that receives reflected radio frequency sensing pulses, said reflected radio frequency sensing pulses being the transmitted radio frequency sensing pulses which have been reflected by n items of clutter (e.g., located in the vicinity of the first transmitter or in an area around the first transmitter), n being a positive integer greater than 1; a first device, said first device including memory and a first processor, said first processor controlling the first device to perform the following operations: determining information about each of the n items of clutter based on information about the received reflected radio frequency sensing pulses; and a second device, said second device including memory and a second processor, said second processor controlling the second device to perform the following operations: determining a clutter loss for each of the n items of clutter based on the determined information about the n items of clutter; determining a predicted amount of RF interference for a range of spectrum frequencies that will occur at a second receiver from radio frequency transmissions emanating from the first transmitter based on one or more or all (or any combination) of the determined clutter losses for each of the n items of clutter; and determining whether or not the first transmitter is authorized to communicate using the range of spectrum frequencies based on the predicted amount of RF interference; and wherein each of the clutter losses determined for one of the n items of clutter is determined as the sum of two radio frequency propagation path losses, said two radio frequency propagation path losses including a first radio frequency propagation path loss and a second radio frequency propagation path loss, said first radio frequency propagation path loss being for a radio frequency propagation path extending from the first transmitter to one of the n items of clutter and the second radio frequency propagation path loss being for a radio frequency propagation path extending from that same item of clutter to the second receiver.

System Embodiment 15. The system of System Embodiment 14, wherein said determining a predicted amount of RF interference for a range of spectrum frequencies that will occur at a second receiver from radio frequency transmissions emanating from the first transmitter based on one or more or all (or any combination) of the determined clutter losses for each of the n items of clutter includes: determining an amount of RF interference predicted to be caused at the second receiver by RF transmissions from the first transmitter for each of the n clutter losses (each of the n clutter losses corresponding to one of n RF propagation paths extending from the first transmitter to an item of clutter (first RF propagation path of clutter loss for item of clutter) and from the item of clutter to the second receiver (second RF propagation path of clutter loss for item of clutter)); and adding together two or more or all (or any combination) of the determined n RF amounts of interference (e.g., adding together each of the n determined amounts of interference corresponding to the n RF propagation paths corresponding to the n items of clutter).

System Embodiment 17. A system comprising: a first transmitter that transmits radio frequency sensing pulses; and a first receiver that receives reflected radio frequency sensing pulses, said reflected radio frequency sensing pulses being the transmitted radio frequency sensing pulses which have been reflected by n items of clutter (e.g., located in the vicinity of the first transmitter or in an area around the first transmitter), n being a positive integer greater than 1; a first device, said first device including memory and a first processor, said first processor controlling the first device to perform the following operations: determining information about each of the n items of clutter based on information about the received reflected radio frequency sensing pulses; and a second device, said second device including memory and a second processor, said second processor controlling the second device to perform the following operations: determining a clutter gain for each of the n items of clutter based on the determined information about the n items of clutter; determining a predicted amount of RF interference for a range of spectrum frequencies that will occur at a second receiver from radio frequency transmissions emanating from the first transmitter based on one or more or all (or any combination) of the determined clutter gains for each of the n items of clutter; and determining whether or not the first transmitter is authorized to communicate using the range of spectrum frequencies based on the predicted amount of RF interference; and wherein each of the clutter gains determined for one of the n items of clutter is determined as the sum of two radio frequency propagation path gains, said two radio frequency propagation path gains including a first radio frequency propagation path gain and a second radio frequency propagation path gain, said first radio frequency propagation path gain being for a radio frequency propagation path extending from the first transmitter to one of the n items of clutter and the second radio frequency propagation path gain being for a radio frequency propagation path extending from that same item of clutter to the second receiver.

System Embodiment 18. The system of System Embodiment 17, wherein said predicted amount of RF interference is determined to be the maximum amount of interference determined based on the clutter gain having the largest or maximum value.

System Embodiment 19. The system of System Embodiment 17, wherein said predicted amount of RF interference is determined to be the sum of RF interference amounts calculated for each of the n clutter gains, (e.g., each of the n clutter gains corresponds to a different RF propagation path extending from the first transmitter to the second receiver via scattering from one of the n items of clutter).

System Embodiment 20. The system of System Embodiments 14-19, wherein the first transmitter is part of a first device, wherein the first receiver is part of the first device, wherein the second receiver is part of a third device located at a different geographical location than the first device, said first and third devices being wireless communications devices (e.g., base stations, access points, wireless user equipment devices, wireless customer premises equipment device), said second device being a computing system (e.g., a resource management computer system such as a Spectrum Access System).

System Embodiment 21. The system of System Embodiments 14-19, wherein the first transmitter is part of a first wireless network entity, wherein the first receiver is part of a second wireless network entity located at a different geographical location than said first wireless network entity, and wherein the second receiver is part of a third wireless network entity located at a different geographical location than the first wireless network entity and the second wireless network entity, said first device being either said first wireless network entity or said second wireless network entity.

The techniques of various embodiments may be implemented using software, hardware and/or a combination of software and hardware. Various embodiments are directed to apparatus, e.g., systems, network entity devices, wireless network entities, wireless network entity devices, wireless base stations, wireless devices, mobile terminals, network equipment, eNBs, gNBs, CBSDs, smart devices, user equipment devices, user devices, computers, smartphones, subscriber devices, computing systems, Spectrum Access Systems, wireless access points, computing devices, servers, nodes, and/or elements. Various embodiments are also directed to methods, e.g., method of controlling and/or operating systems, network entity devices, wireless network entities, wireless network entity devices, wireless base stations, wireless devices, mobile terminals, network equipment, eNBs, gNBs, CBSDs, smart devices, user equipment devices, user devices, computers, smartphones, subscriber devices, computing systems, Spectrum Access Systems, wireless access points, computing devices, servers, nodes, and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of the each of the described methods.

In various embodiments each of the steps or elements of a method are implemented using one or more processors. In some embodiments, each of elements or steps are implemented using hardware circuitry.

In various embodiments devices, e.g., systems, network entity devices, wireless network entities, wireless network entity devices, wireless base stations, wireless devices, mobile terminals, network equipment, eNBs, gNBs, CBSDs, smart devices, user equipment devices, user devices, computers, smartphones, subscriber devices, computing systems, Spectrum Access Systems, wireless access points, computing devices, servers, nodes, and/or elements described herein are implemented using one or more components to perform the steps corresponding to one or more methods, for example, generating or creating messages, message reception, message transmission, signal processing, sending, comparing, determining and/or transmission steps, generating/determining/calculating propagation loss, predicting RF interference, making spectrum usage decisions, utilizing terrain information and clutter information to determine propagation losses, etc. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a computing system, SAS, controller or apparatus, including a processor configured to implement one, multiple or all of the steps of one or more methods of the invention.

In some embodiments, the processor or processors, e.g., CPUs, of one or more devices, e.g., systems, network entity devices, wireless network entities, wireless network entity devices, wireless base stations, wireless devices, mobile terminals, network equipment, eNBs, gNBs, CBSDs, smart devices, user equipment devices, user devices, computers, smartphones, subscriber devices, computing systems, Spectrum Access Systems, wireless access points, computing devices, servers, nodes, and/or elements are configured to perform the steps of the methods described as being performed by the systems, wireless systems, network entity devices, wireless network entities, wireless network entity devices, wireless base stations, wireless devices, mobile terminals, network equipment, eNBs, gNBs, CBSDs, smart devices, user equipment devices, user devices, computers, smartphones, subscriber devices, computing systems, Spectrum Access Systems, wireless access points, computing devices, servers, nodes, and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., systems, network entity devices, wireless network entities, wireless network entity devices, wireless base stations, wireless devices, mobile terminals, network equipment, eNBs, gNBs, CBSDs, smart devices, user equipment devices, user devices, computers, smartphones, subscriber devices, computing systems, Spectrum Access Systems, wireless access points, computing devices, servers, nodes, and/or elements, with a processor which includes a component corresponding to each of the steps of the various described methods performed by the device in which the processor is included. In some but not all embodiments a device, e.g., systems, network entity devices, wireless network entities, wireless network entity devices, wireless base stations, wireless devices, mobile terminals, network equipment, eNBs, gNBs, CBSDs, smart devices, user equipment devices, user devices, computers, smartphones, subscriber devices, computing systems, Spectrum Access Systems, wireless access points, computing devices, servers, nodes, and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., systems, network entity devices, wireless network entities, wireless network entity devices, wireless base stations, wireless devices, mobile terminals, network equipment, eNBs, gNBs, CBSDs, smart devices, user equipment devices, user devices, computers, smartphones, subscriber devices, computing systems, Spectrum Access Systems, wireless access points, computing devices, servers, nodes, and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a system, network entity devices, wireless network entities, wireless network entity devices, wireless base stations, wireless devices, mobile terminals, network equipment, eNBs, gNBs, CBSDs, smart devices, user equipment devices, user devices, computers, smartphones, subscriber devices, computing systems, Spectrum Access Systems, wireless access points, computing devices, servers, nodes, and/or elements or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention. As used herein of ordinals in conjunction with an element is solely for distinguishing what might otherwise be similar or identical labels, such as “first loss” and “second loss,” and does not imply an initial occurrence, a quantity, a priority, a type, an importance, or other attribute, unless otherwise stated herein.

What is claimed is:

1. A method comprising:
transmitting, by a first wireless communications entity, radio frequency sensing pulses;
receiving, by a second wireless communications entity, reflected radio frequency sensing pulses, said reflected radio frequency sensing pulses being the transmitted radio frequency sensing pulses which have been reflected by one or more items of clutter in the vicinity of the first wireless communications entity;
determining information about the one or more items of clutter in the vicinity of the first wireless communications entity based on information about the received reflected radio frequency sensing pulses;
determining a clutter loss for one or more radio frequency propagation paths extending from the first wireless communications entity to a third wireless communications entity based on the determined information about the one or more items of clutter, said one or more radio frequency propagation paths including a first radio frequency propagation path.

2. The method of claim 1,
wherein the radio frequency sensing pulses are transmitted along with communications data as part of a communications signal.

3. The method of claim 2,
wherein the radio frequency sensing pulses form a plurality of pulse-Doppler-based radar pulse trains which have been integrated into an orthogonal frequency-division multiplexing (OFDM) resource grid being used for wireless communications.

4. The method of claim 1,
wherein said information about the received reflected radio frequency sensing pulses includes: (i) an amount of time from when the radio frequency sensing pulses were transmitted from the first wireless communications entity to when the reflected radio frequency sensing pulses were received by the second wireless communications entity, and (ii) information on a spatial direction of the received reflected radio frequency sensing pulses.

5. The method of claim 4, wherein said determining information about the one or more items of clutter based on information about the received reflected radio frequency sensing pulses further includes:
determining a first clutter distance for a first item of clutter, said first item of clutter being one of the one or more items of clutter, said first clutter distance being the distance between a first transmitter of the first wireless communications entity and the first item of clutter.

6. The method of claim 5,
wherein the first wireless communications entity and the second wireless communications entity are the same wireless communications entity; and
wherein said determining information about the one or more items of clutter based on information about the received reflected radio frequency sensing pulses further includes: determining a scattering cross section (σ) for the first item of clutter based on: (i) a transmitted power (Pₜ) of the radio frequency sensing pulses, (ii) a received power (Pᵣ) of the reflected radio frequency sensing pulses; (iii) a wavelength (λ) of the transmitted radio frequency sensing pulses, (iv) the first clutter distance; and (v) a gain of an antenna used to transmit the radio frequency sensing pulses and receive the reflected radio frequency sensing pulses; and
wherein the method further comprises:
identifying a clutter type for the first item of clutter based on the determined scattering cross section for the first item of clutter.

7. The method of claim 1, further comprising:
making a spectrum usage decision based on a first radio frequency propagation path loss for the first radio frequency propagation path extending from the first wireless communications entity to the third wireless communications entity; and
wherein said first radio frequency propagation path loss is based on said determined clutter loss for the first radio frequency propagation path extending from the first wireless communications entity to the third wireless communications entity.

8. The method of claim 1, further comprising:
making a spectrum usage decision based on the determined clutter loss for the one or more radio frequency propagation paths extending from the first wireless communications entity to the third wireless communications entity, said determined clutter loss including at least one clutter loss for a path extending from the first wireless communications entity to one of the one or more items of clutter determined as a scattering loss determined as a function of a scattering cross section of the one or more items of clutter.

9. The method of claim 7, wherein the clutter loss includes a first clutter loss (L_{tx-sc}) for a first radio frequency propagation path extending from a point of transmission of a first transmitter of the first wireless communications entity to a first item of clutter and a second clutter loss (L_{sc-rx}) for a second radio frequency propagation path extending from the first item of clutter to the point of reception at a receiver of the third wireless communications entity, said first item of clutter being one of the items of clutter in the vicinity of the first wireless communications entity.

10. The method of claim 9,
wherein said determining information about the one or more items of clutter in the vicinity of the first wireless communications entity based on information about the received reflected radio frequency sensing pulses includes:
determining whether the first item of clutter blocks a line-of-sight transmission path between the first wireless communications entity and the third wireless communications entity; and
wherein the method further includes:
determining the first clutter loss as a single diffraction loss in response to determining that the first item of clutter blocks the line-of-sight transmission path between the first wireless communications entity and the third wireless communications entity.

11. The method of claim 10, further comprising:
determining the first clutter loss as a scattering loss in response to determining that the first item of clutter does not block the line-of-sight path between the first wireless communications entity and the third wireless communications entity; and
wherein said determining information about the one or more items of clutter includes determining a type of clutter for the first item of clutter from a set of clutter types, said set of clutter types including a building clutter type and a tree clutter type; and
wherein the scattering loss is determined as a function of a scattering cross section of the first item of clutter.

12. The method of claim 11, wherein the scattering loss (L_{σ}) is determined using the equation L_{σ}=10 log(σ(θₛ, φₛ; θᵢ, φᵢ)), where σ(θₛ, φₛ; θᵢ, φᵢ) is the scattering cross section of the first item of clutter, where index i=incident angles and s=scattering angles, where θᵢ and φᵢ are the polar and azimuthal incident angles towards the first item of clutter from the first transmitter respectively and θₛ and φₛ are the polar and azimuthal scattering angles away from the first item of clutter respectively.

13. The method of claim 7, wherein said making a spectrum usage decision based on the first radio frequency propagation path loss for the first radio frequency propagation path includes:
determining a predicted amount of RF interference for a range of spectrum frequencies that will occur at the third wireless communications entity from radio frequency transmissions emanating from the first wireless communications entity based on the first radio frequency propagation path loss; and
determining whether or not the first wireless communications entity is authorized to communicate using the range of spectrum frequencies based on the predicted amount of RF interference.

14. A system comprising:
a first wireless communications entity including a first processor configured to operate the first wireless communications entity to transmit radio frequency sensing pulses; and
a second wireless communications entity including a second processor configured to operate the second wireless communications entity to:
receive reflected radio frequency sensing pulses, said reflected radio frequency sensing pulses being the transmitted radio frequency sensing pulses which have been reflected by one or more items of clutter in the vicinity of the first wireless communications entity;
determine information about the one or more items of clutter in the vicinity of the first wireless communications entity based on information about the received reflected radio frequency sensing pulses; and
determine a clutter loss for one or more radio frequency propagation paths extending from the first wireless communications entity to a third wireless communications entity based on the determined information about the one or more items of clutter, said one or more radio frequency propagation paths including a first radio frequency propagation path.

15. The system of claim 14,
wherein the radio frequency sensing pulses are transmitted along with communications data as part of a communications signal.

16. The system of claim 15,
wherein the radio frequency sensing pulses form a plurality of pulse-Doppler-based radar pulse trains which have been integrated into an orthogonal frequency-division multiplexing (OFDM) resource grid being used for wireless communications.

17. The system of claim 14,
wherein said information about the received reflected radio frequency sensing pulses includes: (i) an amount of time from when the radio frequency sensing pulses were transmitted from the first wireless communications entity to when the reflected radio frequency sensing pulses were received by the second wireless communications entity, and (ii) information on a spatial direction of the received reflected radio frequency sensing pulses.

18. The system of claim 14,
wherein the first wireless communications entity and the second wireless communications entity are the same wireless communications entity; and
wherein said second processor is further configured to operate the second wireless communications entity to:
determine a scattering cross section (σ) for a first item of clutter from the one or more items of clutter based on: (i) a transmitted power (Pₜ) of the radio frequency sensing pulses, (ii) a received power (Pᵣ) of the reflected radio frequency sensing pulses; (iii) a wavelength (λ) of the transmitted radio frequency sensing pulses, (iv) the first clutter distance; and (v) a gain of an antenna used to transmit the radio frequency sensing pulses and receive the reflected radio frequency sensing pulses, as part of being configured to determine information about the one or more items of clutter based on information about the received reflected radio frequency sensing pulses, and
wherein said second processor is further configured to operate the second wireless communications entity to:
identify a clutter type for the first item of clutter based on the determined scattering cross section for the first item of clutter.

19. The system of claim 14, further comprising: a spectrum access system (SAS) including a third processor configured to:
make a spectrum usage decision based on the determined clutter loss for the one or more radio frequency propagation paths extending from the first wireless communications entity to the third wireless communications entity, said determined clutter loss including at least one clutter loss for a path extending from the first wireless communications entity to one of the one or more items of clutter determined as a scattering loss determined as a function of a scattering cross section of the one or more items of clutter.

20. A non-transitory computer readable medium including a first set of computer executable instructions which when executed by a processor of a wireless communications entity cause the first wireless communications entity to perform the steps of:
transmitting radio frequency sensing pulses;
receiving reflected radio frequency sensing pulses, said reflected radio frequency sensing pulses being the transmitted radio frequency sensing pulses which have been reflected by one or more items of clutter in the vicinity of the first wireless communications entity;
determining information about the one or more items of clutter in the vicinity of the first wireless communications entity based on information about the received reflected radio frequency sensing pulses; and
determining a clutter loss for one or more radio frequency propagation paths extending from the first wireless communications entity to a third wireless communications entity based on the determined information about the one or more items of clutter, said one or more radio frequency propagation paths including a first radio frequency propagation path.
